(19) United States
(12) Patent Application Publication
(10) Pub. No.: US 2019/0312669 A1
(43) Pub. Date: Oct. 10, 2019

(54) METHOD FOR TRANSMITTING CHANNEL STATE INFORMATION IN WIRELESS COMMUNICATION SYSTEM, AND APPARATUS THEREFOR

(71) Applicant: LG ELECTRONICS INC., Seoul (KR)

(72) Inventors: Kyuhwan KWAK, Seoul (KR); Daesung HWANG, Seoul (KR); Yunjung YI, Seoul (KR); Hyunho LEE, Seoul (KR)

(73) Assignee: LG ELECTRONICS INC., Seoul (KR)

(21) Appl. No.: 16/090,167

(22) PCT Filed: Mar. 29, 2017
(86) PCT No.: PCT/KR2017/003439

§ 371 Date: Sep. 28, 2018

Related U.S. Application Data
(60) Provisional application No. 62/314,973, filed on Mar. 29, 2016.
(60) Provisional application No. 62/316,601, filed on Apr. 1, 2016.

(51) Int. Cl. H04L 1/00; H04L 5/00; H04W 80/08; H04B 7/06; H04B 7/0456; H04W 76/11

(52) U.S. Cl. CPC H04L 1/0026; H04L 5/0082; H04L 5/0055; H04W 76/11; H04B 7/0632; H04B 7/0639; H04B 7/0456; H04W 80/08

(57) ABSTRACT

The present invention provides a method for transmitting channel state information in a wireless communication system, and an apparatus therefor. Specifically, a method for transmitting, by a terminal, channel state information (CSI) in a wireless communication system supporting a short transmission time interval (TTI) may comprise the steps of: transmitting first CSI associated with a downlink channel received from a base station, to the base station in a first TTI; and transmitting second CSI associated with the received downlink channel, to the base station in a second TTI, wherein the first CSI includes information indicating a specific region including one or more indices associated with the CSI, and the second CSI includes information indicating a specific index which corresponds to a channel state associated with the received downlink channel among the one or more indices.

### TECHNICAL FIELD

The present invention relates to a wireless communication system and, more particularly, to a method for a user equipment to transmit channel state information to a base station in a wireless communication system supporting a short transmission time interval and an apparatus supporting the same.

### BACKGROUND ART

Mobile communication systems have been developed to provide voice services while ensuring the activity of a user. However, the mobile communication systems have been expanded to their regions up to data services as well as voice. Today, the shortage of resources is caused due to an explosive increase of traffic, and more advanced mobile communication systems are required due to user's need for higher speed services.

Requirements for a next-generation mobile communication system basically include the acceptance of explosive data traffic, a significant increase of a transfer rate per user, the acceptance of the number of significantly increased connection devices, very low end-to-end latency, and high energy efficiency. To this end, research is carried out on various technologies, such as dual connectivity, massive Multiple Input Multiple Output (MIMO), in-band full duplex, Non-Orthogonal Multiple Access (NOMA), the support of a super wideband, and device networking.

### DISCLOSURE

### Technical Problem

The present invention proposes a method for a user equipment to transmit (feedback or report) channel state information (CSI) (e.g., CQI) to a base station in a wireless communication system supporting a short transmission time interval (short TTI, sTTI).

Furthermore, the present invention proposes a method of segmenting (or dividing) the CSI for each step and transmitting the CSI to a base station in multiple sTTI.

Furthermore, the present invention proposes a method of transmitting CSI in a wireless communication system supporting an sTTI and multiple input multiple output (MIMO) transmission.

Furthermore, the present invention proposes a method of differently configuring the length of a transmitted sTTI based on a CSI size.

Furthermore, the present invention proposes a method of multiplexing different user equipments when the different user equipments perform CSI transmission.

Furthermore, the present invention proposes a method of transmitting different uplink control information (e.g., a scheduling request, ACK/NACK information) along with CSI transmission.

Technical objects to be achieved by the present invention are not limited to the aforementioned technical objects, and other technical objects not described above may be evidently understood by a person having ordinary skill in the art to which the present invention pertains from the following description.

### Technical Solution

In a method of transmitting channel state information (CSI) in a wireless communication system supporting a short transmission time interval (short TTI) according to an embodiment of the present invention, the method performed by a user equipment includes transmitting, to a base station, first CSI for a downlink channel received from the base station, in a first TTI, and transmitting, to the base station, second CSI for the received downlink channel, in a second TTI, wherein the first CSI includes information indicating a specific region including one or more indices related to the CSI, and wherein the second CSI may include information indicating a specific index corresponding to a channel state of the received downlink channel among the one or more indices.

Furthermore, in one embodiment of the present invention, when a plurality of indices related to the CSI is configured as one or more index groups, the information indicating the specific region may include information indicating a specific index group of the one or more index groups, and the information indicating the specific index may include information indicating an index corresponding to the channel state of the received downlink channel among one or more indices included in the specific index group.

Furthermore, in one embodiment of the present invention, the plurality of indices related to the CSI may include at least one of a plurality of indices for a channel quality indicator (CQI) and a plurality of indices for a precoding matrix indicator (PMI).

Furthermore, in one embodiment of the present invention, the plurality of indices for the CQI may be represented as 4-bit information, and the first CSI and the second CSI may be represented as bit information of a number smaller than 4.

Furthermore, in one embodiment of the present invention, configuration information for the one or more index groups may be received from the base station, through at least one of high layer signaling or physical layer signaling.

Furthermore, in one embodiment of the present invention, the information indicating the specific region may include information indicating a starting point of the specific region, and the information indicating the specific index may include offset information between an index corresponding to the starting point and the specific index.

Furthermore, in one embodiment of the present invention, the first TTI and the second TTI may include one or more different symbols.

Furthermore, in one embodiment of the present invention, when the number of bits configuring the first CSI is smaller than a number of bits configuring the second CSI, the number of symbols configuring the first TTI may be set smaller than a number of symbols configuring the second TTI.

Furthermore, in one embodiment of the present invention, when the number of bits configuring the first CSI is greater than the number of bits configuring the second CSI, the number of symbols configuring the first TTI may be set greater than the number of symbols configuring the second TTI.

Furthermore, in another embodiment of the present invention, a user equipment transmitting channel state information (CSI) in a wireless communication system supporting a short transmission time interval (short TTI) includes a transceiver for transmitting and receiving radio signals and a processor functionally connected to the transceiver, wherein the processor controls to transmit, to a base station, first CSI for a downlink channel received from the base station, in a first TTI and transmit, to the base station, second CSI for the received downlink channel, in a second TTI. The first CSI may include information indicating a specific region including one or more indices related to the CSI, and the second CSI may include information indicating a specific index corresponding to a channel state of the received downlink channel among the one or more indices.

Furthermore, the in another embodiment of the present invention, when a plurality of indices related to the CSI is configured as one or more index groups, the information indicating the specific region may include information indicating a specific index group of the one or more index groups. The information indicating the specific index may include information indicating an index corresponding to the channel state of the received downlink channel among one or more indices included in the specific index group.

Furthermore, in another embodiment of the present invention, the information indicating the specific region may include information indicating a starting point of the specific region. The information indicating the specific index may include offset information between an index corresponding to the starting point and the specific index.

### Advantageous Effects

In accordance with an embodiment of the present invention, in a wireless communication system supporting a short transmission time interval (sTTI), a user equipment can transmit channel state information through an sTTI configured by a base station.

Furthermore, in accordance with an embodiment of the present invention, as the number of bits transmitted for channel state information per sTTI unit is reduced, a code rate in a corresponding sTTI can be reduced.

Furthermore, in accordance with an embodiment of the present invention, as the sTTI of a different length is configured based on the size of channel state information, a code rate in a corresponding sTTI can be efficiently controlled.

Furthermore, in accordance with an embodiment of the present invention, as different uplink control information (e.g., a scheduling request, ACK/NACK information) is simultaneously transmitted while CSI is transmitted using an sTTI, latency taken to transmit the corresponding different uplink control information can be reduced.

Effects which may be obtained by the present invention are not limited to the aforementioned effects, and other technical effects not described above may be evidently understood by a person having ordinary skill in the art to which the present invention pertains from the following description.

### DESCRIPTION OF DRAWINGS

The accompanying drawings included as part of the detailed description in order to help understanding of the present invention provide embodiments of the present invention, and describe the technical characteristics of the present invention along with the detailed description.

FIG. 1 illustrates the structure of a radio frame in a wireless communication system to which the present invention may be applied.

FIG. 2 is a diagram illustrating a resource grid for one downlink slot in a wireless communication system to which the present invention may be applied.

FIG. 3 illustrates the structure of a downlink subframe in a wireless communication system to which the present invention may be applied.

FIG. 4 illustrates the structure of an uplink subframe in a wireless communication system to which the present invention may be applied.

FIG. 5 illustrates an example of a form in which physical uplink control channel (PUCCH) formats are mapped to the PUCCH region of an uplink physical resource block in a wireless communication system to which the present invention may be applied.

FIG. 6 illustrates the structure of a channel quality indicator (CQI) channel in the case of a normal cyclic prefix (CP) in a wireless communication system to which the present invention may be applied.

FIG. 7 illustrates the structure of an ACK/NACK channel in the case of a normal CP in a wireless communication system to which the present invention may be applied.

FIG. 8 illustrates an example of the transport channel processing of an uplink shared channel (UL-SCH) in a wireless communication system to which the present invention may be applied.

FIG. 9 illustrates an example of the signal processing process of an uplink shared channel, that is, a transport channel, in a wireless communication system to which the present invention may be applied.

FIG. 10 illustrates reference signal patterns mapped to downlink resource block pairs in a wireless communication system to which the present invention may be applied.

FIG. 11 illustrates am uplink subframe including a sounding reference signal symbol in a wireless communication system to which the present invention may be applied.

FIG. 12 illustrates examples of component carriers and carrier aggregations in a wireless communication system to which the present invention may be applied.

FIG. 13 illustrates an example of a subframe structure according to cross carrier scheduling in a wireless communication system to which the present invention may be applied.

FIG. 14 illustrates an example in which 5 SC-FDMA symbols are generated and transmitted for one slot in a wireless communication system to which the present invention may be applied.

FIG. 15 is a diagram illustrating a time-frequency resource block in a time frequency domain in a wireless communication system to which the present invention may be applied.

FIG. 16 is a diagram illustrating a resource allocation and retransmission process of an asynchronous HARQ method in a wireless communication system to which the present invention may be applied.

FIG. 17 is a diagram illustrating a carrier aggregation-based CoMP system in a wireless communication system to which the present invention may be applied.

FIG. 18 is a diagram showing an example in which a legacy PDCCH, a PDSCH and E-PDCCHs are multiplexed to which the present invention may be applied.

FIG. 19 illustrates an example of the mapping of modulation symbols to a PUCCH to which the present invention may be applied.

FIG. 20 illustrates examples of sTTI structures and PUCCH formats which may be taken into consideration under corresponding sTTI structures to which the present invention may be applied.

FIG. 21 illustrates an example of a method of transmitting CSI in an sTTI structure to which the present invention may be applied.

FIG. 22 illustrates the indices of CQIs transmitted in 4 bits to which the present invention may be applied.

FIGS. 23a to 23d illustrate examples of a method for a user equipment to transmit a CQI through an sTTI in a system supporting MIMO transmission to which the present invention may be applied.

FIG. 24 illustrates an example of a method for a user equipment to transmit a CQI for two codewords to which the present invention may be applied.

FIG. 25 illustrates an example of a 7-symbol sTTI structure for transmitting CSI to which the present invention may be applied.

FIG. 26 illustrates an example of multiplexing between user equipments for CSI transmission to which the present invention may be applied.

FIG. 27 illustrates another example of multiplexing between user equipments for CSI transmission to which the present invention may be applied.

FIG. 28 illustrates an example of a CS index configuration in which a user equipment transmits CSI and an SR to a base station to which the present invention may be applied.

FIG. 29 illustrates an example of a CS index configuration in which a user equipment transmits CSI and ACK/NACK information to a base station to which the present invention may be applied.

FIG. 30 illustrates an operating flowchart of a user equipment to transmit channel state information (CSI) to a base station to which the present invention may be applied.

FIG. 31 illustrates a block diagram of a wireless communication apparatus according to an embodiment of the present invention.

### MODE FOR INVENTION

Hereinafter, preferred embodiments of the present invention will be described in detail with reference to the accompanying drawings. A detailed description to be disclosed below together with the accompanying drawing is to describe embodiments of the present invention and not to describe a unique embodiment for carrying out the present invention. The detailed description below includes details in order to provide a complete understanding. However, those skilled in the art know that the present invention can be carried out without the details.

In some cases, in order to prevent a concept of the present invention from being ambiguous, known structures and devices may be omitted or may be illustrated in a block diagram format based on core function of each structure and device.

In the specification, a base station means a terminal node of a network directly performing communication with a terminal. In the present document, specific operations described to be performed by the base station may be performed by an upper node of the base station in some cases. That is, it is apparent that in the network constituted by multiple network nodes including the base station, various operations performed for communication with the terminal may be performed by the base station or other network nodes other than the base station. A base station (BS) may be generally substituted with terms such as a fixed station, Node B, evolved-NodeB (eNB), a base transceiver system (BTS), an access point (AP), and the like. Further, a ‘terminal’ may be fixed or movable and be substituted with terms such as user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, a downlink means communication from the base station to the terminal and an uplink means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help appreciating the present invention and the use of the specific terms may be modified into other forms within the scope without departing from the technical spirit of the present invention.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as global system for mobile communications (GSM)/general packet radio service (GPRS)/enhanced data rates for GSM Evolution (EDGE). The OFDMA may be implemented as radio technology such as IEEE 802.11(Wi-Fi), IEEE 802.16 (WiMAX), IEEE 802-20, E-UTRA (Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

The embodiments of the present invention may be based on standard documents disclosed in at least one of IEEE 802, 3GPP, and 3GPP2 which are the wireless access systems. That is, steps or parts which are not described to definitely show the technical spirit of the present invention among the embodiments of the present invention may be based on the documents. Further, all terms disclosed in the document may be described by the standard document.

3GPP LTE/LTE-A is primarily described for clear description, but technical features of the present invention are not limited thereto.

General System

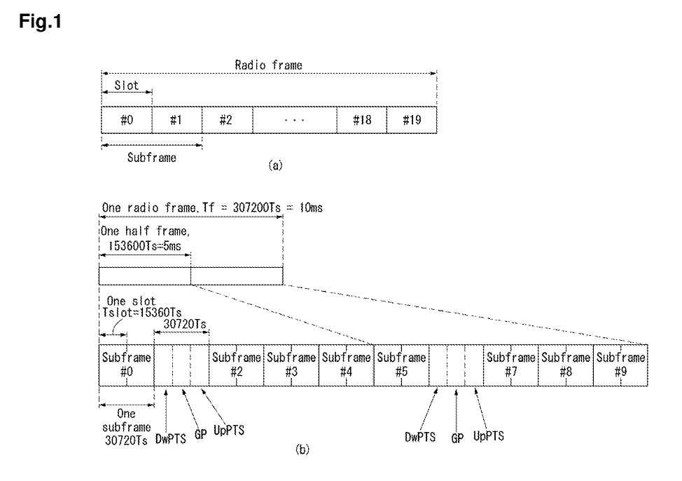

FIG. 1 illustrates a structure a radio frame in a wireless communication system to which the present invention can be applied.

In 3GPP LTE/LTE-A, radio frame structure type 1 may be applied to frequency division duplex (FDD) and radio frame structure type 2 may be applied to time division duplex (TDD) are supported.

In FIG. 1, the size of the radio frame in the time domain is represented by a multiple of a time unit of T_s=1/(15000*2048). The downlink and uplink transmissions are composed of radio frames having intervals of T_f=307200*T_s=10 ms.

FIG. 1(a) illustrates the type 1 radio frame structure. The type 1 radio frame may be applied to both full duplex FDD and half duplex FDD.

The radio frame includes 10 subframes. One radio frame includes 20 slots each having a length of T_slot=15360*T_s=0.5 ms. Indices 0 to 19 are assigned to the respective slots. One subframe includes two contiguous slots in the time domain, and a subframe i includes a slot 2i and a slot 2i+1. The time taken to send one subframe is called a transmission time interval (TTI). For example, the length of one subframe may be 1 ms, and the length of one slot may be 0.5 ms.

In FDD, uplink transmission and downlink transmission are classified in the frequency domain. There is no restriction to full duplex FDD, whereas a UE is unable to perform transmission and reception at the same time in a half duplex FDD operation.

One slot includes a plurality of orthogonal frequency division multiplexing (OFDM) symbols in the time domain and includes a plurality of resource blocks (RBs) in the frequency domain. An OFDM symbol is for expressing one symbol period because 3GPP LTE uses OFDMA in downlink. The OFDM symbol may also be called an SC-FDMA symbol or a symbol period. The resource block is a resource allocation unit and includes a plurality of contiguous subcarriers in one slot.

FIG. 1(b) shows the type 2 radio frame structure. The type 2 radio frame structure includes 2 half frames each having a length of 153600*T_s=5 ms. Each of the half frames includes 5 subframes each having a length of 30720*T_s=1 ms.

In the type 2 radio frame structure of a TDD system, an uplink-downlink configuration is a rule showing how uplink and downlink are allocated (or reserved) with respect to all of subframes. Table 1 shows the uplink-downlink confiquration.

TABLE 1

| Uplink- | Downlink- | | | | | | | | | | | |
|---|---|---|---|---|---|---|---|---|---|---|---|---|
| Downlink | to-Uplink | | | | | | | | | | | |
| config- | Switch-point | | Subframe number | | | | | | | | | |
| uration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

Referring to Table 1, “D” indicates a subframe for downlink transmission, “U” indicates a subframe for uplink transmission, and “S” indicates a special subframe including the three fields of a downlink pilot time slot (DwPTS), a guard period (GP), and an uplink pilot time slot (UpPTS) for each of the subframes of the radio frame.

The DwPTS is used for initial cell search, synchronization or channel estimation by a UE. The UpPTS is used for an eNB to perform channel estimation and for a UE to perform uplink transmission synchronization. The GP is an interval for removing interference occurring in uplink due to the multi-path delay of a downlink signal between uplink and downlink.

Each subframe i includes the slot 2i and the slot 2i+1 each having “T_slot=15360*T_s=0.5 ms.”

The uplink-downlink configuration may be divided into seven types. The location and/or number of downlink subframes, special subframes, and uplink subframes are different in the seven types.

A point of time changed from downlink to uplink or a point of time changed from uplink to downlink is called a switching point. Switch-point periodicity means a cycle in which a form in which an uplink subframe and a downlink subframe switch is repeated in the same manner. The switch-point periodicity supports both 5 ms and 10 ms. In the case of a cycle of the 5 ms downlink-uplink switching point, the special subframe S is present in each half frame. In the case of the cycle of the 5 ms downlink-uplink switching point, the special subframe S is present only in the first half frame.

In all of the seven configurations, No. 0 and No. 5 subframes and DwPTSs are an interval for only downlink transmission. The UpPTSs, the subframes, and a subframe subsequent to the subframes are always an interval for uplink transmission.

Both an eNB and a UE may be aware of such uplink-downlink configurations as system information. The eNB may notify the UE of a change in the uplink-downlink allocation state of a radio frame by sending only the index of configuration information whenever uplink-downlink configuration information is changed. Furthermore, the configuration information is a kind of downlink control information. Like scheduling information, the configuration information may be transmitted through a physical downlink control channel (PDCCH) and may be transmitted to all of UEs within a cell in common through a broadcast channel as broadcast information.

Table 2 shows a configuration (i.e., the length of a DwPTS/GP/UpPTS) of the special subframe.

TABLE 2

| | Normal cyclic prefix in downlink | | | Extended cyclic prefix in downlink | | |
|---|---|---|---|---|---|---|
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

The structure of the radio frame according to the example of FIG. 1 is only one example. The number of subcarriers included in one radio frame, the number of slots included in one subframe, and the number of OFDM symbols included in one slot may be changed in various manners.

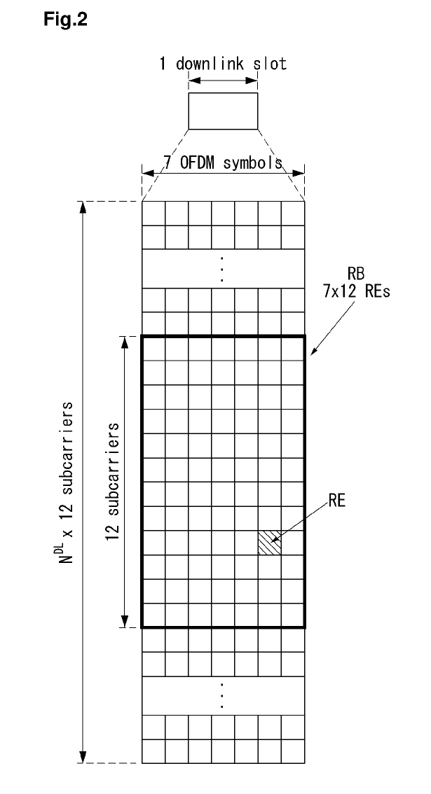

FIG. 2 is a diagram illustrating a resource grid for one downlink slot in the wireless communication system to which the present invention can be applied.

Referring to FIG. 2, one downlink slot includes the plurality of OFDM symbols in the time domain. Herein, it is exemplarily described that one downlink slot includes 7 OFDM symbols and one resource block includes 12 subcarriers in the frequency domain, but the present invention is not limited thereto.

Each element on the resource grid is referred to as a resource element and one resource block includes 12×7 resource elements. The number of resource blocks included in the downlink slot, NDL is subordinated to a downlink transmission bandwidth.

A structure of the uplink slot may be the same as that of the downlink slot.

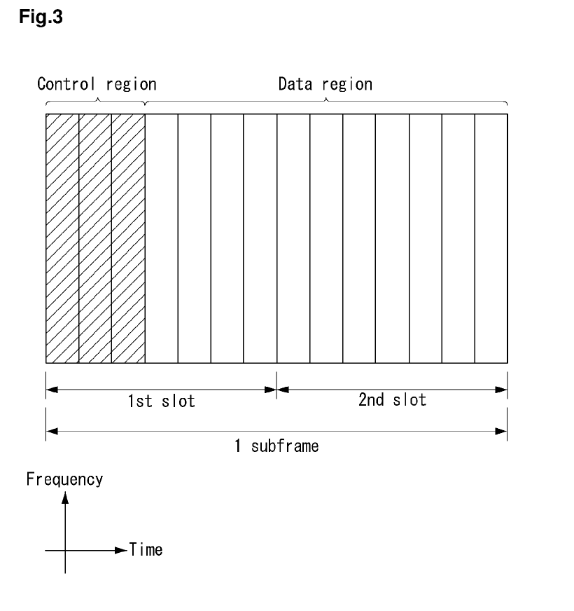

FIG. 3 illustrates a structure of a downlink subframe in the wireless communication system to which the present invention can be applied.

Referring to FIG. 3, a maximum of three former OFDM symbols in the first slot of the sub frame is a control region to which control channels are allocated and residual OFDM symbols is a data region to which a physical downlink shared channel (PDSCH) is allocated. Examples of the downlink control channel used in the 3GPP LTE include a Physical Control Format Indicator Channel (PCFICH), a Physical Downlink Control Channel (PDCCH), a Physical Hybrid-ARQ Indicator Channel (PHICH), and the like.

The PFCICH is transmitted in the first OFDM symbol of the subframe and transports information on the number (that is, the size of the control region) of OFDM symbols used for transmitting the control channels in the subframe. The PHICH which is a response channel to the uplink transports an Acknowledgement (ACK)/Not-Acknowledgement (NACK) signal for a hybrid automatic repeat request (HARQ). Control information transmitted through a PDCCH is referred to as downlink control information (DCI). The downlink control information includes uplink resource allocation information, downlink resource allocation information, or an uplink transmission (Tx) power control command for a predetermined terminal group.

The PDCCH may transport A resource allocation and transmission format (also referred to as a downlink grant) of a downlink shared channel (DL-SCH), resource allocation information (also referred to as an uplink grant) of an uplink shared channel (UL-SCH), paging information in a paging channel (PCH), system information in the DL-SCH, resource allocation for an upper-layer control message such as a random access response transmitted in the PDSCH, an aggregate of transmission power control commands for individual terminals in the predetermined terminal group, a voice over IP (VoIP). A plurality of PDCCHs may be transmitted in the control region and the terminal may monitor the plurality of PDCCHs. The PDCCH is constituted by one or an aggregate of a plurality of continuous control channel elements (CCEs). The CCE is a logical allocation wise used to provide a coding rate depending on a state of a radio channel to the PDCCH. The CCEs correspond to a plurality of resource element groups. A format of the PDCCH and a bit number of usable PDCCH are determined according to an association between the number of CCEs and the coding rate provided by the CCEs.

The base station determines the PDCCH format according to the DCI to be transmitted and attaches the control information to a cyclic redundancy check (CRC) to the control information. The CRC is masked with a unique identifier (referred to as a radio network temporary identifier (RNTI)) according to an owner or a purpose of the PDCCH. In the case of a PDCCH for a specific terminal, the unique identifier of the terminal, for example, a cell-RNTI (C-RNTI) may be masked with the CRC. Alternatively, in the case of a PDCCH for the paging message, a paging indication identifier, for example, the CRC may be masked with a paging-RNTI (P-RNTI). In the case of a PDCCH for the system information, in more detail, a system information block (SIB), the CRC may be masked with a system information identifier, that is, a system information (SI)-RNTI. The CRC may be masked with a random access (RA)-RNTI in order to indicate the random access response which is a response to transmission of a random access preamble.

Enhanced PDCCH (EPDCCH) carries UE-specific signaling. The EPDCCH is located in a physical resource block (PRB) that is set to be terminal specific. In other words, as described above, the PDCCH can be transmitted in up to three OFDM symbols in the first slot in the subframe, but the EPDCCH can be transmitted in a resource region other than the PDCCH. The time (i.e., symbol) at which the EPDCCH in the subframe starts may be set in the UE through higher layer signaling (e.g., RRC signaling, etc.).

The EPDCCH is a transport format, a resource allocation and HARQ information associated with the DL-SCH and a transport format, a resource allocation and HARQ information associated with the UL-SCH, and resource allocation information associated with SL-SCH (Sidelink Shared Channel) and PSCCH Information, and so on. Multiple EPDCCHs may be supported and the terminal may monitor the set of EPCCHs.

The EPDCCH can be transmitted using one or more successive advanced CCEs (ECCEs), and the number of ECCEs per EPDCCH can be determined for each EPDCCH format.

Each ECCE may be composed of a plurality of enhanced resource element groups (EREGs). EREG is used to define the mapping of ECCE to RE. There are 16 EREGs per PRB pair. All REs are numbered from 0 to 15 in the order in which the frequency increases, except for the RE that carries the DMRS in each PRB pair.

The UE can monitor a plurality of EPDCCHs. For example, one or two EPDCCH sets may be set in one PRB pair in which the terminal monitors the EPDCCH transmission.

Different coding rates can be realized for the EPCCH by merging different numbers of ECCEs. The EPCCH may use localized transmission or distributed transmission, which may result in different mapping of the ECCE to the REs in the PRB.

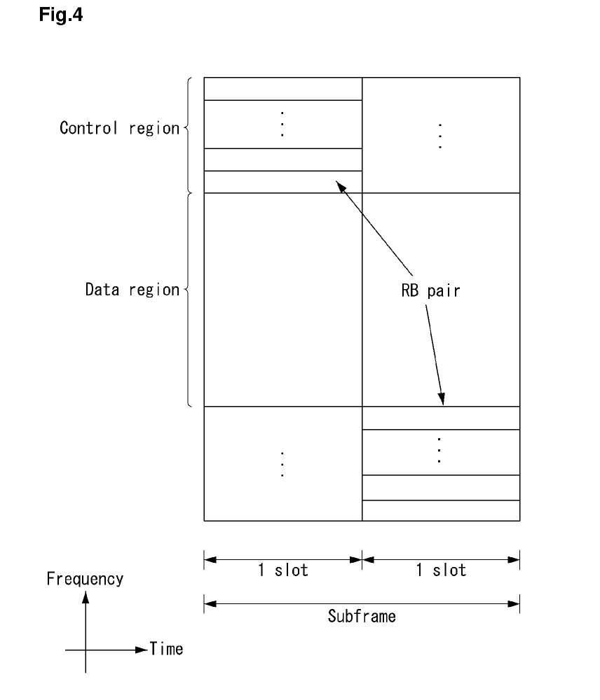

FIG. 4 illustrates a structure of an uplink subframe in the wireless communication system to which the present invention can be applied.

Referring to FIG. 4, the uplink subframe may be divided into the control region and the data region in a frequency domain. A physical uplink control channel (PUCCH) transporting uplink control information is allocated to the control region. A physical uplink shared channel (PUSCH) transporting user data is allocated to the data region. One terminal does not simultaneously transmit the PUCCH and the PUSCH in order to maintain a single carrier characteristic.

A resource block (RB) pair in the subframe is allocated to the PUCCH for one terminal. RBs included in the RB pair occupy different subcarriers in two slots, respectively. The RB pair allocated to the PUCCH frequency-hops in a slot boundary.

PUCCH (Physical Uplink Control Channel)

The uplink control information (UCI) transmitted through the PUCCH may include a scheduling request (SR), HARQ ACK/NACK information, and downlink channel measurement information.
Scheduling request (SR): information used to request an uplink UL-SCH resource. It is transmitted using an on-off keying (OOK) method.
HARQ ACK/NACK: a response signal for a downlink data packet on a PDSCH. It indicates whether a downlink data packet is successfully received. ACK/NACK 1 bit is transmitted as a response to a single downlink codeword, and ACK/NACK 2 bits are transmitted as a response to 2 downlink codewords.
Channel state information (CSI): feedback information for a downlink channel. CSI may include at least any one of a channel quality indicator (CQI), a rank indicator (RI), a precoding matrix indicator (PMI) and a precoding type indicator (PTI). 20 bits are used per subframe.

The HARQ ACK/NACK information may be generated according to a downlink data packet on the PDSCH is successfully decoded. In the existing wireless communication system, 1 bit is transmitted as ACK/NACK information with respect to downlink single codeword transmission and 2 bits are transmitted as the ACK/NACK information with respect to downlink 2-codeword transmission.

The channel measurement information which designates feedback information associated with a multiple input multiple output (MIMO) technique may include a channel quality indicator (CQI), a precoding matrix index (PMI), and a rank indicator (RI). The channel measurement information may also be collectively expressed as the CQI.

20 bits may be used per subframe for transmitting the CQI.

The PUCCH may be modulated by using binary phase shift keying (BPSK) and quadrature phase shift keying (QPSK) techniques. Control information of a plurality of terminals may be transmitted through the PUCCH and when code division multiplexing (CDM) is performed to distinguish signals of the respective terminals, a constant amplitude zero autocorrelation (CAZAC) sequence having a length of 12 is primary used. Since the CAZAC sequence has a characteristic to maintain a predetermined amplitude in the time domain and the frequency domain, the CAZAC sequence has a property suitable for increasing coverage by decreasing a peak-to-average power ratio (PAPR) or cubic metric (CM) of the terminal. Further, the ACK/NACK information for downlink data transmission performed through the PUCCH is covered by using an orthogonal sequence or an orthogonal cover (OC).

Further, the control information transmitted on the PUCCH may be distinguished by using a cyclically shifted sequence having different cyclic shift (CS) values. The cyclically shifted sequence may be generated by cyclically shifting a base sequence by a specific cyclic shift (CS) amount. The specific CS amount is indicated by the cyclic shift (CS) index. The number of usable cyclic shifts may vary depending on delay spread of the channel. Various types of sequences may be used as the base sequence the CAZAC sequence is one example of the corresponding sequence.

Further, the amount of control information which the terminal may transmit in one subframe may be determined according to the number (that is, SC-FDMA symbols other an SC-FDMA symbol used for transmitting a reference signal (RS) for coherent detection of the PUCCH) of SC-FDMA symbols which are usable for transmitting the control information.

In the 3GPP LTE system, the PUCCH is defined as a total of 7 different formats according to the transmitted control information, a modulation technique, the amount of control information, and the like and an attribute of the uplink control information (UCI) transmitted according to each PUCCH format may be summarized as shown in Table 3 given below.

TABLE 3

| PUCCH Format | Uplink Control Information(UCI) |
|---|---|
| Format 1 | Scheduling Request(SR)(unmodulated |
| | waveform) |
| Format 1a | 1-bit HARQ ACK/NACK with/without SR |
| Format 1b | 2-bit HARQ ACK/NACK with/without SR |
| Format 2 | CQI (20 coded bits) |
| Format 2 | CQI and 1- or 2-bit HARQ ACK/NACK |
| | (20 bits) for extended CP only |
| Format 2a | CQI and 1-bit HARQ ACK/NACK |
| | (20 + 1 coded bits) |
| Format 2b | CQI and 2-bit HARQ ACK/NACK |
| | (20 + 2 coded bits) |
| Format 3 | HARQ ACK/NACK, SR, CSI (48 coded bits) |

PUCCH format 1 is used for transmitting only the SR. A waveform which is not modulated is adopted in the case of transmitting only the SR and this will be described below in detail.

PUCCH format 1a or 1b is used for transmitting the HARQ ACK/NACK. PUCCH format 1a or 1b may be used when only the HARQ ACK/NACK is transmitted in a predetermined subframe. Alternatively, the HARQ ACK/NACK and the SR may be transmitted in the same subframe by using PUCCH format 1a or 1b.

The PUCCH format 2 is used for the transmission of a CQI, and the PUCCH format 2a or 2b is used for the transmission of a CQI and HARQ ACK/NACK. In the case of an extended CP, the PUCCH format 2 may be used for the transmission of a CQI and HARQ ACK/NACK.

The PUCCH format 3 is used to carry encoded UCI of 48 bits. The PUCCH format 3 may carry HARQ ACK/NACK, SR (if any) for a plurality of serving cells and CSI reporting for one serving cell.

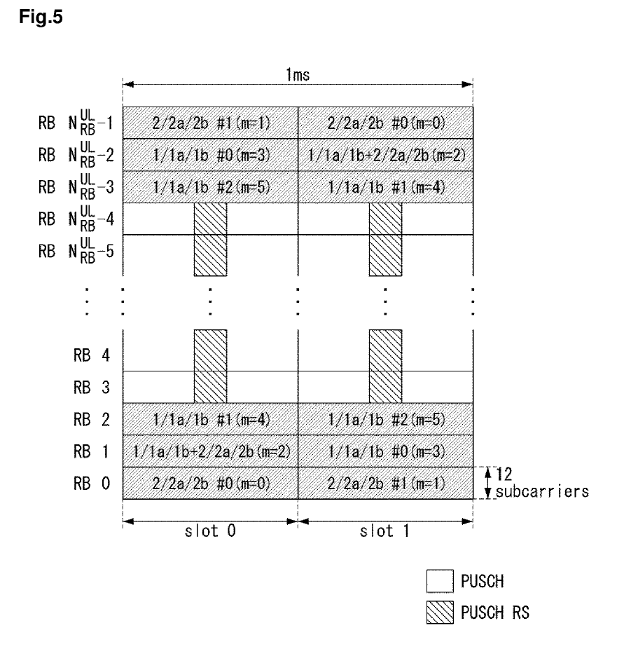

FIG. 5 illustrates one example of a type in which PUCCH formats are mapped to a PUCCH region of an uplink physical resource block in the wireless communication system to which the present invention can be applied.

In FIG. 5, N_{RB}^{UL} represents the number of resource blocks in the uplink and 0, 1, . . . , N_{RB}^{UL}−1 mean numbers of physical resource blocks. Basically, the PUCCH is mapped to both edges of an uplink frequency block. As illustrated in FIG. 5, PUCCH format 2/2a/2b is mapped to a PUCCH region expressed as m=0, 1 and this may be expressed in such a manner that PUCCH format 2/2a/2b is mapped to resource blocks positioned at a band edge. Further, both PUCCH format 2/2a/2b and PUCCH format 1/1a/1b may be mixed and mapped to a PUCCH region expressed as m=2. Next, PUCCH format 1/1a/1b may be mapped to a PUCCH region expressed as m=3, 4, and 5. The number (N_{RB}⁽²⁾) of PUCCH RBs which are usable by PUCCH format 2/2a/2b may be indicated to terminals in the cell by broadcasting signaling.

PUCCH format 2/2a/2b is described. PUCCH format 2/2a/2b is a control channel for transmitting channel measurement feedback (CQI, PMI, and RI).

A reporting period of the channel measurement feedbacks (hereinafter, collectively expressed as CQI information) and a frequency wise (alternatively, a frequency resolution) to be measured may be controlled by the base station. In the time domain, periodic and aperiodic CQI reporting may be supported. PUCCH format 2 may be used for only the periodic reporting and the PUSCH may be used for aperiodic reporting. In the case of the aperiodic reporting, the base station may instruct the terminal to transmit a scheduling resource loaded with individual CQI reporting for the uplink data transmission.

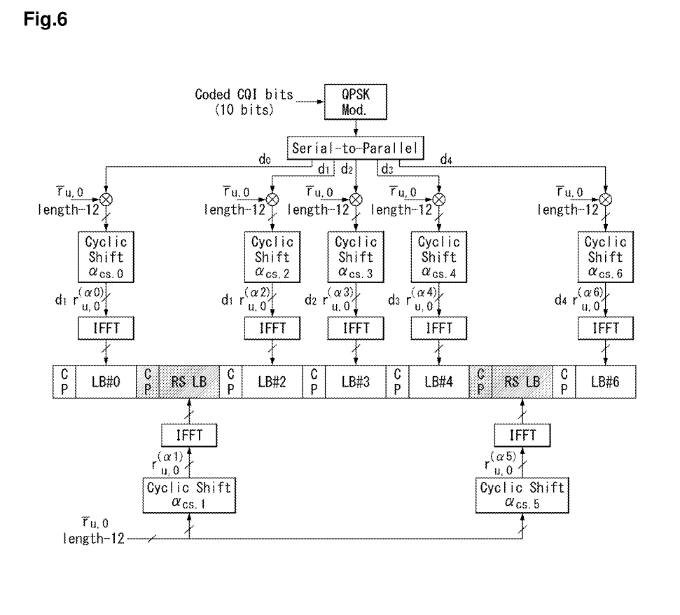

FIG. 6 illustrates a structure of a CQI channel in the case of a general CP in the wireless communication system to which the present invention can be applied.

In SC-FDMA symbols 0 to 6 of one slot, SC-FDMA symbols 1 and 5 (second and sixth symbols) may be used for transmitting a demodulation reference signal and the CQI information may be transmitted in the residual SC-FDMA symbols. Meanwhile, in the case of the extended CP, one SC-FDMA symbol (SC-FDMA symbol 3) is used for transmitting the DMRS.

In PUCCH format 2/2a/2b, modulation by the CAZAC sequence is supported and the CAZAC sequence having the length of 12 is multiplied by a QPSK-modulated symbol. The cyclic shift (CS) of the sequence is changed between the symbol and the slot. The orthogonal covering is used with respect to the DMRS.

The reference signal (DMRS) is loaded on two SC-FDMA symbols separated from each other by 3 SC-FDMA symbols among 7 SC-FDMA symbols included in one slot and the CQI information is loaded on 5 residual SC-FDMA symbols. Two RSs are used in one slot in order to support a high-speed terminal. Further, the respective terminals are distinguished by using the CS sequence. CQI information symbols are modulated and transferred to all SC-FDMA symbols and the SC-FDMA symbol is constituted by one sequence. That is, the terminal modulates and transmits the CQI to each sequence.

The number of symbols which may be transmitted to one TTI is 10 and modulation of the CQI information is determined up to QPSK. When QPSK mapping is used for the SC-FDMA symbol, since a CQI value of 2 bits may be loaded, a CQI value of 10 bits may be loaded on one slot. Therefore, a CQI value of a maximum of 20 bits may be loaded on one subframe. A frequency domain spread code is used for spreading the CQI information in the frequency domain.

The CAZAC sequence (for example, ZC sequence) having the length of 12 may be used as the frequency domain spread code. CAZAC sequences having different CS values may be applied to the respective control channels to be distinguished from each other. IFFT is performed with respect to the CQI information in which the frequency domain is spread.

12 different terminals may be orthogonally multiplexed on the same PUCCH RB by a cyclic shift having 12 equivalent intervals. In the case of a general CP, a DMRS sequence on SC-FDMA symbol 1 and 5 (on SC-FDMA symbol 3 in the case of the extended CP) is similar to a CQI signal sequence on the frequency domain, but the modulation of the CQI information is not adopted.

The terminal may be semi-statically configured by upper-layer signaling so as to periodically report different CQI, PMI, and RI types on PUCCH resources indicated as PUCCH resource indexes (n_{PUCCH}^{(1,\tilde{p})}, n_{PUCCH}^{(2,\tilde{p})}, and n_{PUCCH}^{(3,\tilde{p})}). Herein, the PUCCH resource index (n_{PUCCH}^{(2,\tilde{p})}) is information indicating the PUCCH region used for PUCCH format 2/2a/2b and a CS value to be used.

Below, PUCCH formats 1a and 1b are described.

In PUCCH format 1a and 1b, the CAZAC sequence having the length of 12 is multiplied by a symbol modulated by using a BPSK or QPSK modulation scheme. For example, a result acquired by multiplying a modulated symbol d(0) by a CAZAC sequence r(n) (n=0, 1, 2, . . . , N−1) having a length of N becomes y(0), y(1), y(2), . . . , y(N−1). y(0), . . . , y(N−1) symbols may be designated as a block of symbols. The modulated symbol is multiplied by the CAZAC sequence and thereafter, the block-wise spread using the orthogonal sequence is adopted.

A Hadamard sequence having a length of 4 is used with respect to general ACK/NACK information and a discrete Fourier transform (DFT) sequence having a length of 3 is used with respect to the ACK/NACK information and the reference signal.

The Hadamard sequence having the length of 2 is used with respect to the reference signal in the case of the extended CP.

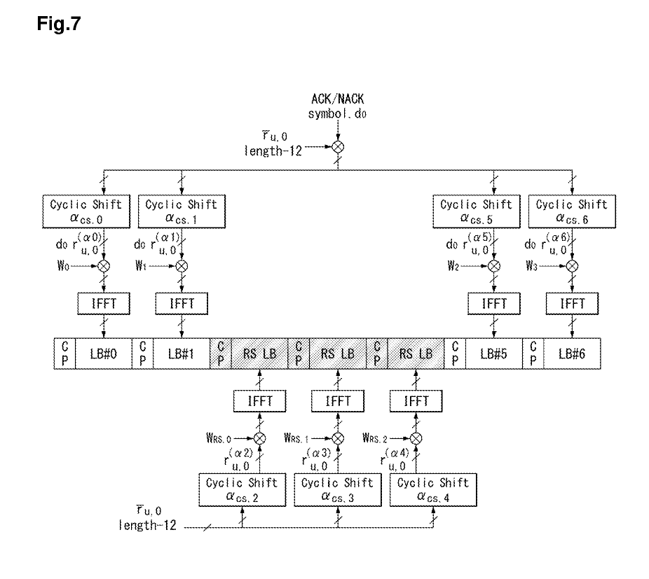

FIG. 7 illustrates a structure of an ACK/NACK channel in the case of a general CP in the wireless communication system to which the present invention can be applied.

In FIG. 7, a PUCCH channel structure for transmitting the HARQ ACK/NACK without the CQI is exemplarily illustrated.

The reference signal (DMRS) is loaded on three consecutive SC-FDMA symbols in a middle part among 7 SC-FDMA symbols and the ACK/NACK signal is loaded on 4 residual SC-FDMA symbols.

Meanwhile, in the case of the extended CP, the RS may be loaded on two consecutive symbols in the middle part. The number of and the positions of symbols used in the RS may vary depending on the control channel and the numbers and the positions of symbols used in the ACK/NACK signal associated with the positions of symbols used in the RS may also correspondingly vary depending on the control channel.

Acknowledgment response information (not scrambled status) of 1 bit and 2 bits may be expressed as one HARQ ACK/NACK modulated symbol by using the BPSK and QPSK modulation techniques, respectively. A positive acknowledgement response (ACK) may be encoded as ‘1’ and a negative acknowledgment response (NACK) may be encoded as ‘0’.

When a control signal is transmitted in an allocated band, 2-dimensional (D) spread is adopted in order to increase a multiplexing capacity. That is, frequency domain spread and time domain spread are simultaneously adopted in order to increase the number of terminals or control channels which may be multiplexed.

A frequency domain sequence is used as the base sequence in order to spread the ACK/NACK signal in the frequency domain. A Zadoff-Chu (ZC) sequence which is one of the CAZAC sequences may be used as the frequency domain sequence. For example, different CSs are applied to the ZC sequence which is the base sequence, and as a result, multiplexing different terminals or different control channels may be applied. The number of CS resources supported in an SC-FDMA symbol for PUCCH RBs for HARQ ACK/NACK transmission is set by a cell-specific upper-layer signaling parameter (Δ_{shift}^{PUCCH}).

The ACK/NACK signal which is frequency-domain spread is spread in the time domain by using an orthogonal spreading code. As the orthogonal spreading code, a Walsh-Hadamard sequence or DFT sequence may be used. For example, the ACK/NACK signal may be spread by using an orthogonal sequence (w0, w1, w2, and w3) having the length of 4 with respect to 4 symbols. Further, the RS is also spread through an orthogonal sequence having the length of 3 or 2. This is referred to as orthogonal covering (OC).

Multiple terminals may be multiplexed by a code division multiplexing (CDM) scheme by using the CS resources in the frequency domain and the OC resources in the time domain described above. That is, ACK/NACK information and RSs of a lot of terminals may be multiplexed on the same PUCCH RB.

In respect to the time-domain spread CDM, the number of spreading codes supported with respect to the ACK/NACK information is limited by the number of RS symbols. That is, since the number of RS transmitting SC-FDMA symbols is smaller than that of ACK/NACK information transmitting SC-FDMA symbols, the multiplexing capacity of the RS is smaller than that of the ACK/NACK information.

For example, in the case of the general CP, the ACK/NACK information may be transmitted in four symbols and not 4 but 3 orthogonal spreading codes are used for the ACK/NACK information and the reason is that the number of RS transmitting symbols is limited to 3 to use only 3 orthogonal spreading codes for the RS.

In the case of the subframe of the general CP, when 3 symbols are used for transmitting the RS and 4 symbols are used for transmitting the ACK/NACK information in one slot, for example, if 6 CSs in the frequency domain and 3 orthogonal cover (OC) resources may be used, HARQ acknowledgement responses from a total of 18 different terminals may be multiplexed in one PUCCH RB. In the case of the subframe of the extended CP, when 2 symbols are used for transmitting the RS and 4 symbols are used for transmitting the ACK/NACK information in one slot, for example, if 6 CSs in the frequency domain and 2 orthogonal cover (OC) resources may be used, the HARQ acknowledgement responses from a total of 12 different terminals may be multiplexed in one PUCCH RB.

Next, PUCCH format 1 is described. The scheduling request (SR) is transmitted by a scheme in which the terminal requests scheduling or does not request the scheduling. An SR channel reuses an ACK/NACK channel structure in PUCCH format 1a/1 b and is configured by an on-off keying (OOK) scheme based on an ACK/NACK channel design. In the SR channel, the reference signal is not transmitted. Therefore, in the case of the general CP, a sequence having a length of 7 is used and in the case of the extended CP, a sequence having a length of 6 is used. Different cyclic shifts (CSs) or orthogonal covers (OCs) may be allocated to the SR and the ACK/NACK. That is, the terminal transmits the HARQ ACK/NACK through a resource allocated for the SR in order to transmit a positive SR. The terminal transmits the HARQ ACK/NACK through a resource allocated for the ACK/NACK in order to transmit a negative SR.

Next, an enhanced-PUCCH (e-PUCCH) format is described. An e-PUCCH may correspond to PUCCH format 3 of an LTE-A system. A block spreading technique may be applied to ACK/NACK transmission using PUCCH format 3.

A block spread scheme is described in detail later in relation to FIG. 14.

PUCCH Piggybacking

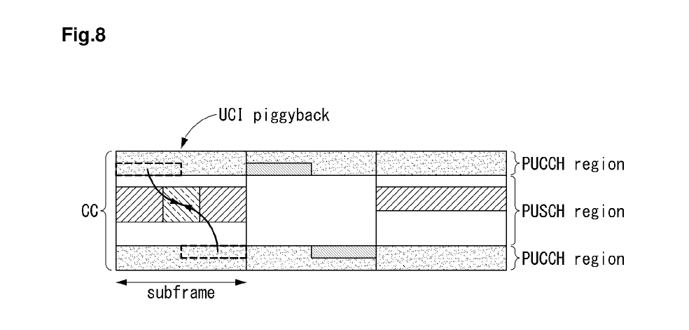

FIG. 8 illustrates one example of transport channel processing of a UL-SCH in the wireless communication system to which the present invention can be applied.

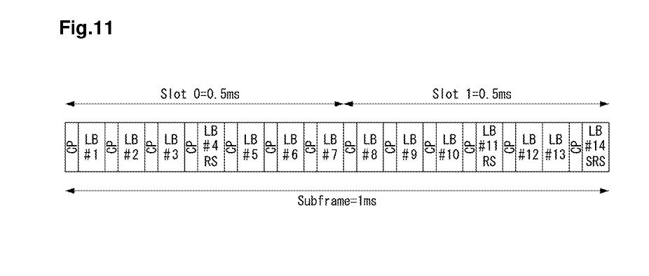

In a 3GPP LTE system (=E-UTRA, Rel. 8), in the case of the UL, single carrier transmission having an excellent peak-to-average power ratio (PAPR) or cubic metric (CM) characteristic which influences the performance of a power amplifier is maintained for efficient utilization of the power amplifier of the terminal. That is, in the case of transmitting the PUSCH of the existing LTE system, data to be transmitted may maintain the single carrier characteristic through DFT-precoding and in the case of transmitting the PUCCH, information is transmitted while being loaded on a sequence having the single carrier characteristic to maintain the single carrier characteristic. However, when the data to be DFT-precoded is non-contiguously allocated to a frequency axis or the PUSCH and the PUCCH are simultaneously transmitted, the single carrier characteristic deteriorates. Therefore, when the PUSCH is transmitted in the same subframe as the transmission of the PUCCH as illustrated in FIG. 11, uplink control information (UCI) to be transmitted to the PUCCH is transmitted (piggyback) together with data through the PUSCH.

Since the PUCCH and the PUSCH may not be simultaneously transmitted as described above, the existing LTE terminal uses a method that multiplexes uplink control information (UCI) (CQI/PMI, HARQ-ACK, RI, and the like) to the PUSCH region in a subframe in which the PUSCH is transmitted.

As one example, when the channel quality indicator (CQI) and/or precoding matrix indicator (PMI) needs to be transmitted in a subframe allocated to transmit the PUSCH, UL-SCH data and the CQI/PMI are multiplexed after DFT-spreading to transmit both control information and data. In this case, the UL-SCH data is rate-matched by considering a CQI/PMI resource. Further, a scheme is used, in which the control information such as the HARQ ACK, the RI, and the like punctures the UL-SCH data to be multiplexed to the PUSCH region.

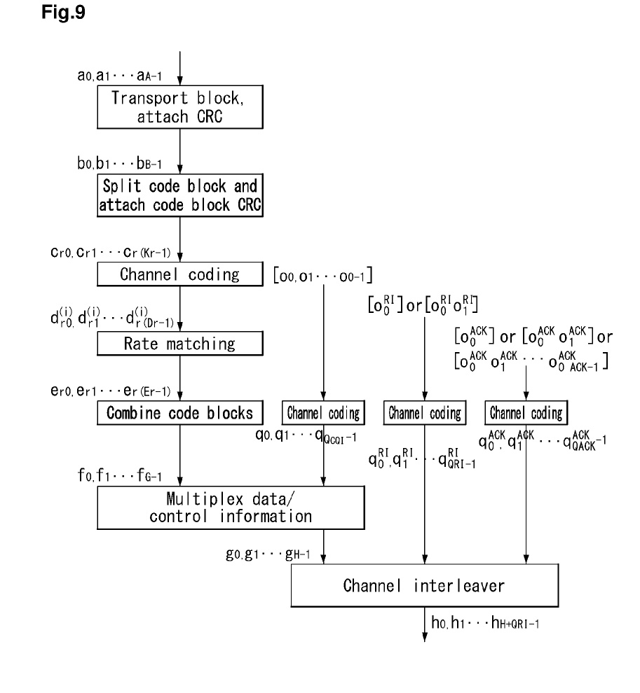

FIG. 9 illustrates one example of a signal processing process of an uplink share channel of a transport channel in the wireless communication system to which the present invention can be applied.

Herein, the signal processing process of the uplink share channel (hereinafter, referred to as “UL-SCH”) may be applied to one or more transport channels or control information types.

Referring to FIG. 9, the UL-SCH transfers data to a coding unit in the form of a transport block (TB) once every a transmission time interval (TTI).

A CRC parity bit p₀, p₁, p₂, p₃, . . . , p_{L-1} is attached to a bit of the transport block received from the upper layer (S90). In this case, A represents the size of the transport block and L represents the number of parity bits. Input bits to which the CRC is attached are shown in b₀, b₁, b₂, b₃, . . . , b_{B-1}. In this case, B represents the number of bits of the transport block including the CRC.

b₀, b₁, b₂, b₃, . . . , b_{B-1} is segmented into multiple code blocks (CBs) according to the size of the TB and the CRC is attached to multiple segmented CBs (S91). Bits after the code block segmentation and the CRC attachment are shown in cᵣ₀, cᵣ₁, cᵣ₂, cᵣ₃, . . . , c_{r(K}_{ᵣ}₋₁₎. Herein, r represents No. (r=0, . . . , C−1) of the code block and Kr represents the bit number depending on the code block r. Further, C represents the total number of code blocks.

Subsequently, channel coding is performed (S92). Output bits after the channel coding are shown in dᵣ₀⁽ⁱ⁾, dᵣ₁⁽ⁱ⁾, dᵣ₂⁽ⁱ⁾, dᵣ₃⁽ⁱ⁾, . . . , d_{r(D}_{ᵣ}₋₁₎⁽ⁱ⁾. In this case, i indicates an encoded stream index and may have a value of 0, 1, or 2. Dr represents the number of bits of the i-th encoded stream for the code block r. r represents the code block number (r=0, . . . , C−1) and C represents the total number of code blocks. Each code block may be encoded by turbo coding.

Subsequently, rate matching is performed (S93). Bits after the rate matching are shown in eᵣ₀, eᵣ₁, eᵣ₂, eᵣ₃, . . . , e_{r(E}_{ᵣ}₋₁₎. In this case, r represents the code block number (r=0, . . . , C−1) and C represents the total number of code blocks. Er represents the number of rate-matched bits of the r-th code block.

Subsequently, concatenation among the code blocks is performed again (S94). Bits after the concatenation of the code blocks is performed are shown in f₀, f₁, f₂, f₃, . . . , f_{G-1}. In this case, G represents the total number of bits encoded for transmission and when the control information is multiplexed with the UL-SCH, the number of bits used for transmitting the control information is not included.

Meanwhile, when the control information is transmitted in the PUSCH, channel coding of the CQI/PMI, the RI, and the ACK/NACK which are the control information is independently performed (S96, S97, and S98). Since different encoded symbols are allocated for transmitting each control information, the respective control information has different coding rates.

In time division duplex (TDD), as an ACK/NACK feedback mode, two modes of ACK/NACK bundling and ACK/NACK multiplexing are supported by an upper-layer configuration. ACK/NACK information bits for the ACK/NACK bundling are constituted by 1 bit or 2 bits and ACK/NACK information bits for the ACK/NACK multiplexing are constituted by 1 to 4 bits.

After the concatenation among the code blocks in step S94, encoded bits f₀, f₁, f₂, f₃, . . . , f_{G-1} of the UL-SCH data and encoded bits q₀, q₁, q₂, q₃, . . . , q_{N}_{_{L}}_{·Q}_{_{CQI}}₋₁ of the CQI/PMI are multiplexed (S95). A multiplexed result of the data and the CQI/PMI is shown in g₀, g₁, g₂, g₃, . . . , g_{H′-1}. In this case, gᵢ (i=0, . . . , H′−1) represents a column vector having a length of (Qₘ·N_{L}) H=(G+N_{L}·Q_{CQI}) and H′=H/(N_{L}−Qₘ). N_{L} represents the number of layers mapped to a UL-SCH transport block and H represents the total number of encoded bits allocated to N_{L} transport layers mapped with the transport block for the UL-SCH data and the CQI/PMI information.

Subsequently, the multiplexed data and CQI/PMI, a channel encoded RI, and the ACK/NACK are channel-interleaved to generate an output signal (S99).

Reference Signal (RS)

In the wireless communication system, since the data is transmitted through the radio channel, the signal may be distorted during transmission. In order for the receiver side to accurately receive the distorted signal, the distortion of the received signal needs to be corrected by using channel information. In order to detect the channel information, a signal transmitting method know by both the transmitter side and the receiver side and a method for detecting the channel information by using an distortion degree when the signal is transmitted through the channel are primarily used. The aforementioned signal is referred to as a pilot signal or a reference signal (RS).

Furthermore, recently, most of mobile communication systems use a method capable of improving transmission/reception data efficiency by adopting multiple transmission antennas and multiple reception antennas instead of the existing method of using one transmission antenna and one reception antenna when a packet is transmitted. When the data is transmitted and received by using the MIMO antenna, a channel state between the transmitting antenna and the receiving antenna need to be detected in order to accurately receive the signal. Therefore, the respective transmitting antennas need to have individual reference signals.

In a mobile communication system, an RS may be basically into two types depending on its object. The RS includes an RS of an object for channel information acquisition and an RS used for data demodulation. The former has an object for a UE to obtain channel information in the downlink and thus must be transmitted in a wide band. Even a UE that does not receive downlink data in a specific subframe can receive and measure the former. Furthermore, the former is used for the measurement of handover. The latter is an RS transmitted in a corresponding resource together when a base station transmits downlink. A UE can perform channel estimation by a corresponding RS and thus can demodulate data. The RS must be transmitted in a region in which data is transmitted.

5 types of downlink reference signals are defined.
Cell-specific reference signal (CRS)
Multicast-broadcast single-frequency network (MBSFN) reference signal (MBSFN RS)
UE-specific reference signal or demodulation reference signal (DM-RS)
Positioning reference signal (PRS)
Channel state information reference signal (CSI-RS)

One reference signal is transmitted for each downlink antenna port.

A CRS is transmitted in all of downlink subframes within a cell supporting PDSCH transmission. The CRS is transmitted in one or more of the antenna ports 0-3. The CRS is defined only in Δf=15 kHz.

An MBSFN RS is transmitted in the MBSFN region of an MBSFN subframe only when a physical multicast channel (PMCH) is transmitted. The MBSFN RS is transmitted in the antenna port 4. The MBSFN RS is defined only in an extended CP.

A DM-RS is supported by the transmission of a PDSCH, and is transmitted in the antenna port p=5, p=7, p=8 or p=7, 8, . . . , u+6.

In this case, u is the number of layers used for PDSCH transmission. The DM-RS is present and valid for PDSCH demodulation only when PDSCH transmission is associated in a corresponding antenna port. The DM-RS is transmitted only in a resource block (RB) to which a corresponding PDSCH is mapped.

When any one of a physical channel and a physical signal is transmitted using the resource element (RE) of the same index pair (k,l) as an RE in which a DM-RS is transmitted in addition to the DM-RS regardless of the antenna port (p), the DM-RS is not transmitted in the RE of the corresponding index pair (k,l).

A PRS is transmitted only in a resource block within downlink subframe configured for PRS transmission.

When both a common subframe and an MBSFN subframe are configured as positioning subframes within one cell, OFDM symbols within an MBSFN subframe configured for PRS transmission use the same CP as a subframe #0. When only an MBSFN subframe is configured as a positioning subframe within one cell, OFDM symbols configured for a PRS within the MBSFN region of a corresponding subframe use an extended CP.

The starting point of an OFDM symbol configured for PRS transmission within a subframe configured for PRS transmission is the same as the starting point of a subframe having the same CP length as an OFDM symbol all of them have been configured for PRS transmission.

A PRS is transmitted in the antenna port 6.

A PRS is not mapped to an RE (k,l) allocated to a physical broadcast channel (PBCH), a PSS or an SSS regardless of the antenna port (p).

A PRS is defined only in Δf=15 kHz.

A CSI-RS is transmitted in the 1, 2, 4 and 8 antenna port using p=15, p=15, 16, p=15, . . . , 18 and p=15, . . . , 22, respectively.

A CSI-RS is defined only in Δf=15 kHz.

A reference signal is described more specifically.

A CRS is a reference signal for obtaining information about a channel state shared by all of UEs within a cell and for the measurement of handover. The DM-RS is used for data demodulation for only a specific UE. Information for demodulation and channel measurement can be provided using such reference signals. That is, the DM-RS is used for only data demodulation, and the CRS is used for the two objects of channel information acquisition and data demodulation.

A reception side (i.e., UE) measures a channel state from a CRS, and feeds an indicator related to channel quality, such as a channel quality indicator (CQI), a precoding matrix index (PMI), a precoding type indicator (PTI) and/or a rank indicator (RI), back to a transmission side (i.e., base station). The CRS is also called a cell-specific reference signal (cell-specific RS). In contrast, the reference signal related to the feedback of channel state information (CSI) may be defined as a CSI-RS.

A DM-RS may be transmitted through resource elements if data demodulation on a PDSCH is necessary. A UE may receive whether a DM-RS is present through a higher layer, and the DM-RS is valid only when a corresponding PDSCH is mapped. The DM-RS may be called a UE-specific reference signal (UE-specific RS) or a demodulation reference signal (DMRS: Demodulation RS).

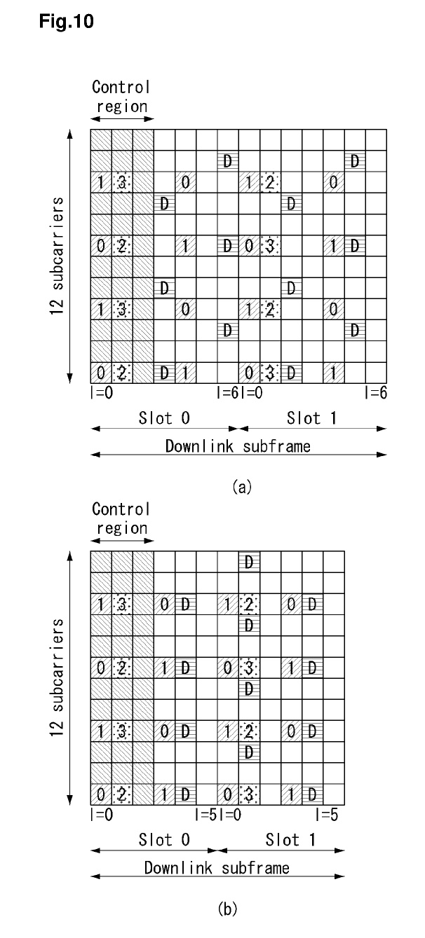

FIG. 10 illustrates a reference signal pattern mapped to a downlink resource block pair in the wireless communication system to which the present invention can be applied.

Referring to FIG. 10, as a wise in which the reference signal is mapped, the downlink resource block pair may be expressed by one subframe in the time domain×12 subcarriers in the frequency domain.

That is, one resource block pair has a length of 14 OFDM symbols in the case of a normal cyclic prefix (CP) (FIG. 10a) and a length of 12 OFDM symbols in the case of an extended cyclic prefix (CP) (FIG. 10b). Resource elements (REs) represented as ‘0’, ‘1’, ‘2’, and ‘3’ in a resource block lattice mean the positions of the CRSs of antenna port indexes ‘0’, ‘1’, ‘2’, and ‘3’, respectively and resource elements represented as ‘D’ means the position of the DRS.

Hereinafter, when the CRS is described in more detail, the CRS is used to estimate a channel of a physical antenna and distributed in a whole frequency band as the reference signal which may be commonly received by all terminals positioned in the cell. Further, the CRS may be used to demodulate the channel quality information (CSI) and data.

The CRS is defined as various formats according to an antenna array at the transmitter side (base station). The 3GPP LTE system (for example, release-8) supports various antenna arrays and a downlink signal transmitting side has three types of antenna arrays of three single transmitting antennas, two transmitting antennas, and four transmitting antennas. When the base station uses the single transmitting antenna, a reference signal for a single antenna port is arrayed. When the base station uses two transmitting antennas, reference signals for two transmitting antenna ports are arrayed by using a time division multiplexing (TDM) scheme and/or a frequency division multiplexing (FDM) scheme. That is, different time resources and/or different frequency resources are allocated to the reference signals for two antenna ports which are distinguished from each other.

Moreover, when the base station uses four transmitting antennas, reference signals for four transmitting antenna ports are arrayed by using the TDM and/or FDM scheme. Channel information measured by a downlink signal receiving side (terminal) may be used to demodulate data transmitted by using a transmission scheme such as single transmitting antenna transmission, transmission diversity, closed-loop spatial multiplexing, open-loop spatial multiplexing, or multi-user MIMO.

In the case where the MIMO antenna is supported, when the reference signal is transmitted from a specific antenna port, the reference signal is transmitted to the positions of specific resource elements according to a pattern of the reference signal and not transmitted to the positions of the specific resource elements for another antenna port. That is, reference signals among different antennas are not duplicated with each other.

A rule of mapping the CRS to the resource block is defined as below.

$$k = 6 m + ( v + {v}_{shift} ) mod 6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL} \\ v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s} mod 2 ) & if p = 3 \end{matrix} \\ {v}_{shift} = {N}_{ID}^{cell} mod 6 \qquad [ Equation 1 ]$$

In Equation 1, k and l represent the subcarrier index and the symbol index, respectively and p represents the antenna port. N_{symb}^{DL} represents the number of OFDM symbols in one downlink slot and N_{RB}^{DL} represents the number of radio resources allocated to the downlink. ns represents a slot index and, n_{ID}^{cell} represents a cell ID. mod represents an modulo operation. The position of the reference signal varies depending on the v_{shift} value in the frequency domain. Since v_{shift} is subordinated to the cell ID, the position of the reference signal has various frequency shift values according to the cell.

In more detail, the position of the CRS may be shifted in the frequency domain according to the cell in order to improve channel estimation performance through the CRS. For example, when the reference signal is positioned at an interval of three subcarriers, reference signals in one cell are allocated to a 3 k-th subcarrier and a reference signal in another cell is allocated to a 3 k+1-th subcarrier. In terms of one antenna port, the reference signals are arrayed at an interval of six resource elements in the frequency domain and separated from a reference signal allocated to another antenna port at an interval of three resource elements.

In the time domain, the reference signals are arrayed at a constant interval from symbol index 0 of each slot. The time interval is defined differently according to a cyclic shift length. In the case of the normal cyclic shift, the reference signal is positioned at symbol indexes 0 and 4 of the slot and in the case of the extended CP, the reference signal is positioned at symbol indexes 0 and 3 of the slot. A reference signal for an antenna port having a maximum value between two antenna ports is defined in one OFDM symbol. Therefore, in the case of transmission of four transmitting antennas, reference signals for reference signal antenna ports 0 and 1 are positioned at symbol indexes 0 and 4 (symbol indexes 0 and 3 in the case of the extended CP) and reference signals for antenna ports 2 and 3 are positioned at symbol index 1 of the slot. The positions of the reference signals for antenna ports 2 and 3 in the frequency domain are exchanged with each other in a second slot.

Hereinafter, when the DRS is described in more detail, the DRS is used for demodulating data. A precoding weight used for a specific terminal in the MIMO antenna transmission is used without a change in order to estimate a channel associated with and corresponding to a transmission channel transmitted in each transmitting antenna when the terminal receives the reference signal.

The 3GPP LTE system (for example, release-8) supports a maximum of four transmitting antennas and a DRS for rank 1 beamforming is defined. The DRS for the rank 1 beamforming also means a reference signal for antenna port index 5.

A rule of mapping the DRS to the resource block is defined as below. Equation 2 shows the case of the normal CP and Equation 3 shows the case of the extended CP.

$$\begin{matrix}k = ( {k}^{′} ) mod {N}_{sc}^{RB} + {N}_{sc}^{RB} \cdot {n}_{PRB} \\ {k}^{′} = \{ \begin{matrix}4 {m}^{′} + {v}_{shift} & if l ∈ \{ 2 , 3 \} \\ 4 {m}^{′} + ( 2 + {v}_{shift} ) mod 4 & if l ∈ \{ 5 , 6 \}\end{matrix} \\ l = \{ \begin{matrix}3 & {l}^{′} = 0 \\ 6 & {l}^{′} = 1 \\ 2 & {l}^{′} = 2 \\ 5 & {l}^{′} = 3\end{matrix} \\ {l}^{′} = \{ \begin{matrix}0 , 1 & if {n}_{s} mod 2 = 0 \\ 2 , 3 & if {n}_{s} mod 2 = 1\end{matrix} \\ {m}^{′} = 0 , 1 , … , 3 {N}_{RB}^{PDSCH} - 1 \\ {v}_{shift} = {N}_{ID}^{cell} mod 3 & [ Equation 2 ] \\ k = ( {k}^{′} ) mod {N}_{sc}^{RB} + {N}_{sc}^{RB} \cdot {n}_{PRB} \\ {k}^{′} = \{ \begin{matrix}3 {m}^{′} + {v}_{shift} & if l = 4 \\ 3 {m}^{′} + ( 2 + {v}_{shift} ) mod 3 & if l = 1\end{matrix} \\ l = \{ \begin{matrix}4 & {l}^{′} ∈ \{ 0 , 2 \} \\ 1 & {l}^{′} = 1\end{matrix} \\ {l}^{′} = \{ \begin{matrix}0 & if {n}_{s} mod 2 = 0 \\ 1 , 2 & if {n}_{s} mod 2 = 1\end{matrix} \\ {m}^{′} = 0 , 1 , … , 4 {N}_{RB}^{PDSCH} - 1 \\ {v}_{shift} = {N}_{ID}^{cell} mod 3 & [ Equation 3 ]\end{matrix}$$

In Equations 1 to 3 given above, k and p represent the subcarrier index and DL cell the antenna port, respectively. N_{RB}^{DL}, ns, and N_{ID}^{cell} represent the number of RBs, the number of slot indexes, and the number of cell IDs allocated to the downlink, respectively. The position of the RS varies depending on the v_{shift} value in terms of the frequency domain.

In Equations 2 and 3, k and l represent the subcarrier index and the symbol index, respectively and p represents the antenna port. N_{sc}^{RB} represents the size of the resource block in the frequency domain and is expressed as the number of subcarriers. n_{PRB} represents the number of physical resource blocks. N_{RB}^{PDSCH} represents a frequency band of the resource block for the PDSCH transmission. ns represents the slot index and N_{ID}^{cell} represents the cell ID. mod represents the modulo operation. The position of the reference signal varies depending on the v_{shift} value in the frequency domain. Since v_{shift} is subordinated to the cell ID, the position of the reference signal has various frequency shift values according to the cell.

Sounding Reference Signal (SRS)

The SRS is primarily used for the channel quality measurement in order to perform frequency-selective scheduling and is not associated with transmission of the uplink data and/or control information. However, the SRS is not limited thereto and the SRS may be used for various other purposes for supporting improvement of power control and various start-up functions of terminals which have not been scheduled. One example of the start-up function may include an initial modulation and coding scheme (MCS), initial power control for data transmission, timing advance, and frequency semi-selective scheduling. In this case, the frequency semi-selective scheduling means scheduling that selectively allocates the frequency resource to the first slot of the subframe and allocates the frequency resource by pseudo-randomly hopping to another frequency in the second slot.

Further, the SRS may be used for measuring the downlink channel quality on the assumption that the radio channels between the uplink and the downlink are reciprocal. The assumption is valid particularly in the time division duplex in which the uplink and the downlink share the same frequency spectrum and are divided in the time domain.

Subframes of the SRS transmitted by any terminal in the cell may be expressed by a cell-specific broadcasting signal. A 4-bit cell-specific ‘srsSubframeConfiguration’ parameter represents 15 available subframe arrays in which the SRS may be transmitted through each radio frame. By the arrays, flexibility for adjustment of the SRS overhead is provided according to a deployment scenario.

A 16-th array among them completely turns off a switch of the SRS in the cell and is suitable primarily for a serving cell that serves high-speed terminals.

FIG. 11 illustrates an uplink subframe including a sounding reference signal symbol in the wireless communication system to which the present invention can be applied.

Referring to FIG. 11, the SRS is continuously transmitted through a last SC FDMA symbol on the arrayed subframes. Therefore, the SRS and the DMRS are positioned at different SC-FDMA symbols.

The PUSCH data transmission is not permitted in a specific SC-FDMA symbol for the SRS transmission and consequently, when sounding overhead is highest, that is, even when the SRS symbol is included in all subframes, the sounding overhead does not exceed approximately 7%.

Each SRS symbol is generated by a base sequence (random sequence or a sequence set based on Zadoff-Ch (ZC)) associated with a given time wise and a given frequency band and all terminals in the same cell use the same base sequence. In this case, SRS transmissions from a plurality of terminals in the same cell in the same frequency band and at the same time are orthogonal to each other by different cyclic shifts of the base sequence to be distinguished from each other.

SRS sequences from different cells may be distinguished each other by allocating different base sequences to respective cells, but orthogonality among different base sequences is not assured.

General Carrier Aggregation

A communication environment considered in embodiments of the present invention includes multi-carrier supporting environments. That is, a multi-carrier system or a carrier aggregation system used in the present invention means a system that aggregates and uses one or more component carriers (CCs) having a smaller bandwidth smaller than a target band at the time of configuring a target wideband in order to support a wideband.

In the present invention, multi-carriers mean aggregation of (alternatively, carrier aggregation) of carriers and in this case, the aggregation of the carriers means both aggregation between continuous carriers and aggregation between non-contiguous carriers. Further, the number of component carriers aggregated between the downlink and the uplink may be differently set. A case in which the number of downlink component carriers (hereinafter, referred to as ‘DL CC’) and the number of uplink component carriers (hereinafter, referred to as ‘UL CC’) are the same as each other is referred to as symmetric aggregation and a case in which the number of downlink component carriers and the number of uplink component carriers are different from each other is referred to as asymmetric aggregation. The carrier aggregation may be interchangeably used with a term such as a CA, a bandwidth aggregation or a spectrum aggregation.

The carrier aggregation configured by combining two or more component carriers aims at supporting up to a bandwidth of 100 MHz in the LTE-A system. When one or more carriers having the bandwidth than the target band are combined, the bandwidth of the carriers to be combined may be limited to a bandwidth used in the existing system in order to maintain backward compatibility with the existing IMT system. For example, the existing 3GPP LTE system supports bandwidths of 1.4, 3, 5, 10, 15, and 20 MHz and a 3GPP LTE-advanced system (that is, LTE-A) may be configured to support a bandwidth larger than 20 MHz by using on the bandwidth for compatibility with the existing system. Further, the carrier aggregation system used in the preset invention may be configured to support the carrier aggregation by defining a new bandwidth regardless of the bandwidth used in the existing system.

The LTE-A system uses a concept of the cell in order to manage a radio resource.

The carrier aggregation environment may be called a multi-cell environment. The cell is defined as a combination of a pair of a downlink resource (DL CC) and an uplink resource (UL CC), but the uplink resource is not required. Therefore, the cell may be constituted by only the downlink resource or both the downlink resource and the uplink resource. When a specific terminal has only one configured serving cell, the cell may have one DL CC and one UL CC, but when the specific terminal has two or more configured serving cells, the cell has DL CCs as many as the cells and the number of UL CCs may be equal to or smaller than the number of DL CCs.

Alternatively, contrary to this, the DL CC and the UL CC may be configured. That is, when the specific terminal has multiple configured serving cells, a carrier aggregation environment having UL CCs more than DL CCs may also be supported. That is, the carrier aggregation may be appreciated as aggregation of two or more cells having different carrier frequencies (center frequencies). Herein, the described ‘cell’ needs to be distinguished from a cell as an area covered by the base station which is generally used.

The cell used in the LTE-A system includes a primary cell (PCell) and a secondary cell (SCell. The P cell and the S cell may be used as the serving cell. In a terminal which is in an RRC_CONNECTED state, but does not have the configured carrier aggregation or does not support the carrier aggregation, only one serving constituted by only the P cell is present. On the contrary, in a terminal which is in the RRC_CONNECTED state and has the configured carrier aggregation, one or more serving cells may be present and the P cell and one or more S cells are included in all serving cells.

The serving cell (P cell and S cell) may be configured through an RRC parameter. PhysCellId as a physical layer identifier of the cell has integer values of 0 to 503. SCellIndex as a short identifier used to identify the S cell has integer values of 1 to 7. ServCellIndex as a short identifier used to identify the serving cell (P cell or S cell) has the integer values of 0 to 7. The value of 0 is applied to the P cell and SCellIndex is previously granted for application to the S cell. That is, a cell having a smallest cell ID (alternatively, cell index) in ServCellIndex becomes the P cell.

The P cell means a cell that operates on a primary frequency (alternatively, primary CC). The terminal may be used to perform an initial connection establishment process or a connection re-establishment process and may be designated as a cell indicated during a handover process. Further, the P cell means a cell which becomes the center of control associated communication among serving cells configured in the carrier aggregation environment. That is, the terminal may be allocated with and transmit the PUCCH only in the P cell thereof and use only the P cell to acquire the system information or change a monitoring procedure. An evolved universal terrestrial radio access (E-UTRAN) may change only the P cell for the handover procedure to the terminal supporting the carrier aggregation environment by using an RRC connection reconfiguration message (RRCConnectionReconfigutaion) message of an upper layer including mobile control information (mobilityControllnfo).

The S cell means a cell that operates on a secondary frequency (alternatively, secondary CC). Only one P cell may be allocated to a specific terminal and one or more S cells may be allocated to the specific terminal. The S cell may be configured after RRC connection establishment is achieved and used for providing an additional radio resource. The PUCCH is not present in residual cells other than the P cell, that is, the S cells among the serving cells configured in the carrier aggregation environment. The E-UTRAN may provide all system information associated with a related cell which is in an RRC_CONNECTED state through a dedicated signal at the time of adding the S cells to the terminal that supports the carrier aggregation environment. A change of the system information may be controlled by releasing and adding the related S cell and in this case, the RRC connection reconfiguration (RRCConnectionReconfigutaion) message of the upper layer may be used. The E-UTRAN may perform having different parameters for each terminal rather than broadcasting in the related S cell.

After an initial security activation process starts, the E-UTRAN adds the S cells to the P cell initially configured during the connection establishment process to configure a network including one or more S cells. In the carrier aggregation environment, the P cell and the S cell may operate as the respective component carriers. In an embodiment described below, the primary component carrier (PCC) may be used as the same meaning as the P cell and the secondary component carrier (SCC) may be used as the same meaning as the S cell.

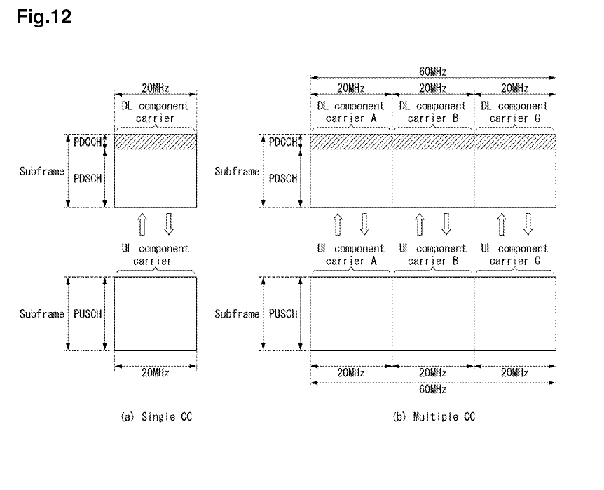

FIG. 12 illustrates examples of a component carrier and carrier aggregation in the wireless communication system to which the present invention can be applied.

FIG. 12a illustrates a single carrier structure used in an LTE system. The component carrier includes the DL CC and the UL CC. One component carrier may have a frequency range of 20 MHz.

FIG. 12b illustrates a carrier aggregation structure used in the LTE system. In the case of FIG. 12b, a case is illustrated, in which three component carriers having a frequency magnitude of 20 MHz are combined. Each of three DL CCs and three UL CCs is provided, but the number of DL CCs and the number of UL CCs are not limited. In the case of carrier aggregation, the terminal may simultaneously monitor three CCs, and receive downlink signal/data and transmit uplink signal/data.

When N DL CCs are managed in a specific cell, the network may allocate M (M≤N) DL CCs to the terminal. In this case, the terminal may monitor only M limited DL CCs and receive the DL signal. Further, the network gives L (L≤M≤N) DL CCs to allocate a primary DL CC to the terminal and in this case, UE needs to particularly monitor L DL CCs. Such a scheme may be similarly applied even to uplink transmission.

A linkage between a carrier frequency (alternatively, DL CC) of the downlink resource and a carrier frequency (alternatively, UL CC) of the uplink resource may be indicated by an upper-layer message such as the RRC message or the system information. For example, a combination of the DL resource and the UL resource may be configured by a linkage defined by system information block type 2 (SIB2). In detail, the linkage may mean a mapping relationship between the DL CC in which the PDCCH transporting a UL grant and a UL CC using the UL grant and mean a mapping relationship between the DL CC (alternatively, UL CC) in which data for the HARQ is transmitted and the UL CC (alternatively, DL CC) in which the HARQ ACK/NACK signal is transmitted.

Cross Carrier Scheduling

In the carrier aggregation system, in terms of scheduling for the carrier or the serving cell, two types of a self-scheduling method and a cross carrier scheduling method are provided. The cross carrier scheduling may be called cross component carrier scheduling or cross cell scheduling.

The cross carrier scheduling means transmitting the PDCCH (DL grant) and the PDSCH to different respective DL CCs or transmitting the PUSCH transmitted according to the PDCCH (UL grant) transmitted in the DL CC through other UL CC other than a UL CC linked with the DL CC receiving the UL grant.

Whether to perform the cross carrier scheduling may be UE-specifically activated or deactivated and semi-statically known for each terminal through the upper-layer signaling (for example, RRC signaling).

When the cross carrier scheduling is activated, a carrier indicator field (CIF) indicating through which DL/UL CC the PDSCH/PUSCH the PDSCH/PUSCH indicated by the corresponding PDCCH is transmitted is required. For example, the PDCCH may allocate the PDSCH resource or the PUSCH resource to one of multiple component carriers by using the CIF. That is, the CIF is set when the PDSCH or PUSCH resource is allocated to one of DL/UL CCs in which the PDCCH on the DL CC is multiply aggregated. In this case, a DCI format of LTE-A Release-8 may extend according to the CIF. In this case, the set CIF may be fixed to a 3-bit field and the position of the set CIF may be fixed regardless of the size of the DCI format. Further, a PDCCH structure (the same coding and the same CCE based resource mapping) of the LTE-A Release-8 may be reused.

On the contrary, when the PDCCH on the DL CC allocates the PDSCH resource on the same DL CC or allocates the PUSCH resource on a UL CC which is singly linked, the CIF is not set. In this case, the same PDCCH structure (the same coding and the same CCE based resource mapping) and DCI format as the LTE-A Release-8 may be used.

When the cross carrier scheduling is possible, the terminal needs to monitor PDCCHs for a plurality of DCIs in a control region of a monitoring CC according to a transmission mode and/or a bandwidth for each CC. Therefore, a configuration and PDCCH monitoring of a search space which may support monitoring the PDCCHs for the plurality of DCIs are required.

In the carrier aggregation system, a terminal DL CC aggregate represents an aggregate of DL CCs in which the terminal is scheduled to receive the PDSCH and a terminal UL CC aggregate represents an aggregate of UL CCs in which the terminal is scheduled to transmit the PUSCH. Further, a PDCCH monitoring set represents a set of one or more DL CCs that perform the PDCCH monitoring. The PDCCH monitoring set may be the same as the terminal DL CC set or a subset of the terminal DL CC set. The PDCCH monitoring set may include at least any one of DL CCs in the terminal DL CC set. Alternatively, the PDCCH monitoring set may be defined separately regardless of the terminal DL CC set. The DL CCs included in the PDCCH monitoring set may be configured in such a manner that self-scheduling for the linked UL CC is continuously available. The terminal DL CC set, the terminal UL CC set, and the PDCCH monitoring set may be configured UE-specifically, UE group-specifically, or cell-specifically.

When the cross carrier scheduling is deactivated, the deactivation of the cross carrier scheduling means that the PDCCH monitoring set continuously means the terminal DL CC set and in this case, an indication such as separate signaling for the PDCCH monitoring set is not required. However, when the cross carrier scheduling is activated, the PDCCH monitoring set is preferably defined in the terminal DL CC set. That is, the base station transmits the PDCCH through only the PDCCH monitoring set in order to schedule the PDSCH or PUSCH for the terminal.

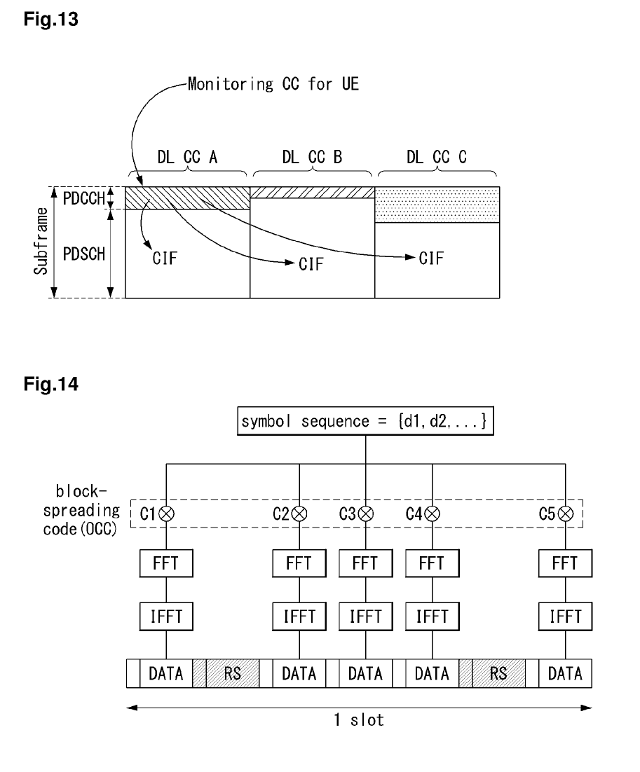

FIG. 13 illustrates one example of a subframe structure depending on cross carrier scheduling in the wireless communication system to which the present invention can be applied.

Referring to FIG. 13, a case is illustrated, in which three DL CCs are associated with a DL subframe for an LTE-A terminal and DL CC‘A’ is configured as a PDCCH monitoring DL CC. When the CIF is not used, each DL CC may transmit the PDCCH scheduling the PDSCH thereof without the CIF. On the contrary, when the CIF is used through the upper-layer signaling, only one DL CC ‘A’ may transmit the PDCCH scheduling the PDSCH thereof or the PDSCH of another CC by using the CIF. In this case, DL CC ‘B’ and ‘C’ in which the PDCCH monitoring DL CC is not configured does not transmit the PDCCH.

PDCCH Transmission

A base station determines a PDCCH format based on DCI to be transmitted to a UE and attaches cyclic redundancy check (CRC) to control information. The CRC is masked with a unique identity (this is called a radio network temporary identifier (RNTI)) depending on the owner or use of a PDCCH. If a PDCCH is a PDCCH for a specific UE, CRC may be masked with a unique identity, for example, a cell-RNTI (C-RNTI) of the UE. Or if a PDCCH is a PDCCH for a paging message, CRC may be masked with a paging indication identity, for example, a paging-RNTI P-(RNTI). If a PDCCH is a PDCCH for system information, more specifically, a system information block (SIB), CRC may be masked with a system information identity, a system information RNTI (SI-RNTI). In order to indicate a random access response that is a response for the transmission of a random access preamble of a UE, CRC may be masked with an RA-random access RNTI (RA-RNTI).

Next, the base station generates coded data by performing channel coding on control information to which the CRC has been added. In this case, channel coding may be performed at a code rate according to an MCS level. The base station performs rate matching according to a CCE aggregation level assigned to the PDCCH format and generates modulation symbols by modulating the coded data. In this case, a modulation sequence according to an MCS level may be used. Modulation symbols configuring one PDCCH may be any one of CCE aggregation levels 1, 2, 4 and 8. Thereafter, the base station maps the modulation symbols to a physical resource element (CCE to RE mapping).

A plurality of PDCCHs may be transmitted in a single subframe. That is, the control region of one subframe includes a plurality of CCEs having indices 0˜N_{CCE,k}−1. In this case, N_{CCE,k} means a total number of CCEs within the control region of a k-th subframe. UE monitors a plurality of PDCCHs every subframe.

In this case, the term “monitoring” means that the UE attempts to decode each of PDCCHs according to the format of a monitored PDCCH. In a control region allocated within a subframe, an eNB does not provide UE with information about the position of a corresponding PDCCH. The UE is unaware that its own PDCCH is transmitted at which position in what CCE aggregation level or according to which DCI format in order to receive a control channel transmitted by the eNB. Accordingly, the UE searches for the PDCCH by monitoring a set of PDCCH candidates within a subframe. This is called blind decoding/detection (BD). Blind decoding refers to a method of demasking, by UE, its own UE ID to a CRC portion and then checking whether a corresponding PDCCH is its own control channel by reviewing a CRC error.

In active mode, UE monitors the PDCCH of each subframe in order to receive data transmitted to the UE. In DRX mode, UE wakes up in the monitoring period of each DRX cycle and monitors a PDCCH in a subframe corresponding to the monitoring period. A subframe in which the monitoring of the PDCCH is performed is called a non-DRX subframe.

In order to receive a PDCCH transmitted to UE, the UE has to perform blind decoding on all of CCEs which are present in the control region of a non-DRX subframe. The UE has to decode all of PDCCHs in a possible CCE aggregation level until blind decoding for the PDCCHs is successful within each non-DRX subframe because the UE is unaware that which PDCCH format will be transmitted. The UE has to attempt detection in all of possible CCE aggregation levels until blind decoding for the PDCCHs is successful because the UE is unaware that its own PDCCH uses how many CCEs. That is, the UE performs the blind decoding in each CCE aggregation level. That is, the UE first attempts decoding in a CCE aggregation level unit of 1. If decoding all fails, the UE attempts decoding in a CCE aggregation level unit of 2. Thereafter, the UE attempts decoding in a CCE aggregation level unit of 4 and a CCE aggregation level unit of 8. Furthermore, the UE attempts decoding on all of a C-RNTI, a P-RNTI, an SI-RNTI, and an RA-RNTI 4. Furthermore, the UE attempts decoding on all of DCI formats to be monitored.

As described above, if UE attempts blind decoding on all of DCI formats to be monitored in each of all of CCE aggregation levels with respect to all of RNTIs, the number of times of detection attempts is excessively increased. Accordingly, in the LTE system, a search space (SS) concept is defined for the blind decoding of UE. The search space means a set of PDCCH candidates to be monitored and may have a different size depending on the format of each PDCCH.

The search space may include a common search space (CSS) and a UE-specific/dedicated search space (USS). In the case of the CSS, all of pieces of UE may be aware of the size of the CSS, but the USS may be individually set for each piece of UE. Accordingly, UE has to decode both the USS and the CSS in order to decode a PDCCH. Accordingly, UE performs a maximum of pieces of 44 blind decoding (BD) in one subframe. In this case, blind decoding performed based on a different CRC value (e.g., a C-RNTI, P-RNTI, SI-RNTI or RA-RNTI) is not included in the maximum of pieces of 44 blind decoding (BD).

Due to a small search space, an eNB may not secure a CCE resource for transmitting a PDCCH to all of pieces of UE to which the PDCCH is to be transmitted within a given subframe. The reason for this is that the remaining resources left over after a CCE position is allocated may not be included in the search space of specific UE. In order to minimize such a barrier that may continue even in a next subframe, a UE-specific hopping sequence may be applied to the start point of a USS.

Table 4 illustrates the sizes of a CSS and a USS.

TABLE 4

| PDCCH | Number of | Number of candidates | Number of candidates in |
|---|---|---|---|
| format | CCEs (n) | in common search space | dedicated search space |
| 0 | 1 | — | 6 |
| 1 | 2 | — | 6 |
| 2 | 4 | 4 | 2 |
| 3 | 8 | 2 | 2 |

In order to reduce the computational load of UE according to the number of times of blind decoding attempts, the UE does not perform searches according to all of defined DCI formats at the same time. More specifically, the UE may always perform search for the DCI formats 0 and 1A in a USS. In this case, the DCI formats 0 and 1A have the same size, but the UE may distinguish the DCI formats using a flag for a DCI format 0/DCI format 1A differentiation included in a PDCCH. Furthermore, another DCI format in addition to the DCI formats 0 and 1A may be required for UE depending on PDSCH transmission mode set by an eNB. Examples of another DCI format include the DCI formats 1, 1 B, and 2.

In a CSS, UE may search for the DCI formats 1A and 1C. Furthermore, the UE may be configured to search for the DCI format 3 or 3A. The DCI formats 3 and 3A have the same size as the DCI formats 0 and 1A, but the UE may differentiate the DCI formats using CRC scrambled by another ID not a UE-specific ID.

A search space Sₖ^{(L)} means a set of PDCCH candidates according to an aggregation level L∈{1,2,4,8}. A CCE according to the PDCCH candidate set m of the search space may be determined by Equation 4 below.

L·{(Yₖ+m)mod └N_{CCE,k}/L┘}+i [Equation 4]

In this case, M^{(L)} denotes the number of PDCCH candidates according to a CCE aggregation level L to be monitored in a search space. m=0, . . . , M^{(L)}−1. i is an index that designates each CCE in each of PDCCH candidates, and i=0, . . . , L−1.

As described above, UE monitors both a USS and a CSS in order to decode a PDCCH. In this case, the CSS supports PDCCHs having an aggregation level of {4, 8}, and the USS supports PDCCHs having an aggregation level of {1, 2, 4, 8}.

Table 5 illustrates PDCCH candidates monitored by UE.

TABLE 5

| Search space Sₖ^{(L)} | | | Number of PDCCH |
|---|---|---|---|
| Type | Aggregation level L | Size [in CCEs] | candidates M^{(L)} |
| UE- | 1 | 6 | 6 |
| specific | 2 | 12 | 6 |
| | 4 | 8 | 2 |
| | 8 | 15 | 2 |
| Common | 4 | 16 | 4 |
| | 8 | 15 | 2 |

Referring to Equation 4, in the case of a CSS, Yₖ is set to 0 with respect to two aggregation levels L=4 and L=8. In contrast, in the case of a USS, Yₖ is defined as in Equation 5 with respect to an aggregation level L.

Yₖ=(A·Yₖ₋₁)mod D [Equation 5]

In this case, Y₋₁=n_{RNTI}≠0, the value of an RNTI used for n_{RNTI} may be defined as one of the identifications (IDs) of UE. Furthermore, A=39827, D=65537, and k=└nₛ/2┘. In this case, nₛ denotes a slot number (or index) in a radio frame.

General ACK/NACK Multiplexing Method

In a situation in which the terminal simultaneously needs to transmit multiple ACKs/NACKs corresponding to multiple data units received from an eNB, an ACK/NACK multiplexing method based on PUCCH resource selection may be considered in order to maintain a single-frequency characteristic of the ACK/NACK signal and reduce ACK/NACK transmission power.

Together with ACK/NACK multiplexing, contents of ACK/NACK responses for multiple data units may be identified by combining a PUCCH resource and a resource of QPSK modulation symbols used for actual ACK/NACK transmission.

For example, when one PUCCH resource may transmit 4 bits and four data units may be maximally transmitted, an ACK/NACK result may be identified in the eNB as shown in Table 6 given below.

TABLE 6

| HARQ-ACK(O), HARQ-ACK(1), | | b(0), |
|---|---|---|
| HARQ-ACK(2), HARQ-ACK(3) | n_{PUCCH}⁽¹⁾ | b(1) |
| ACK, ACK, ACK, ACK | n_{PUCCH, 1}⁽¹⁾ | 1, 1 |
| ACK, ACK, ACK, NACK/DTX | n_{PUCCH, 1}⁽¹⁾ | 1, 0 |
| NACK/DTX, NACK/DTX, NACK, DTX | n_{PUCCH, 2}⁽¹⁾ | 1, 1 |
| ACK, ACK, NACK/DTX, ACK | n_{PUCCH, 1}⁽¹⁾ | 1, 0 |
| NACK, DTX, DTX, DTX | n_{PUCCH, 0}⁽¹⁾ | 1, 0 |
| ACK, ACK, NACK/DTX, NACK/DTX | n_{PUCCH, 1}⁽¹⁾ | 1, 0 |
| ACK, NACK/DTX, ACK, ACK | n_{PUCCH, 3}⁽¹⁾ | 0, 1 |
| NACK/DTX, NACK/DTX, NACK/DTX, NACK | n_{PUCCH, 3}⁽¹⁾ | 1, 1 |
| ACK, NACK/DTX, ACK, NACK/DTX | n_{PUCCH, 2}⁽¹⁾ | 0, 1 |
| ACK, NACK/DTX, NACK/DTX, ACK | n_{PUCCH, 0}⁽¹⁾ | 0, 1 |
| ACK, NACK/DTX, NACK/DTX, NACK/DTX | n_{PUCCH, 0}⁽¹⁾ | 1, 1 |
| NACK/DTX, ACK, ACK, ACK | n_{PUCCH, 3}⁽¹⁾ | 0, 1 |
| NACK/DTX, NACK, DTX, DTX | n_{PUCCH, 1}⁽¹⁾ | 0, 0 |
| NACK/DTX, ACK, ACK, NACK/DTX | n_{PUCCH, 2}⁽¹⁾ | 1, 0 |
| NACK/DTX, ACK, NACK/DTX, ACK | n_{PUCCH, 3}⁽¹⁾ | 1, 0 |
| NACK/DTX, ACK, NACK/DTX, NACK/DTX | n_{PUCCH, 1}⁽¹⁾ | 0, 1 |
| NACK/DTX, NACK/DTX, ACK, ACK | n_{PUCCH, 3}⁽¹⁾ | 0, 1 |
| NACK/DTX, NACK/DTX, ACK, NACK/DTX | n_{PUCCH, 2}⁽¹⁾ | 0, 0 |
| NACK/DTX, NACK/DTX, NACK/DTX, ACK | n_{PUCCH ,3}⁽¹⁾ | 0, 0 |
| DTX, DTX, DTX, DTX | N/A | N/A |

In Table 6 given above, HARQ-ACK(i) represents an ACK/NACK result for an i-th data unit. In Table 6 given above, discontinuous transmission (DTX) means that there is no data unit to be transmitted for the corresponding HARQ-ACK(i) or that the terminal may not detect the data unit corresponding to the HARQ-ACK(i).

According to Table 6 given above, a maximum of four PUCCH resources (n_{PUCCH,0}⁽¹⁾, n_{PUCCH,1}⁽¹⁾, n_{PUCCH,2}⁽¹⁾, and n_{PUCCH,3}⁽¹⁾) are provided and b(0) and b(1) are two bits transmitted by using a selected PUCCH.

For example, when the terminal successfully receives all of four data units, the terminal transmits 2 bits (1,1) by using n_{PUCCH,1}⁽¹⁾.

When the terminal fails in decoding in first and third data units and succeeds in decoding in second and fourth data units, the terminal transmits bits (1,0) by using n_{PUCCH,3}⁽¹⁾.

In ACK/NACK channel selection, when there is at least one ACK, the NACK and the DTX are coupled with each other. The reason is that a combination of the PUCCH resource and the QPSK symbol may not all ACK/NACK states. However, when there is no ACK, the DTX is decoupled from the NACK.

In this case, the PUCCH resource linked to the data unit corresponding to one definite NACK may also be reserved to transmit signals of multiple ACKs/NACKs.

Block Spreading Scheme

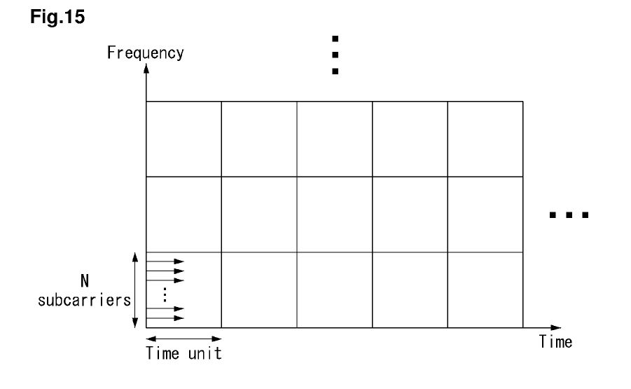

The block spreading technique is a scheme that modulates transmission of the control signal by using the SC-FDMA scheme unlike the existing PUCCH format 1 series or 2 series. As illustrated in FIG. 15, a symbol sequence may be spread and transmitted on the time domain by using an orthogonal cover code (OCC). The control signals of the plurality of terminals may be multiplexed on the same RB by using the OCC. In the case of PUCCH format 2 described above, one symbol sequence is transmitted throughout the time domain and the control signals of the plurality of terminals are multiplexed by using the cyclic shift (CS) of the CAZAC sequence, while in the case of a block spreading based on PUCCH format (for example, PUCCH format 3), one symbol sequence is transmitted throughout the frequency domain and the control signals of the plurality of terminals are multiplexed by using the time domain spreading using the OCC.

FIG. 14 illustrates one example of generating and transmitting 5 SC-FDMA symbols during one slot in the wireless communication system to which the present invention can be applied.

In FIG. 14, an example of generating and transmitting 5 SC-FDMA symbols (that is, data part) by using an OCC having the length of 5 (alternatively, SF=5) in one symbol sequence during one slot. In this case, two RS symbols may be used during one slot.

In the example of FIG. 14, the RS symbol may be generated from a CAZAC sequence to which a specific cyclic shift value is applied and transmitted in a type in which a predetermined OCC is applied (alternatively, multiplied) throughout a plurality of RS symbols. Further, in the example of FIG. 8, when it is assumed that 12 modulated symbols are used for each OFDM symbol (alternatively, SC-FDMA symbol) and the respective modulated symbols are generated by QPSK, the maximum bit number which may be transmitted in one slot becomes 24 bits (=12×2). Accordingly, the bit number which is transmittable by two slots becomes a total of 48 bits. When a PUCCH channel structure of the block spreading scheme is used, control information having an extended size may be transmitted as compared with the existing PUCCH format 1 series and 2 series.

HARQ (Hybrid—Automatic Repeat and Request)

In a mobile communication system, a single eNB transmits/receives data through a plurality of UEs and a radio channel environment in one cell/sector.

In a system using multiple carriers and operating in a similar manner, an eNB receives packet traffic from the wired Internet and transmits the received packet traffic to each UE using a predetermined communication method. In this case, what the eNB determines that it will transmit data to which UE using which frequency region at which timing is downlink scheduling.

Furthermore, the eNB receives and demodulates data transmitted by a UE using a communication method of a predetermined form, and transmits packet traffic through the wired Internet. What an eNB determines that it will allow which UE to transmit uplink data using which frequency band at which timing is uplink scheduling. In general, a UE having a better channel state transmits/receives data using more time and more frequency resources.

FIG. 15 is a diagram illustrating a time-frequency resource block in a time frequency domain in a wireless communication system to which the present invention may be applied.

A resource in a system using multiple carriers and operating in a similar way may be basically divided into time and frequency regions. The resource may be defined as a resource block. The resource block includes a specific N subcarrier and a specific M subframe or a predetermined time unit. In this case, N and M may be 1.

In FIG. 15, one square means one resource block, and one resource block has multiple subcarriers as one axis and a predetermined time unit as the other axis. In the downlink, an eNB schedules one or more resource blocks to a selected UE according to a predetermined scheduling rule. The eNB transmits data to the UE using the allocated resource blocks. In the uplink, an eNB schedules one or more resource blocks to a selected UE according to a predetermined scheduling rule. The UE transmits data in the uplink using the allocated resource.

After data is transmitted after scheduling, an error control method when a frame is lost or damaged includes an automatic repeat request (ARQ) method and a hybrid ARQ (HARQ) method of a more advanced form.

Basically, in the ARQ method, after one frame is transmitted, an acknowledgement message (ACK) waits to be received. The reception side transmits an acknowledgement message (ACK) only when a frame is correctly received. When an error occurs in the frame, the reception side transmits a negative-ACK (NAK) message and deletes corresponding information of the erroneously received frame from a reception stage buffer. When the transmission side receives an ACK signal, it transmits a frame subsequently. When the transmission side receives a NACK message, however, it retransmits a frame.

Unlike in the ARQ method, in the HARQ method, if a received frame cannot be demodulated, the reception stage transmits a NACK message to the transmission stage, but stores an already received frame in the buffer for a specific time and combines a frame with the received frame when the corresponding frame is retransmitted, thereby increasing a reception success ratio.

Recently, the HARQ method more efficient than the basic ARQ method is widely used. The HARQ method includes multiple types, and may be basically divided into synchronous HARQ and asynchronous HARQ based on retransmission timing. The HARQ method may be divided into a channel-adaptive method and a channel non-adaptive method depending on whether a channel state is incorporated into the amount of resources used upon retransmission.

The synchronous HARQ method is a method in which subsequent retransmission has been performed by a system at predetermined timing after initial transmission has failed. That is, assuming that retransmission is performed every fourth time unit after initial transmission fails, timing does not need to be notified because the timing at which retransmission is performed has already been agreed between an eNB and a UE. In this case, if a NACK message has been received, the data transmission side retransmits a frame every fourth time unit until it receives an ACK message.

In contrast, in the asynchronous HARQ method, retransmission timing is newly scheduled or the method may be performed through additional signaling. Timing at which retransmission for a previously failed frame is performed is changed by multiple factors, such as a channel state.

The channel non-adaptive HARQ method is a method in which the modulation of a frame upon retransmission or the number of resource blocks used or AMC is performed according to planned upon initial transmission. In contrast, the channel-adaptive HARQ method is a method in which they are changed depending on the state of a channel. For example, in the channel non-adaptive method, the transmission side has transmitted data using 6 resource blocks upon initial transmission, and also retransmits data using 6 resource blocks upon subsequent retransmission. In contrast, a method of retransmitting data using resource blocks greater than or smaller than 6 depending on a subsequent channel state although initial transmission has been performed using the 6 resource blocks is the channel-adaptive method.

Four combinations of HARQ may be performed based on such a classification, but chiefly used HARQ methods include a synchronous and channel-adaptive HARQ method and a synchronous and channel non-adaptive HARQ methods.

The asynchronous and channel-adaptive HARQ method can maximize retransmission efficiency by adaptively changing retransmission timing and the amount of resources depending on the state of a channel, but has a disadvantage in that overhead is great. Accordingly, in general, the synchronous and channel-adaptive HARQ method is not taken into consideration for the uplink.

Meanwhile, the synchronous and channel non-adaptive HARQ method has an advantage in that overhead is rarely present because timing for retransmission and resource allocation have been agreed within a system, but has a disadvantage in that retransmission efficiency is low if this method is used in a severely changing channel state.

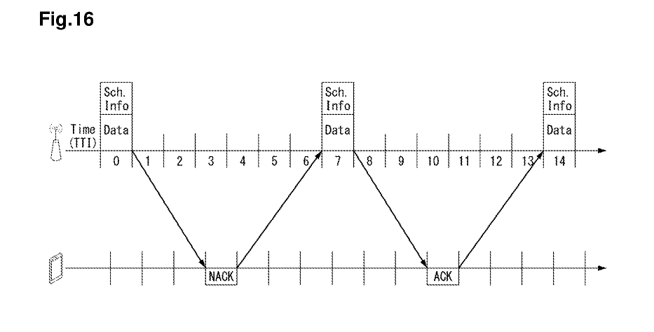

FIG. 16 is a diagram illustrating a resource allocation and retransmission process of an asynchronous HARQ method in a wireless communication system to which the present invention may be applied.

Meanwhile, for example in the case of the downlink, after scheduling is performed and data is transmitted, information of ACK/NACK is received from a UE, and time delay occurs as in FIG. 16 until next data is transmitted. This is channel propagation delay and delay occurring due to the time taken for data decoding and data encoding.

For data transmission not having an empty space during such a delay interval, a transmission method using an independent HARQ process is used. For example, if the shortest periodicity between next data transmission and next data transmission is 7 subframes, data transmission can be performed without an empty space if 7 independent processes are placed.

The LTE physical layer supports HARQ in a PDSCH and PUSCH and transmits associated reception response (ACK) feedback in a separate control channel.

If the LTE FDD system does not operate in MIMO, 8 stop-and-wait (SAW) HARQ processes are supported in both the uplink and downlink as a constant round-trip time (RTT) of 8 ms.

CA-Based Coordinated Multi-Point (CoMP) Operation

In a post-LTE system, cooperative multi-point (CoMP) transmission may be implemented using a carrier aggregation (CA) function in LTE.

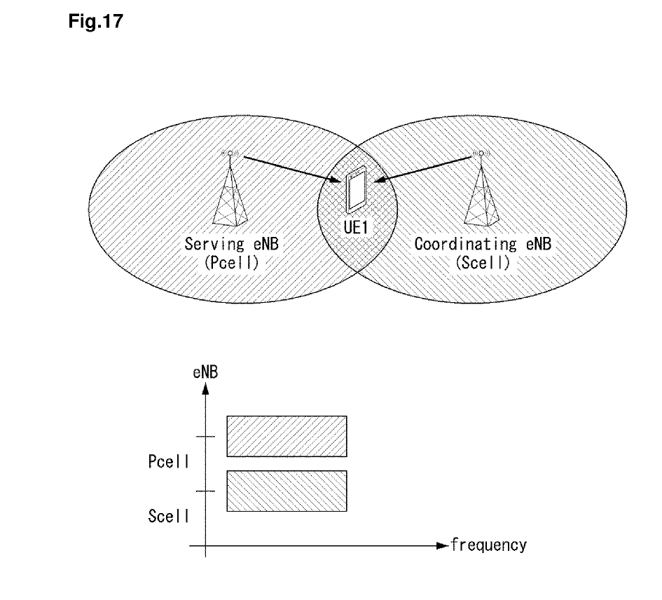

FIG. 17 is a diagram illustrating a carrier aggregation-based CoMP system in a wireless communication system to which the present invention may be applied.

FIG. 17 illustrates a case where a primary cell (PCell) carrier and a secondary cell (SCell) carrier use the same frequency band in a frequency axis and are assigned to two geographically separated eNBs.

A serving eNB may assign a PCell to a UE1, and a neighboring base station providing great interference may assign an SCell to the UE1, so various DL/UL CoMP operations, such as JT, CS/CB and dynamic cell selection, may be possible.

FIG. 17 illustrates an example in which the UE aggregates the two eNBs as a PCell and an SCell, respectively. Practically, one UE may aggregate three or more cells, and some of the cells may perform a CoMP operation in the same frequency band and other cells may perform a simple CA operation in another frequency band. In this case, the PCell does not necessarily need to participate in the CoMP operation.

UE Procedure for Receiving PDSCH

When a UE detects the PDCCH of a serving cell that transmits an intended DCI format 1, 1A, 1B, 1C, 1D, 2, 2A, 2B or 2C to the UE within a subframe other than a subframe(s) indicated by a higher layer parameter “mbsfn-SubframeConfigList”, the number of transport blocks defined in a higher layer is limited. Accordingly, the UE decodes the corresponding PDSCH in the same subframe.

A UE decodes a PDSCH based on a detected PDCCH having CRC scrambled by an SI-RNTI or P-RNTI in which the intended DCI format 1A, 1C is transmitted thereto, and assumes that a PRS is not present in a resource block (RB) in which the corresponding PDSCH is transmitted.

The UE in which a carrier indicator field (CIF) for a serving cell is configured assumes that the carrier indicator field is not present in any PDCCH of the serving cell within a common search space.

If not, the UE in which a CIF is configured assumes that when PDCCH CRC is scrambled by a C-RNTI or SPS C-RNTI, a CIF for a serving cell is present a PDCCH located within a UE-specific-search space.

When the UE is configured by a higher layer to decode a PDCCH having CRC scrambled by an SI-RNTI, the UE decodes the PDCCH and a corresponding PDSCH based on a combination defined in Table 7. The PDSCH corresponding to the PDCCH(s) is scrambling-initialized by an SI-RNTI.

Table 7 illustrates a PDCCH and PDSCH configured by an SI-RNTI.

TABLE 7

| | | Transmission scheme of |
|---|---|---|
| | | PDSCH corresponding to |
| DCI format | Search Space | PDCCH |
| DCI format 1C | Common | When the number of PBCH antenna ports |
| | | is 1, a single-antenna port and port 0 |
| | | is used, and otherwise transmit diversity. |
| DCI format 1A | Common | When the number of PBCH antenna ports |
| | | is 1, a single-antenna port and port 0 |
| | | is used, and otherwise transmit diversity |

When a UE is configured by a higher layer to decode a PDCCH having CRC scrambled by a P-RNTI, the UE decodes the PDCCH and a corresponding PDSCH based on a combination defined in Table 8. the PDSCH corresponding to the PDCCH(s) is scrambling-initialized by the P-RNTI.

Table 8 illustrates a PDCCH and PDSCH configured by a P-RNTI.

TABLE 8

| | | Transmission scheme of |
|---|---|---|
| | | PDSCH corresponding to |
| DCI format | Search Space | PDCCH |
| DCI format 1C | Common | When the number of PBCH antenna ports |
| | | is 1, a single-antenna port and port 0 |
| | | is used, and otherwise transmit diversity |
| DCI format 1A | Common | When the number of PBCH antenna ports |
| | | is 1, a single-antenna port and port 0 |
| | | is used, and otherwise transmit diversity |

When a UE is configured by a higher layer to decode a PDCCH having CRC scrambled by an RA-RNTI, the UE decodes the PDCCH and a corresponding PDSCH based on a combination defined in Table 9. The PDSCH corresponding to the PDCCH(s) is scrambling-initialized by an RA-RNTI.

Table 9 illustrates a PDCCH and PDSCH configured by an RA-RNTI.

TABLE 9

| | | Transmission scheme of |
|---|---|---|
| | | PDSCH corresponding to |
| DCI format | Search Space | PDCCH |
| DCI format 1C | Common | When the number of PBCH antenna ports |
| | | is 1, a single-antenna port and port |
| | | 0 is used, and otherwise transmit diversity |
| DCI format 1A | Common | When the number of PBCH antenna ports |
| | | is 1, a single-antenna port and port 0 |
| | | is used, and otherwise transmit diversity |

A UE may be configured semi-statically through higher layer signaling to receive PDSCH data transmission signaled through a PDCCH according to one of 9 transmission modes like mode 1 to mode 9.

In the case of a frame structure type 1,
A UE does not receive a PDSCH RB transmitted in the antenna port 5 within any subframe in which the number of OFDM symbols for a PDCCH having a normal CP is 4.
If any one of 2 physical resource blocks (PRBs) to which a virtual resource block (VRB) pair is mapped overlaps a frequency in which a PBCH or a primary or secondary synchronization signal is transmitted within the same subframe, the UE does not receive a PDSCH RB transmitted in the antenna port 5, 7, 8, 9, 10, 11, 12, 13 or 14 in the corresponding two PRBs.
A UE does not receive a PDSCH RB transmitted in the antenna port 7 to which distributed VRB resource allocation has been assigned.
A UE may skip the decoding of a transport block if it does not all of allocated PDSCH RBs. When the UE skips the decoding, a physical layer indicates that the transport block has not been successfully decoded with respect to a higher layer.

In the case of a frame structure type 2,
A UE does not receive a PDSCH RB transmitted in the antenna port 5 in any subframe in which the number of OFDM symbols for a PDCCH having a normal CP is 4.
If any one of two PRBs to which a VRB pair is mapped overlaps a frequency in which a PBCH is transmitted within the same subframe, a UE does not receive a PDSCH RB transmitted in the antenna port 5 in the corresponding two PRBs.
If any one of two PRBs to which a VRB pair is mapped overlaps a frequency in which a primary or secondary synchronization signal is transmitted within the same subframe, a UE does not receive a PDSCH RB transmitted in the antenna port 7, 8, 9, 10, 11, 12, 13 or 14 in the corresponding two PRBs.
If a normal CP is configured, a UE does not receive a PDSCH in the antenna port 5 to which distributed VRB resource allocation has been assigned within a special subframe in an uplink-downlink configuration #1 or #6.
A UE does not receive a PDSCH in the antenna port 7 to which distributed VRB resource allocation has been assigned.
A UE may skip the decoding of a transport block when it does not receive all of allocated PDSCH RBs. When the UE skips the decoding, a physical layer indicates that a transport block has not been successfully decoded with respect to a higher layer.

If a UE is configured by a higher layer to decode a PDCCH having CRC scrambled by a C-RNTI, the UE decodes the PDCCH and a corresponding PDSCH based on each combination defined in Table 10. The PDSCH corresponding to the PDCCH(s) is scrambling-initialized by the C-RNTI.

If a CIF for a serving cell is configured in a UE or the UE is configured by a higher layer to decode a PDCCH having CRC scrambled by a C-RNTI, the UE decodes a PDSCH of a serving cell indicated by a CIF value within the decoded PDCCH.

When a UE of the transmission mode 3, 4, 8 or 9 receives DCI format 1A assignment, the UE assumes that PDSCH transmission is related to a transport block 1 and a transport block 2 is disabled.

When a UE is configured as the transmission mode 7, a UE-specific reference signal corresponding to a PDCCH(s) is scrambling-initialized by a C-RNTI.

If an extended CP is used in the downlink, a UE does not support the transmission mode 8.

If a UE is configured as the transmission mode 9, when the UE detects a PDCCH having CRC scrambled by a C-RNTI in which the DCI format 1A or 2C is intended thereto, the UE decodes a corresponding PDSCH in a subframe indicated by a higher layer parameter (“mbsfn-SubframeConfigList”). In this case, a PMCH is configured to be decoded by a higher layer or a PRS occasion is configured only within an MBSFN subframe. A CP length used in a subbframe #0 is a normal CP, and a subframe configured as part of a PRS occasion by a higher layer is excluded.

Table 10 illustrates a PDCCH and PDSCH configured by a C-RNTI.

TABLE 10

| | | | Transmission scheme of |
|---|---|---|---|
| Transmission | | | PDSCH corresponding to |
| mode | DCI format | Search Space | PDCCH |
| Mode 1 | DCI format 1A | Common and | Single-antenna port, port 0 |
| | | UE specific | |
| | | by C-RNTI | |
| | DCI format 1 | UE specific | Single-antenna port, port 0 |
| | | by C-RNTI | |
| Mode 2 | DCI format 1A | Common and | Transmit diversity |
| | | UE specific | |
| | | by C-RNTI | |
| | DCI format 1 | UE specific | Transmit diversity |
| | | by C-RNTI | |
| Mode 3 | DCI format 1A | Common and | Transmit diversity |
| | | UE specific | |
| | | by C-RNTI | |
| | DCI format 2A | UE specific | Large delay CDD or Transmit diversity |
| | | by C-RNTI | |
| Mode 4 | DCI format 1A | Common and | Transmit diversity |
| | | UE specific | |
| | | by C-RNTI | |
| | DCI format 2 | UE specific | Closed-loop spatial multiplexing or |
| | | by C-RNTI | Transmit diversity |
| Mode 5 | DCI format 1A | Common and | Transmit diversity |
| | | UE specific | |
| | | by C-RNTI | |
| | DCI format 1D | UE specific | Multi-user MIMO |
| | | by C-RNTI | |
| Mode 6 | DCI format 1A | Common and | Transmit diversity |
| | | UE specific | |
| | | by C-RNTI | |
| | DCI format 1B | UE specific | Closed-loop spatial multiplexing using a |
| | | by C-RNTI | single transmission layer |
| Mode 7 | DCI format 1A | Common and | When the number of PBCH antenna |
| | | UE specific | ports is 1, a single-antenna port and port |
| | | by C-RNTI | 0 is used, and otherwise transmit |
| | | | diversity |
| | DCI format 1 | UE specific | Single-antenna port, port 5 |
| | | by C-RNTI | |
| Mode 8 | DCI format 1A | Common and | When the number of PBCH antenna |
| | | UE specific | ports is 1, a single-antenna port and port |
| | | by C-RNTI | 0 is used, and otherwise transmit |
| | | | diversity |
| | DCI format 2B | UE specific | Dual layer transmission, port 7 and 8 or |
| | | by C-RNTI | single-antenna port, port 7 or 8 |
| Mode 9 | DCI format 1A | Common and | Non-MBSFN subframe: When the |
| | | UE specific | number of PBCH antenna ports is 1, a |
| | | by C-RNTI | single-antenna port and port 0 is used, |
| | | | and otherwise transmit diversity |
| | | | MBSFN subframe: Single-antenna port, |
| | | | port 7 |
| | DCI format 2C | UE specific | Up to 8 layer transmission, ports 7-14 |
| | | by C-RNTI | |

If a UE is configured by a higher layer to decode a PDCCH having CRC scrambled by an SPS C-RNTI, the UE decodes the PDCCH of a primary cell and a corresponding PDSCH of the primary cell based on each combination defined in Table 11. If the PDSCH is transmitted without the corresponding PDCCH, the same PDSCH-related configuration is applied. The corresponding PDSCH and a PDSCH not having a PDCCH in the PDCCH are scrambling-initialized by the SPS C-RNTI.

If a UE is configured to the transmission mode 7, a UE-specific reference signal corresponding to a PDCCH(s) is scrambling-initialized by an SPS C-RNTI.

If a UE is configured to the transmission mode 9, when the UE detects a PDSCH configured without a PDCCH having CRC scrambled by an SPS C-RNTI in which the DCI format 1A or 2C intended thereto is delivered or a PDCCH intended thereto, the UE decodes the corresponding PDSCH in a subframe indicated by a higher layer parameter (“mbsfn-SubframeConfigList”). In this case, a PMCH is configured to be decoded by a higher layer or a PRS occasion is configured only within an MBSFN subframe. A CP length used in a subframe #0 is a normal CP, and a subframe configured as part of the PRS occasion by a higher layer is excluded.

Table 11 illustrates a PDCCH and PDSCH configured by an SPS C-RNTI.

TABLE 11

| | | | Transmission scheme of |
|---|---|---|---|
| Transmission | | | PDSCH corresponding to |
| mode | DCI format | Search Space | PDCCH |
| Mode 1 | DCI format 1A | Common and | Single-antenna port, port 0 |
| | | UE specific | |
| | | by C-RNTI | |
| | DCI format 1 | UE specific | Single-antenna port, port 0 |
| | | by C-RNTI | |
| Mode 2 | DCI format 1A | Common and | Transmit diversity |
| | | UE specific | |
| | | by C-RNTI | |
| | DCI format 1 | UE specific | Transmit diversity |
| | | by C-RNTI | |
| Mode 3 | DCI format 1A | Common and | Transmit diversity |
| | | UE specific | |
| | | by C-RNTI | |
| | DCI format 2A | UE specific | Transmit diversity |
| | | by C-RNTI | |
| Mode 4 | DCI format 1A | Common and | Transmit diversity |
| | | UE specific | |
| | | by C-RNTI | |
| | DCI format 2 | UE specific | Transmit diversity |
| | | by C-RNTI | |
| Mode 5 | DCI format 1A | Common and | Transmit diversity |
| | | UE specific | |
| | | by C-RNTI | |
| Mode 6 | DCI format 1A | Common and | Transmit diversity |
| | | UE specific | |
| | | by C-RNTI | |
| Mode 7 | DCI format 1A | Common and | Single-antenna port, port 5 |
| | | UE specific | |
| | | by C-RNTI | |
| | DCI format 1 | UE specific | Single-antenna port, port 5 |
| | | by C-RNTI | |
| Mode 8 | DCI format 1A | Common and | Single-antenna port, port 7 |
| | | UE specific | |
| | | by C-RNTI | |
| | DCI format 2B | UE specific | Single-antenna port, port 7 or 8 |
| | | by C-RNTI | |
| Mode 9 | DCI format 1A | Common and | Single-antenna port, port 7 |
| | | UE specific | |
| | | by C-RNTI | |
| | DCI format 2C | UE specific | Single-antenna port, port 7 or 8 |
| | | by C-RNTI | |

If a UE is configured by a higher layer to decode a PDCCH having CRC scrambled by a temporary C-RNTI and to not decode a PDCCH having CRC scrambled by a C-RNTI, the UE decodes the PDCCH and a corresponding PDSCH based on a combination defined in Table 12. The PDSCH corresponding to the PDCCH(s) is scrambling-initialized by the temporary C-RNTI.

Table 12 illustrates a PDCCH and PDSCH configured by a temporary C-RNTI.

TABLE 12

| | | Transmission scheme of |
|---|---|---|
| | | PDSCH corresponding to |
| DCI format | Search Space | PDCCH |
| DCI | Common and | When the number of PBCH antenna |
| format 1A | UE specific by | ports is 1, a single-antenna port |
| | Temporary C-RNTI | and port 0 is used, and otherwise |
| | | transmit diversity |
| DCI | UE specific by | When the number of PBCH antenna |
| format 1 | Temporary C-RNTI | ports is 1, a single-antenna port |
| | | and port 0 is used, and otherwise |
| | | transmit diversity |

UE Procedure of Transmitting PUSCH

A UE is semi-statically configured through higher layer signaling to transmit PUSCH transmission signaled through a PDCCH based on any one of two uplink transmission modes of the modes 1 and 2 defined in Table 13. If a UE is configured by a higher layer to decode a PDCCH having CRC scrambled by a C-RNTI, the UE decodes the PDCCH based on a combination defined in Table 13 and transmits a corresponding PUSCH. PUSCH retransmission for the same transport block as PUSCH transmission corresponding to the PDCCH(s) is scrambling-initialized by a C-RNTI. The transmission mode 1 is a default uplink transmission mode for a UE until an uplink transmission mode is assigned in the UE through higher layer signaling.

When a UE is configured to the transmission mode 2 and receives a DCI format 0 uplink scheduling grant, the UE assumes that PUSCH transmission is related to a transport block 1 and a transport block 2 is disabled.

Table 13 illustrates a PDCCH and PUSCH configured by a C-RNTI.

TABLE 13

| | | | Transmission scheme of |
|---|---|---|---|
| Transmission | | | PUSCH corresponding to |
| mode | DCI format | Search Space | PDCCH |
| Mode 1 | DCI format 0 | Common and | Single-antenna port, |
| | | UE specific | port 10 |
| | | by C-RNTI | |
| Mode 2 | DCI format 0 | Common and | Single-antenna port, |
| | | UE specific | port 10 |
| | | by C-RNTI | |
| | DCI format 4 | UE specific | Closed-loop spatial |
| | | by C-RNTI | multiplexing |

If a UE is configured by a higher layer to decode a PDCCH having CRC scrambled by a C-RNTI and configured to receive a random access procedure initiated by a PDCCH order, the UE decodes a PDCCH based on a combination defined in Table 14.

Table 14 illustrates a PDCCH configured by a PDCCH order for initiating a random access procedure.

TABLE 14

| DCI format | Search Space |
|---|---|
| DCI format 1A | Common and |
| | UE specific by C-RNTI |

If a UE is configured by a higher layer to decode a PDCCH having CRC scrambled by an SPS C-RNTI, the UE decodes the PDCCH based on a combination defined in Table 15, and transmits a corresponding PUSCH. PUSCH retransmission for the same transport block as PUSCH transmission corresponding to the PDCCH(s) is scrambling-initialized by the SPS C-RNTI. PUSCH retransmission for the same transport block as the minimum transmission of a PUSCH without a corresponding PDCCH is scrambling-initialized by the SPS C-RNTI.

Table 15 illustrates a PDCCH and PUSCH configured by an SPS C-RNTI.

TABLE 15

| | | | Transmission scheme of |
|---|---|---|---|
| Transmission | | | PUSCH corresponding to |
| mode | DCI format | Search Space | PDCCH |
| Mode 1 | DCI format 0 | Common and | Single-antenna port, |
| | | UE specific | port 10 |
| | | by C-RNTI | |
| Mode 2 | DCI format 0 | Common and | Single-antenna port, |
| | | UE specific | port 10 |
| | | by C-RNTI | |

If a UE is configured by a higher layer to decode a PDCCH scrambled by a temporary C-RNTI regardless of whether the UE has been configured to decode a PDCCH having CRC scrambled by a C-RNTI, the UE decodes the PDCCH based on a combination defined in Table 16 and transmits a corresponding PUSCH. A PUSCH corresponding to the PDCCH(s) is scrambling-initialized by the temporary C-RNTI.

When a temporary C-RNTI is configured by a higher layer, PUSCH retransmission for the same transport block as PUSCH transmission corresponding to a random access response grant is scrambled by the temporary C-RNTI. If not, PUSCH retransmission for the same transport block as PUSCH transmission corresponding to a random access response grant is scrambled by a C-RNTI.

Table 16 illustrates a PDCCH configured by a temporary C-RNTI.

TABLE 16

| DCI format | Search Space |
|---|---|
| DCI format 0 | Common |

If a UE is configured by a higher layer to decode a PDCCH having CRC scrambled by a TPC-PUCCH-RNTI, the UE decodes the PDCCH based on a combination defined in Table 17. In Table 17, a mark 3/3A involves that the UE receives the DCI format 3 or DCI format according to a configuration.

Table 17 illustrates a PDCCH scrambled by a TPC-PUCCH-RNTI.

TABLE 17

| DCI format | Search Space |
|---|---|
| DCI format 3/3A | Common |

If a UE is configured by a higher layer to decode a PDCCH having CRC scrambled by a TPC-PUSCH-RNTI, the UE decodes the PDCCH based on a combination defined in Table 18. In Table 18, a mark 3/3A involves that the UE receives the DCI format 3 or DCI format according to a configuration.

Table 18 illustrates a PDCCH configured by a TPC-PUSCH-RNTI.

TABLE 17

| DCI format | Search Space |
|---|---|
| DCI format 3/3A | Common |

Cross-CC Scheduling and E-PDCCH Scheduling

In the existing 3GPP LTE Rel-10 system, if a cross-CC scheduling operation is defined in an aggregation situation for a plurality of CCs (component carrier=(serving) cell), one CC may be preset to be able to receive DL/UL scheduling from only one specific CC (i.e., scheduling CC) (namely, to be able to receive DL/UL grant PDCCH for the corresponding scheduled CC).

The corresponding scheduling CC may basically perform a DL/UL scheduling for the scheduling CC itself.

In other words, the SS for the PDCCH scheduling the scheduling/scheduled CC in the cross-CC scheduling relation may come to exist in the control channel area of the scheduling CC.

Meanwhile, in the LTE system, CFDD DL carrier or TDD DL subframes use first n OFDM symbols of the subframe for PDCCH, PHICH, PCFICH and the like which are physical channels for transmission of various types of control information and use the rest of the OFDM symbols for PDSCH transmission.

At this time, the number of symbols used for control channel transmission in each subframe is dynamically transmitted to the UE through the physical channel such as PCFICH or is semi-statically transmitted to the UE through RRC signaling.

At this time, particularly, value n may be set by 1 to 4 symbols depending on the subframe characteristic and system characteristic (FDD/TDD, system bandwidth, etc.).

Meanwhile, in the existing LTE system, PDCCH, which is the physical channel for transmitting DL/UL scheduling and various control information, may be transmitted through limited OFDM symbols.

Hence, the enhanced PDCCH (i.e., E-PDCCH), which is more freely multiplexed in PDSCH and FDM/TDM scheme, may be introduced instead of the control channel which is transmitted through the OFDM which is separated from the PDSCH like PDCCH.

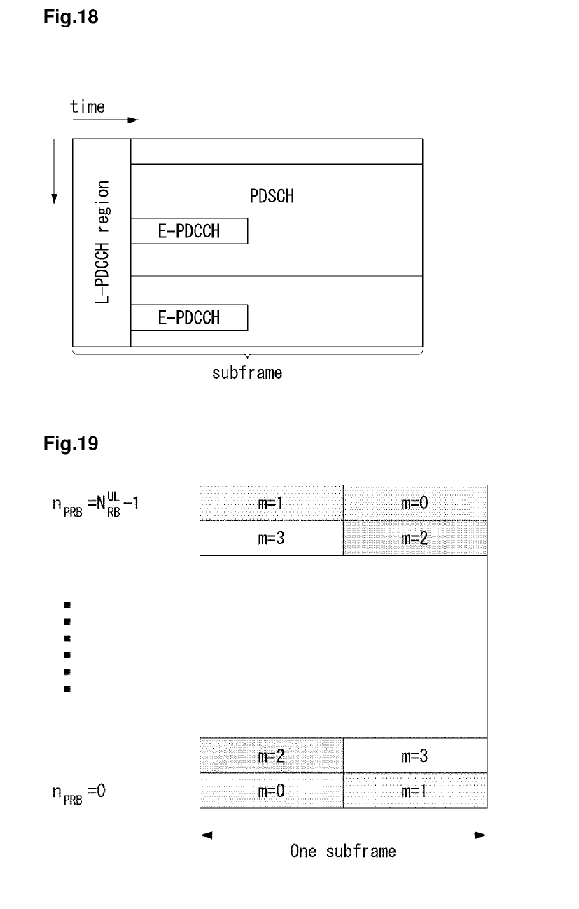

FIG. 18 illustrates an example of multiplexing legacy PDCCH, PDSCH and E-PDCCH.

Here, the legacy PDCCH may be expressed as L-PDCCH.

Quasi Co-Location

QC/QCL (quasi co-located or quasi co-location) can be defined as below.

If two antenna ports are in QC/QCL relationship (or QC/QCL), then a large-scale property of the signal transmitted through one antenna port is transmitted to the other antenna port It can be assumed that the terminal can be inferred. Here, the wide-range characteristic includes at least one of a delay spread, a Doppler spread, a frequency shift, an average received power, and a received timing.

It may also be defined as follows. If two antenna ports are QC/QCL-related (or QC/QCL), then the large-scale properties of the channel through which one symbol is transmitted through one antenna port is transmitted through the other antenna port It can be assumed that the terminal can be inferred from a radio channel through which a symbol is transmitted. Here, the large-scale properties includes at least one of a delay spread, a Doppler spread, a Doppler shift, an average gain, and an average delay.

That is, the two antenna ports are in the QC/QCL relationship (or QC/QCL), which means that the large-scale channel properties of the radio channel from one antenna port are the same as the large-scale channel properties of the radio channel from the other antenna port. Considering a plurality of antenna ports through which RSs are transmitted, if the antenna ports through which two different types of RSs are transmitted are in the QCL relationship, the large-scale properties of the radio channels from one type of antenna port can be replaced by the large-scale properties of the wireless channel.

In this specification, the above QC/QCL related definitions are not distinguished. That is, the QC/QCL concept can follow one of the above definitions. Or in a similar manner, it can be assumed that a QC/QCL hypothesis can be assumed to be transmitted at the co-location between the antenna ports established by the QC/QCL hypothesis (for example, UE may assume that there are antenna ports transmitted at the same transmission point), the QC/QCL concept definition may be modified by the terminal, and the spirit of the present invention includes such similar variations. In the present invention, QC/QCL related definitions are used in combination for convenience of explanation.

According to the QC/QCL concept, the UE may not assume the same large-scale channel properties between corresponding antenna ports for non-QC/QCL (Non-QC/QCL) antenna ports. That is, in this case, a typical UE receiver should perform independent processing on each non-quasi-co-located (NQC) AP which has been configured for timing acquisition and tracking, frequency offset estimation and compensation, delay estimation, and Doppler estimation.

There is an advantage in that UE can perform the following operation between APs capable of assuming QC:
With respect to Delay spread & Doppler spread, UE may identically apply a power-delay-profile, a delay spread and Doppler spectrum, and a Doppler spread estimation result for one port to a Wiener filter used upon channel estimation for the other port.
With respect to Frequency shift & Received Timing, UE may perform time and frequency synchronization on any one port and then apply the same synchronization to the demodulation of the other port.
With respect to Average received power, UE may average RSRP measurements for over two or more antenna ports.

For example, if a DMRS antenna port for downlink data channel demodulation has been QC/QCL with the CRS antenna port of a serving cell, a UE may apply the large-scale properties of a radio channel estimated from its own CRS antenna port upon channel estimation through a corresponding DMRS antenna port identically, thereby being capable of improving MRS-based downlink data channel reception performance.

The reason for this is that a CRS is a reference signal broadcasted every subframe or over a full band with relatively high density and thus estimates regarding the large-scale properties can be obtained more stably from the CRS. In contrast, a DMRS is transmitted in a UE-specific manner with respect to a specific scheduled RB. Furthermore, since the precoding matrix of a precoding resource block group (PRG) unit used for transmission by a base station may change, a valid channel received by a UE may change in the PRG unit. Accordingly, although multiple PRGs have been scheduled, performance deterioration may occur when the DMRS is used for the large-scale property estimation of a radio channel in a wide band. Furthermore, a CSI-RS may also have a transmission cycle of several several tens of ms, and has low density of 1 resource element per antenna port on average per a resource block. Accordingly, likewise, performance deterioration may occur if the CSI-RS is used for the large-scale property estimation of a radio channel.

That is, the UE can use QC/QCL assumption between antenna ports for the detection/reception of a downlink reference signal, channel estimation, and channel state reporting.

Physical Uplink Control Channel (PUCCH)

A PUCCH, that is, a physical uplink control channel, carries uplink control information. The simultaneous transmission of a PUCCH and PUSCH from the same UE is supported if it is enabled by a higher layer. In the case of the frame structure type 2, a PUCCH is not transmitted in an UpPTS field.

A physical uplink control channel supports multiple formats described in Table 19.

The formats 2a and 2b correspond to a normal cyclic prefix.

TABLE 19

| PUCCH format | Modulation scheme | Number of bits per subframe, M_{bit} |
|---|---|---|
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + QPSK | 22 |
| 3 | QPSK | 48 |

All of PUCCH formats use a cyclic shift (n_{cs}^{cell}(nₛ,l). The shift is different depending on a symbol number (I) and a slot number (ns) according to Equation 6.

n_{cs}^{cell}(nₛ,l)=Σᵢ₌₀⁷c(8N_{symb}^{UL}·nₛ+8l+i)·2ⁱ [Equation 6]

In this case, c(i) means a pseudo random sequence, and a pseudo random sequence generator is initialized by an initial value (cᵢₙᵢₜ=n_{ID}^{RS}). In this case, the ID index (n_{ID}^{RS}) of an RE is determined by a cell ID number (N_{ID}^{cell}) corresponding to a primary cell in the start part of each radio frame. A physical resource used for a PUCCH is different depending on two parameters (N_{RB}⁽²⁾ and N_{cs}⁽¹⁾), which are provided by a higher layer.

A variable (N_{RB}⁽²⁾≥0) indicates a bandwidth in the viewpoint of a resource block available for PUCCH formats 2/2a/2b transmission in each slot. A variable (N_{cs}⁽¹⁾) indicates the number of cyclic shifts used for the PUCCH formats 1/1a/1b in a resource block used in a mixture of the formats 1/1a/1b and 2/2a/2b. A value of N_{cs}⁽¹⁾ is a positive number times Δ_{shift}^{PUCCH} within a {0, 1, . . . , 7} range. Δ_{shift}^{PUCCH} is provided by a higher layer. Furthermore, if N_{cs}⁽¹⁾=0, a mixed resource block is not present. A maximum of one resource block of each slot supports a mixture of the formats 1/1 a/1 b and 2/2a/2b.

Resources used for the transmission of the PUCCH formats 1/1a/1b, 2/2a/2b and 3 are marked by indices n_{PUCCH}^{(1,\tilde{p})},

$${n}_{PUCCH}^{( 2 , \tilde{p} )} < {N}_{RB}^{( 2 )} {N}_{sc}^{RB} + ⌈ \frac{{N}_{cs}}{8} ⌉ \cdot ( {N}_{sc}^{RB} - {N}_{cs}^{( 1 )} - 2 ) ,$$

and n_{PUCCH}^{(3,\tilde{p})} not a negative value.

PUCCH Formats 1, 1a and 1b

With respect to the PUCCH format 1, information is carried by whether the transmission of a PUCCH from a UE is present. In the last part of this paragraph, d(0)=1 is assumed with respect to the PUCCH format 1. In the case of the PUCCH formats 1a and 1 b, one or two explicit bits are transmitted. A block of bits (b(0), . . . , b(Mbit−1)) needs to be modulated as described in Table 20, and becomes a complex value symbol d(0).

TABLE 20

| PUCCH format | b(0), . . . , b(M_{bit} − 1) | d(0) |
|---|---|---|
| 1a | 0 | 1 |
| | 1 | −1 |
| 1b | 00 | 1 |
| | 01 | −j |
| | 10 | j |
| | 11 | −1 |

A modulation method for a different PUCCH format is shown in Table 19. A complex symbol d(0) needs to be multiplied by a sequence (r_{u,v}^{(α}^{_{\tilde{p}}}⁾(n)) of a periodically shifted length 12 (N_{seq}^{PUCCH}=12) for each antenna port (P) used for PUCCH transmission according to Equation 7.

$${y}^{( \tilde{p} )} ( n ) = \frac{1}{\sqrt{P}} d ( 0 ) \cdot {r}_{u , v}^{( {α}_{\tilde{p}} )} ( n ) , n = 0 , 1 , … , {N}_{seq}^{PUCCH} - 1 \qquad [ Equation 7 ]$$

In this case, r_{u,v}^{(α}^{_{\tilde{p}}}⁾(n) may be defined as M_{sc}^{RS}=N_{seq}^{PUCCH}. An antenna-port specific cyclic shift (α_{\tilde{p}}) is changed between symbols and slots as defined below.

A block (y^{(\tilde{p})}(0), . . . , y^{(\tilde{p})}(N_{seq}^{PUCCH}−1)) of symbols of a complex value is scrambled by block-wise spread and S(ns) according to an antenna-port specific orthogonal sequence (wₙ_{_{oc}}_{^{(\tilde{p})}}(i)) in Equation 8.

z^{(\tilde{p})}(m′·N_{SF}^{PUCCH}·N_{seq}^{PUCCH}+m·N_{seq}^{PUCCH}+n)=S(nₛ)·wₙ_{_{oc}}_{^{(\tilde{p})}}(m)·y^{(\tilde{p})}(n) [Equation 8]

In this case, m, n, m′, and S(ns) satisfies the conditions of Equations 9 and 10.

$$\begin{matrix}m = 0 , … , {N}_{SF}^{PUCCH} - 1 \\ n = 0 , … , {N}_{seq}^{PUCCH} - 1 \\ {m}^{′} = 0 , 1 & [ Equation 9 ] \\ S ( {n}_{s} ) = \{ \begin{matrix}1 & if {n}_{\tilde{p}}^{′} ( {n}_{s} ) mod 2 = 0 \\ {e}^{j π / 2} & otherwise\end{matrix} & [ Equation 10 ]\end{matrix}$$

In this case, N_{SF}^{PUCCH}=4 is used for two slots of the normal PUCCH formats 1/1a/1b, and N_{SF}^{PUCCH}=4 is used for the first slot of the shortened PUCCH formats 1/1a/1b and N_{SF}^{PUCCH}=3 is used for the second slot thereof. A sequence (wₙ_{_{oc}}_{^{(\tilde{p})}}(i)) is given by Table 21 and Table 22.

TABLE 21

| Sequence index | Orthogonal sequences |
|---|---|
| n_{oc}^{(\tilde{p})}(nₛ) | [w(0) . . . w(N_{SF}^{PUCCH} − 1)] |
| 0 | [+1 +1 +1 +1] |
| 1 | [+1 −1 +1 −1] |
| 2 | [+1 −1 −1 +1] |

TABLE 22

| Sequence index | Orthogonal sequences |
|---|---|
| n_{oc}^{(\tilde{p})}(nₛ) | [w(0) . . . w(N_{SF}^{PUCCH} − 1)] |
| 0 | [1 1 1] |
| 1 | [1 e^{j2π/3} e^{j4π/3}] |
| 2 | [1 e^{j4π/3} e^{j2π/3}] |

Resources used for the transmission of the PUCCH formats 1, 1a and 1 b are identified by an orthogonal sequence index (n_{oc}^{(\tilde{p})}(nₛ)) determined according to Equation 11 and a resource index (n_{PUCCH}^{(1,\tilde{p})}) from a cyclic shift (α_{\tilde{p}}(nₛ,l)).

$${n}_{oc}^{( \tilde{p} )} ( {n}_{s} ) = \{ \begin{matrix}⌊ {n}_{\tilde{p}}^{′} ( {n}_{s} ) \cdot {Δ}_{shift}^{PUCCH} / {N}^{′} ⌋ & for normal cyclic prefix \\ 2 \cdot ⌊ {n}_{\tilde{p}}^{′} ( {n}_{s} ) \cdot {Δ}_{shift}^{PUCCH} / {N}^{′} ⌋ & for extended cyclic prefix\end{matrix} \\ {α}_{\tilde{p}} ( {n}_{s} , l ) = 2 \cdot {n}_{cs}^{( \tilde{p} )} ( {n}_{s} , l ) / {N}_{sc}^{RB} \\ {n}_{cs}^{( \tilde{p} )} ( {n}_{s} , l ) = \{ \begin{matrix}[ {n}_{cs}^{cell} ( {n}_{s} , l ) + ( {n}_{\tilde{p}}^{′} ( {n}_{s} ) \cdot {Δ}_{shift}^{PUCCH} + ( {n}_{oc}^{( \tilde{p} )} ( {n}_{s} ) mod {Δ}_{shift}^{PUCCH} ) ) mod {N}^{′} ] mod {N}_{sc}^{RB} & for normal cyclic prefix \\ [ {n}_{cs}^{cell} ( {n}_{s} , l ) + ( {n}_{\tilde{p}}^{′} ( {n}_{s} ) \cdot {Δ}_{shift}^{PUCCH} + {n}_{oc}^{( \tilde{p} )} ( {n}_{s} ) / 2 ) mod {N}^{′} ] mod {N}_{sc}^{RB} & for extended cyclic prefix\end{matrix} \qquad [ Equation 11 ]$$

In Equation 11, N′ and c satisfies the condition of Equation 12.

$${N}^{′} = \{ \begin{matrix}{N}_{cs}^{( 1 )} & if {n}_{PUCCH}^{( 1 , \tilde{p} )} < c \cdot {N}_{cs}^{( 1 )} / {Δ}_{shift}^{PUCCH} \\ {N}_{sc}^{RB} & otherwise \end{matrix} \\ c = \{ \begin{matrix}3 & normal cyclic prefix \\ 2 & extended cyclic prefix\end{matrix} \qquad [ Equation 12 ]$$

PUCCH Formats 2, 2a, and 2b

In the case of the PUCCH formats 2, 2a, and 2b, the blocks (b(0), . . . , b(19)) of bits need to be scrambled as a UE-specific scrambling sequence according to Equation 13. As a result, the blocks of the bits become the blocks (\tilde{b}(0), . . . , \tilde{b}(19)) of scrambled bits.

\tilde{b}(i)=(b(i)+c(i))mod 2 [Equation 13]

In this case, c(i) means a scrambling sequence. A scrambling sequence generator is initialized by an initial value (cᵢₙᵢₜ=(└nₛ/2┘+1)·(2N_{ID}^{cell}+1)·2¹⁶+n_{RNTI}) at the start part of each subframe in which nRNTI is a C-RNTI. The blocks (\tilde{b}(0), . . . , \tilde{b}(19) of scrambled bits need to be QPSK-modulated. As a result, the blocks of the scrambled bits become the blocks (d(0), . . . , d(9)) of modulation symbols of a complex value.

Each of the complex symbols (d(0), . . . , d(9)) needs to be multiplied by the sequence (r_{u,v}^{(α}^{_{\tilde{p}}}⁾(n)) of a periodically shifted length 12 (N_{seq}^{PUCCH}=12) for each antenna port (P) used for PUCCH transmission according to Equation 14.

$${z}^{( \tilde{p} )} ( {N}_{seq}^{PUCCH} \cdot n + i ) = \frac{1}{\sqrt{P}} d ( n ) \cdot {r}_{u , v}^{( {α}_{\tilde{p}} )} ( i ) \\ n = 0 , 1 , … , 9 \\ i = 0 , 1 , … , {N}_{sc}^{RB} - 1 \qquad [ Equation 14 ]$$

In this case, r_{u,v}^{(α}^{_{\tilde{p}}}⁾(i) may be defined by M_{sc}^{RS}=N_{seq}^{PUCCH}.

Resources used for the transmission of the PUCCH formats 2/2a/2b are identified by a resource index (n_{PUCCH}^{(2,\tilde{p})}) from a cyclic shift (α_{\tilde{p}}(nₛ,l)) determined according to Equation 15.

α_{\tilde{p}}(nₛ,l)=2π·n_{cs}^{(\acute{p})}(nₛ,l)/N_{sc}^{RB} [Equation 15]

The PUCCH formats 2a and 2b are supported with respect to only a normal cyclic prefix (CP). Bit(s) (b(20), . . . ,b(Mbit−1)) are modulated as described in Table 23. As a result, a single modulation symbol (d(10)) used for the generation of a reference signal for the PUCCH formats 2a and 2b is determined as described in Table 23.

TABLE 23

| PUCCH format | b(20), . . . , b(M_{bit} − 1) | d(10) |
|---|---|---|
| 2a | 0 | 1 |
| | 1 | −1 |
| 2b | 00 | 1 |
| | 01 | −j |
| | 10 | j |
| | 11 | −1 |

PUCCH Format 3

In the case of the PUCCH format 3, blocks (b(0), . . . ,b(Mbit−1)) of bits need to be scrambled as a UE-specific scrambling sequence according to Equation 16. As a result, the blocks of the bits become the blocks (\tilde{b}(0), . . . , \tilde{b}(M_{bit}−1) of the scrambled bits.

\tilde{b}(i)=(b(i)+c(i))mod 2 [Equation 16]

In this case, c(i) means a scrambling sequence, and a scrambling sequence generator is initialized by an initial value (cᵢₙᵢₜ=(└nₛ/2┘+1)·(2N_{ID}^{cell}+1)·2¹⁶+n_{RNTI}) at the start part of each subframe in which nRNTI is a C-RNTI. The blocks (\tilde{b}(0), . . . , \tilde{b}(M_{bit} −1)) of scrambled bits need to be subjected to QPSK modulation. As a result, the blocks of the scrambled bits become blocks (d(0), . . . , d(Msymb−1)) of modulation symbols of a complex value.

Complex value symbols (d(0), . . . , d(Msymb−1)) are block-wise spread as orthogonal sequences (wₙ_{_{oc,0}}_{^{(\tilde{p})}}(i) and wₙ_{_{oc,1}}_{^{(\tilde{p})}}(i)). As a result, N_{SF,0}^{PUCCH}+N_{SF,1}^{PUCCH} sets of values of N_{sc}^{RB} are determined according to Equation 17.

$${y}_{n}^{( \tilde{p} )} ( i ) = \{ \begin{matrix}{w}_{{n}_{oc , 0}^{( \tilde{p} )}} ( \overline{n} ) \cdot {e}^{j π ⌊ {n}_{cs}^{cell} ( {n}_{s} , l ) / 64 ⌋ / 2} \cdot d ( i ) & n < {N}_{SF , 0}^{PUCCH} \\ {w}_{{n}_{oc , 1}^{( \tilde{p} )}} ( \overline{n} ) \cdot {e}^{j π ⌊ {n}_{cs}^{cell} ( {n}_{s} , l ) / 64 ⌋ / 2} \cdot d ( {N}_{sc}^{RB} + i ) & otherwise \end{matrix} \\ \overline{n} = n mod {N}_{SF , 0}^{PUCCH} \\ n = 0 , … , {N}_{SF , 0}^{PUCCH} + {N}_{SF , 1}^{PUCCH} - 1 \\ i = 0 , 1 , … , {N}_{sc}^{RB} - 1 \qquad [ Equation 17 ]$$

In this case, N_{SF,0}^{PUCCH}=N_{SF,1}^{PUCCH}=5 is used for the two slots of a subframe using the normal PUCCH format 3, and N_{SF,0}^{PUCCH}=5 is used for the first slot of a subframe using a shortened PUCCH format 3, and N_{SF,1}^{PUCCH}=4 is used for the second slot thereof. Furthermore, the orthogonal sequences (wₙ_{_{oc,0}}_{^{(\tilde{p})}}(i) and wₙ_{_{oc,1}}_{^{(\tilde{p})}}(i)) are given by Table 24.

TABLE 24

| | |
|---|---|
| | Orthogonal sequence |
| Sequence | [wₙ_{_{oc}} (0) . . . wₙ_{_{oc}} (N_{SF}^{PUCCH} − 1) |

| index n_{oc} | N_{SF}^{PUCCH} = 5 | N_{SF}^{PUCCH} = 4 |
|---|---|---|
| 0 | [1 1 1 1 1] | [+1 +1 +1 +1] |
| 1 | [1 e^{j2π/5} e^{j4π/5} e^{j6π/5} e^{j8π/5}] | [+1 −1 +1 −1] |
| 2 | [1 e^{j4π/5} e^{j8π/5} e^{j2π/5} e^{j6π/5}] | [+1 +1 −1 −1] |
| 3 | [1 e^{j6π/5} e^{j2π/5} e^{j8π/5} e^{j4π/5}] | [+1 −1 −1 +1] |
| 4 | [1 e^{j8π/5} e^{j6π/5} e^{j4π/5} e^{j2π/5}] | — |

Resources used for the transmission of the PUCCH formats 2/2a/2b are identified by a resource index (n_{PUCCH}^{(2,\tilde{p})}) from quantities n_{oc,0}^{(\tilde{p})} and n_{oc,1}^{(\tilde{p})} determined according to Equation 18.

$${n}_{oc , 0}^{( \tilde{p} )} = {n}_{PUCCH}^{( 3 , \tilde{p} )} mod {N}_{SF , 1}^{PUCCH} \\ {n}_{oc , 1}^{( \tilde{p} )} = \{ \begin{matrix}( 3 {n}_{oc , 0}^{( \tilde{p} )} ) mod {N}_{SF , 1}^{PUCCH} & if {N}_{SF , 1}^{PUCCH} = 5 \\ {n}_{oc , 0}^{( \tilde{p} )} mod {N}_{SF , 1}^{PUCCH} & otherwise \end{matrix} \qquad [ Equation 18 ]$$

Mapping of Physical Resources to PUCCH Formats

The symbol block (z^{(\tilde{p})}(i)) of a complex value needs to be multiplied by an amplitude scaling coefficient (β_{PUCCH}) in order to be matched with transmit power PPUCCH and to be mapped to a sequence starting from z^{(\tilde{p})} (0) with respect to resource elements (REs). A PUCCH uses one resource block in each of the two slots of a subframe. Within a physical resource block used for transmission, the mapping of z^{(\tilde{p})} (i) to a resource element (k,l) on the antenna port (P) and the mapping of a resource element not used for the transmission of a reference signal start from the first slot of a subframe and increase in order of a slot number.

A physical resource block used for PUCCH transmission in a slot ns is the same as Equation 19.

$${n}_{PRB} = \{ \begin{matrix}⌊ \frac{m}{2} ⌋ & if ( m + {n}_{s} mod 2 ) mod 2 = 0 \\ {N}_{RB}^{UL} - 1 - ⌊ \frac{m}{2} ⌋ & if ( m + {n}_{s} mod 2 ) mod 2 = 1\end{matrix} \qquad [ Equation 19 ]$$

In this case, the value of m is different depending on a form of a PUCCH format.

In the case of the PUCCH formats 1, 1a, and 1b, m is the same as Equation 20.

$$m = \{ \begin{matrix}{N}_{RB}^{( 2 )} & if {n}_{PUCCH}^{( 1 , \tilde{p} )} < c \cdot {N}_{cs}^{( 1 )} / {Δ}_{shift}^{PUCCH} \\ ⌊ \frac{{n}_{PUCCH}^{( 1 , \tilde{p} )} - c \cdot {N}_{cs}^{( 1 )} / {Δ}_{shift}^{PUCCH}}{c \cdot {N}_{sc}^{RB} / {Δ}_{shift}^{PUCCH}} ⌋ + {N}_{RB}^{( 2 )} + ⌈ \frac{{n}_{cs}^{( 1 )}}{8} ⌉ & otherwise \end{matrix} \\ c = \{ \begin{matrix}3 & normal cyclic prefix \\ 2 & extended cyclic prefix\end{matrix} \qquad [ Equation 20 ]$$

In the case of the PUCCH formats 2, 2a, and 2b, m is the same as Equation 21.

m=└n_{PUCCH}^{(2,\tilde{p})}/N_{sc}^{RB}┘ [Equation 21]

In the case of the PUCCH format 3, m is the same as Equation 22.

m=└n_{PUCCH}^{(3,\tilde{p})}/N_{SF,0}^{PUCCH}┘ [Equation 22]

If a serving cell is configured, when a sounding reference signal and the PUCCH format 1, 1 a, 1 b or 3 are transmitted at the same time, a shortened PUCCH format needs to be used if the last SC-FDMA symbol in the second slot of a subframe is empty.

FIG. 19 illustrates an example of the mapping of modulation symbols to a PUCCH to which the present invention may be applied. FIG. 19 is merely for convenience of description and does not limit the scope of the present invention.

In FIG. 19, N_{RB}^{UL} indicates the number of resource blocks in the uplink, and 0, 1, . . . , N_{RB}^{UL}−1 means the number of physical resource blocks.

In a next-generation communication system, a scheme(s) for reducing latency that may occur when information is exchanged is taken into consideration. To this end, in order to reduce a transmission time interval (TTI) compared to legacy LTE, a structure supporting a short transmission time interval (short TTI, sTTI) is taken into consideration.

For example, TTI structures including 2, 3 or 7 orthogonal frequency division multiplexing (OFDM) symbols are taken into consideration compared to a case where the transmission time interval of legacy LTE includes 14 OFDM symbols.

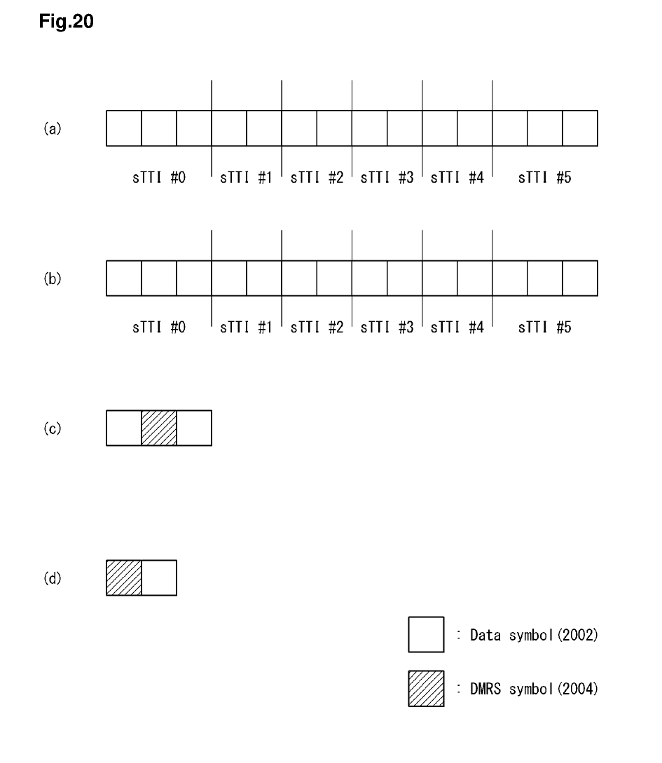

FIG. 20 illustrates examples of sTTI structures and PUCCH formats which may be taken into consideration under corresponding sTTI structures to which the present invention may be applied. FIG. 20 is only for convenience of description and does not limit the scope of the present invention. That is, PUCCH formats which may be taken into consideration under sTTI structures not shown in FIG. 20 and corresponding sTTI structures may be present.

Referring to FIG. 20, a case where multiple sTTIs are deployed according to the structure of 14 OFDM symbols, that is, a transmission time interval in legacy LTE, is assumed. In other words, the multiple sTTIs may be deployed according to one subframe unit of legacy LTE. In this case, the multiple sTTI may mean an sTTI including 2 OFDM symbols (hereinafter a 2-symbol sTTI) or an sTTI including 3 OFDM symbols (hereinafter a 3-symbol sTTI).

FIGS. 20(a) and 20(b) show structures in which four 2-symbol sTTIs and two 3-symbol sTTIs are deployed according to 14 OFDM symbols. In the case of FIG. 20(a), each of the first sTTI (sTTI #0) and the sixth sTTI (sTTI #5) includes a 3-symbol sTTI, and each of the second sTTI (sTTI #1) to the fifth sTTI (sTTI #4) includes a 2-symbol sTTI. In contrast, in the case of FIG. 20(b), each of the second sTTI and the sixth sTTI includes a 3-symbol sTTI, and each of the first sTTI and the third sTTI (sTTI #2) to the fifth sTTI includes a 2-symbol sTTI. sTTIs may be used for the transmission/reception of a signal based on a unit including 14 OFDM symbols of legacy LTE according to the structures of FIGS. 20(a) and 20(b).

A UE may transmit an uplink channel and/or an uplink signal to a base station and receive a downlink channel and/or a downlink signal from the base station using the aforementioned sTTI structure. Furthermore, in the case of communication between UEs (e.g., sidelink communication), an sTTI structure may be used for the transmission/reception of a sidelink channel and/or a sidelink signal.

In a next-generation communication system supporting an sTTI, if the sTTI structures shown in FIGS. 20(a) and 20(b) are used for the uplink transmission of a UE, a channel information feedback (or reporting) method of transmitting channel information about a downlink channel in the uplink may be taken into consideration.

The present invention proposes a channel feedback method in which a next-generation communication system supporting an sTTI is taken into consideration.

To this end, a PUCCH structure (i.e., according to the number of symbols (or length) configuring an sTTI) for each sTTI may be defined.

For example, FIG. 20(c) illustrates a PUCCH format available in a 3-symbol sTTI. In this case, the corresponding PUCCH format may include two data symbols 2002 (i.e., symbols for transmitting data) and one demodulation reference signal (DMRS) symbol 2004 (i.e., a symbol for transmitting a DMRS). For another example, FIG. 20(d) illustrates a PUCCH format available in a 2-symbol sTTI. In this case, the corresponding PUCCH format may include one data symbol 2002 and one DMRS symbol 2004.

In this case, the positions of the data symbol 2002 and DMRS symbol 2004 configuring each PUCCH format may be changed. For example, in the case of a 3-symbol sTTI, unlike in FIG. 20(c), the DMRS symbol 2004 may be located in the first symbol or the third symbol.

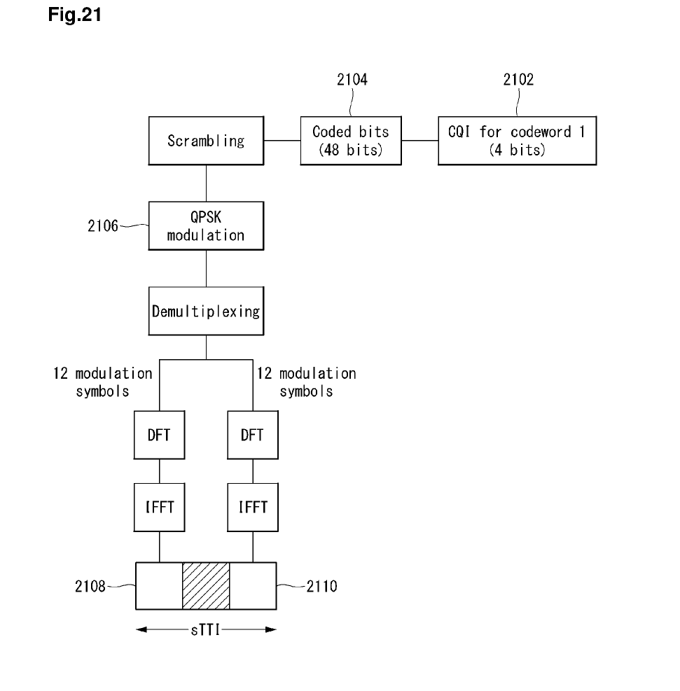

In this case, the data symbol 2002 may be used to transmit ACK/NACK, a scheduling request (SR), uplink control information (UCI), channel state information (CSI) (e.g., a channel quality indicator (CQI), a precoding matrix indicator (PMI), a rank indicator (RI)), uplink data, etc. Furthermore, the DMRS symbol 2004 may be used for channel estimation and the demodulation of a corresponding PUCCH. More specifically, a method of transmitting CSI using the data symbol 2002 may be represented as in FIG. 21.

FIG. 21 illustrates an example of a method of transmitting CSI in an sTTI structure to which the present invention may be applied. FIG. 21 is only for convenience of description and does not limit the scope of the present invention.

Referring to FIG. 21, a case where a UE transmits a CQI including a codeword of 4 bits to a base station using a PUCCH format having the structure of FIG. 20(c), that is, a 3-symbol sTTI is assumed.

In S2102 step, a CQI for a corresponding downlink channel is represented as a codeword of 4 bits. Thereafter, in S2104 step, the codeword of 4 bits is converted into coded bits of 48 bits according to channel coding. In this case, the size (e.g., 48) of the coded bits may be changed according to the number of symbols used for CQI transmission. For example, if a UE transmits a CQI including a codeword of 4 bits to a base station using the PUCCH format of a 2-symbol sTTI (e.g., FIG. 20(d)), the codeword of 4 bits may be converted into coded bits of 24 bits.

The coded bits of 48 bits are scrambled by a scrambling sequence. In S2106 step, quadrature phase shift keying (QPSK) modulation is applied to the scrambled bits. Accordingly, the scrambled bits are converted into modulation symbols of 24 bits.

The converted modulation symbols of 24 bits are classified into a first group and a second group, each one including 12 modulation symbols, through demultiplexing. In this case, the first group is mapped to a data symbol 2108 through DFT and IFFT processes and transmitted to the base station. The second group is mapped to a data symbol 2110 through DFT and IFFT processes and transmitted to the base station.

In various embodiments of the present invention, the UE may transmit CSI information to the base station through the PUCCH format of an sTTI including a specific number of symbols based on the aforementioned procedures. That is, the aforementioned procedures may be applied to PUCCH format transmission (e.g., 2-symbol sTTI, 7-symbol sTTI) for an sTTI including various numbers of symbols in addition to a 3-symbol sTTI.

Furthermore, in relation to the aforementioned procedures, in the following specification, what a UE transmits CSI using (or through) a specific number of symbol sTTIs may mean that the UE transmits the CSI using a PUCCH format suitable for a specific number of symbol sTTIs.

In this case, a system supporting an sTTI configured by taking into consideration short latency, such as that described above, is limited to one transmission unit, that is, the amount of data that may be transmitted in one sTTI. Accordingly, compared to the existing legacy LTE, schemes for reducing the number of bits of CSI transmitted in one TTI unit may be taken into consideration.

Channel state information taken into consideration in legacy LTE includes a CQI, a PMI and an RI. For convenience of description, in this specification, a CSI feedback method is described based on only an example of a CQI. In other words, methods described in this specification may be applied to the feedback of a PMI and/or an RI in addition to a CQI.

The following embodiments of the present invention have been classified for convenience of description, and one or more embodiments may be applied at the same time or regardless of the sequence for CSI transmission in a wireless communication system supporting an sTTI.

### CSI Transmission Method of 2-Step Method (First Embodiment)

In a next-generation wireless communication system supporting an sTTI, the number of bits transmitted in one sTTI can be reduced through a method of dividing a value transmitted with respect to each piece of channel state information into two steps and transmitting them. That is, a UE may transmit (or feed back) channel state information to a base station using two STTIs. The two STTIs may mean consecutive sTTIs or non-consecutive sTTIs.

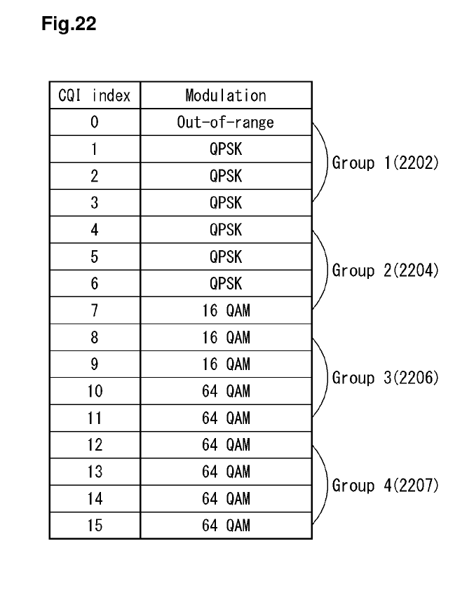

In order to reduce the number of bits transmitted in one sTTI, a UE may transmit a CQI to a base station through 2-step transmission using a grouped CQI index as in FIG. 22.

FIG. 22 illustrates the indices of CQIs transmitted in 4 bits to which the present invention may be applied. FIG. 22 is only for convenience of description and does not limit the scope of the present invention.

In FIG. 22, a case where a CQI transmitted by a UE is represented as 16 CQI indices and the CQI index is represented as information of 4 bits is assumed. In this case, the 16 CQI indices may indicate different CQI values depending on a modulation method (e.g., QPSK, 16 quadrature amplitude modulation (QAM), 64 QAM), a code rate, efficiency, etc.

For the two-step transmission method, the 16 CQI indices, that is, CQls of 16 states, may be grouped into 4. That is, a CQI index 0 to a CQI index 3 may be included in a first group (Group 1) 2202, a CQI index 4 to a CQI index 7 may be included in a second group (Group 2) 2204, a CQI index 8 to a CQI index 11 may be included in a third group (Group 3) 2206, and a CQI index 12 to a CQI index 15 may be included in a fourth group (Group 4) 2208. In this case, the indices of the groups may be represented as 2-bit information “00 (first group)”, “01 (second group)”, “10 (third group)”, and “11 (fourth group).” Furthermore, indices indicating CQIs included in each group may be represented as 2-bit information “00 (first CQI)”, “01 (second CQI)”, “10 (third CQI)”, and “11 (fourth CQI).”

In this case, the indices of each group and/or indices for CQIs included in each group may be previously defined on a system. Alternatively, a base station may transmit information about the indices of each group and/or indices for CQIs included in each group to a UE through higher layer signaling and/or physical layer signaling.

In this case, the UE may transmit (or feed back) information (i.e., group index) indicating a specific group of the four groups to the base station in the first sTTI (or TTI). Thereafter, the UE may transmit information (i.e., CQI index) indicating a specific CQI index included in the specific group in a second sTTI to a base station. For example, what the UE transmits “11” in the first sTTI and transmits “01” in the second sTTI may mean that the UE notifies the base station of the CQI index 13 shown in FIG. 22.

As described above, the UE can transmit 4-bit CQI information to the base station by dividing and transmitting two pieces of 2-bit information in two STTIs. If 4-bit information is divided into 2 bits twice and transmitted, there is an advantage in that a code rate for one sTTI is reduced.

In this case, the method of dividing 4-bit information into two pieces of 2-bit information and transmitting them based on FIG. 22 is only one example. The 4-bit information may be divided into 1-bit information and 3-bit information and transmitted. In this case, if a group index corresponds to 1-bit information, a CQI index indicating a CQI within a group may include 3-bit information. In contrast, if a group index corresponds to 3-bit information, a CQI index indicating a CQI within a group may include 1-bit information. Furthermore, if information about a CQI index includes information of a different number of bits not 4-bit information, a group index and a CQI index indicating a CQI within a group may include combinations of various numbers of bits.

Furthermore, a UE may transmit (or feed back) group index information indicating a specific group to a base station using a long TTI. In other words, the UE may feed a baseline CQI (e.g., wideband CQI) value back through a long TTI, and may feed a CQI for an sTTI using a group to which the value belongs. This may be similar to a method of feeding an RI back in a long term and feeding another CQI and/or PMI back based on a basic RI value. Alternatively, a method of setting the value of the baseline CQI as a median and dynamically (or adaptively) using M values on both sides may be taken into consideration.

Furthermore, a UE may transmit a CQI represented as a small number of bits with respect to only some region of a CQI table (e.g., FIG. 22). For example, a method of transmitting a CQI in 3 bits, but designating a starting point on the CQI table (or the starting point of a specific region) through higher layer signaling may be taken into consideration. Specifically, if the UE transmits a CQI in 3 bits in the state in which the starting point has been designated as the location of the CQI index 8 of FIG. 22 through higher layer signaling, the 3-bit CQI information may mean information corresponding to the CQI index 8 to CQI index 15 of FIG. 22.

Alternatively, for another example, a UE may transmit an index indicating the starting point of a specific range (or information about the starting point) for CQI indices in a first sTTI, and may transmit information indicating a specific CQI index included in the specific range in a second sTTI. In other words, after the UE transmits information indicating the starting point of a range including multiple CQIs to a base station (1 step), the UE may transmit offset information for indicating a specific CQI included in a corresponding area to the base station.

### CSI Transmission Method Through sTTI in System Supporting MIMO Transmission (Second Embodiment)

In a system supporting multiple input multiple output (MIMO) transmission, a UE performing MIMO transmission may report CSI (e.g., CQI) about a maximum of 2 codewords to a base station.

In the case of legacy LTE, a UE may configure a CQI for a first codeword (codeword 1) using 4 bits, may configure a CQI for a second codeword (codeword 2) using 3 bits indicating a differential value, and may report a total of 7 bits to a base station. In this case, the differential value may mean information indicating only a value that varies in different information (e.g., the second codeword) based on specific information (e.g., the first codeword). In this case, the value of the specific information may be denoted as a reference value or an absolute value.

In contrast, in a system supporting an sTTI, in order to reduce the number of bits transmitted in one sTTI, a method of performing a configuration so that a UE transmits a CQI for a first codeword and a CQI for a second codeword through different transmission units, that is, different sTTIs, may be taken into consideration.

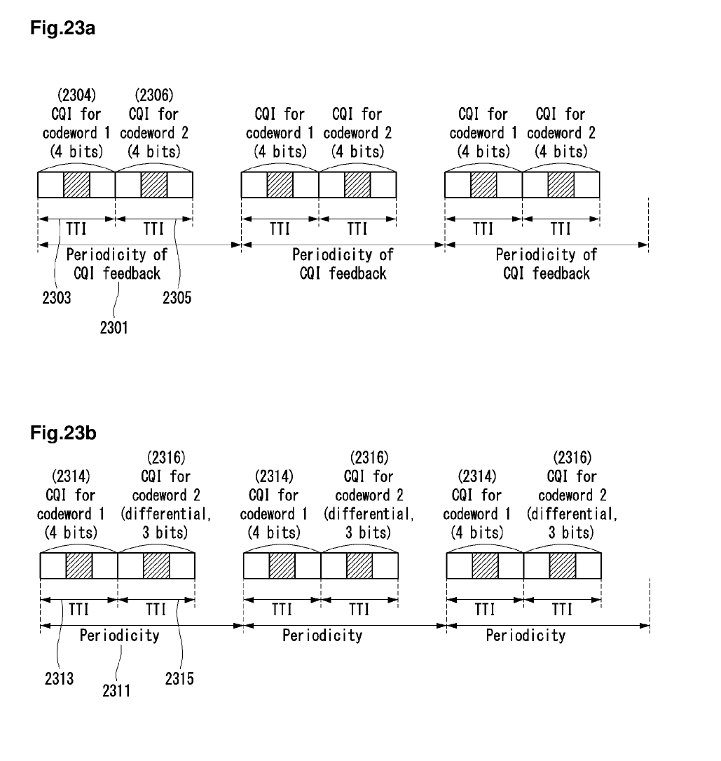

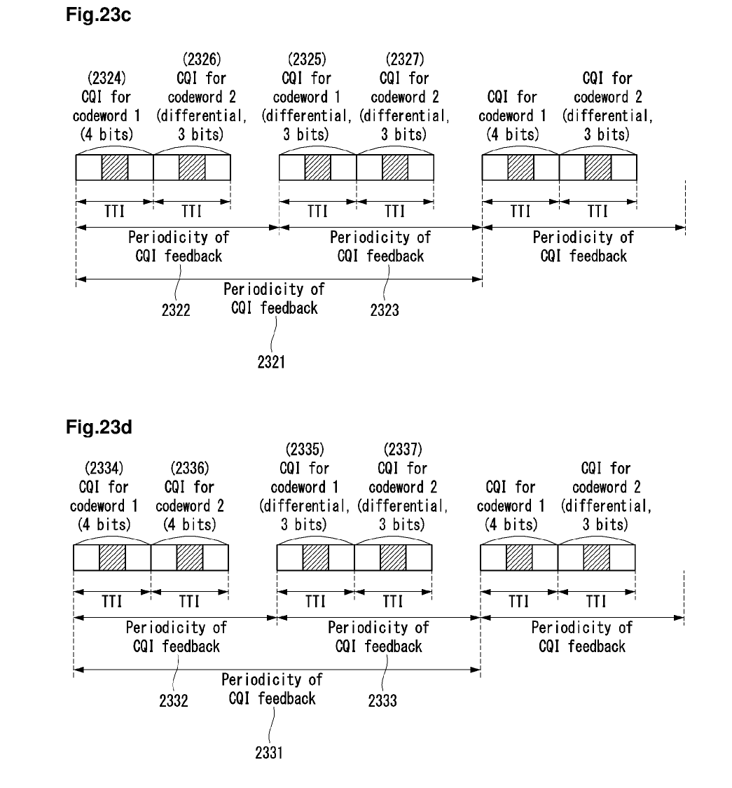

FIGS. 23a to 23d illustrate examples of a method for a user equipment to transmit a CQI through an sTTI in a system supporting MIMO transmission to which the present invention may be applied. FIGS. 23a to 23d are only for convenience of description and do not limit the scope of the present invention.

Referring to FIGS. 23a to 23d, a case where a UE divides and feeds (or transmits) a CQI for a first codeword and a CQI for a second codeword back in consecutive sTTIs according to a specific periodicity is assumed. In the case of FIGS. 23a to 23d, the UE feeds the CQI using a 3-symbol sTTI.

In this case, as in FIG. 23a, a UE does not use a differential value (e.g., 3 bits) for codewords, but may feed an absolute value (e.g., 4 bits) for each codeword back within the specific periodicity. That is, according to a specific periodicity 2301, the UE may feed a CQI (4 bits) 2304 for a first codeword back in a first sTTI (i.e., first sTTI) 2303, and may feed a CQI (4 bits) 2306 for a second codeword back in a second sTTI 2305 (i.e., an sTTI consecutive to the first sTTI).

Alternatively, as in FIG. 23b, a UE may feed a CQI for a second codeword value back within a specific periodicity using a differential value with respect to a first codeword. That is, according to a specific periodicity 2311, a UE may feed a CQI (4 bits) 2314 for a first codeword back in a first sTTI 2313, and may feed a CQI (3 bits) 2316 for a second codeword configured as a differential value with respect to a CQI for a first codeword back in a second sTTI 2315. In this case, there is an advantage in that the number of bits transmitted in the second sTTI is reduced from 4 bits to 3 bits compared to FIG. 23a.

Alternatively, in order to further reduce the number of transmitted bits, as in FIG. 23c, a UE may configure a CQI for a first codeword value as a differential value in some interval and feed it back. That is, unlike in the case of FIG. 23b (a case where only a CQI for a second codeword is configured as a differential value), a method of separately configuring the periodicity in which a CQI for a first codeword is fed back as a reference value (i.e., the periodicity in which an absolute value is fed back) and feeding the CQI for the first codeword value back as a differential value within the corresponding periodicity may be taken into consideration.

For example, a case where a UE performs twice CQI feedback procedures (i.e., perform CQI feedback according to a first periodicity 2322 and a second periodicity 2323) within a periodicity 2321 in which a CQI for a first codeword is fed back as an absolute value may be taken into consideration. In this case, the UE may feed a CQI (4 bits, an absolute value) 2324 for a first codeword and a CQI (3 bits, a differential value) 2326 for a second codeword configured as a differential value with respect to the CQI for the first codeword back to a base station in the first periodicity 2322. Thereafter, the UE may feed a CQI 2325 configured as a differential value for the first codeword (i.e., a CQI for a first codeword configured as a differential value different from an absolute value 2324) and a CQI (3 bits, a differential value) 2327 for a second codeword configured as a differential value with respect to the CQI for the first codeword back in the second periodicity 2323.

In this case, the absolute value may be fixed to one CQI for the first codeword transmitted in the first the periodicity 2321 or may be configured based on each codeword first transmitted within the periodicity 2321. Furthermore, the periodicity 2321 may be predefined on a system or a base station may transmit information about the periodicity 2321 through higher layer signaling and/or physical layer signaling to the UE.

Alternatively, as in FIG. 23d, a UE may configure values first transmitted in a specific periodicity in which an absolute value of a CQI is transmitted as absolute values with respect to a first codeword and a second codeword and feed them back.

In other words, unlike in FIG. 23c, the UE may feed a CQI (4 bits, an absolute value) 2334 for a first codeword and a CQI (4 bits, an absolute value) 2336 for a second codeword back to a base station in the first periodicity 2332 of a periodicity 2331. Thereafter, the UE may feed a CQI 2335 configured as a differential value for the first codeword and a CQI 2337 configured as a differential value for the second codeword back to the base station in a second periodicity 2333. In this case, the CQI 2335 configured as the differential value for the first codeword may mean a CQI for the first codeword configured as a differential value with respect to the absolute value 2334, the CQI 2337 configured as the differential value for the second codeword may mean a CQI for the second codeword configured as the differential value with respect to the absolute value 2336.

As described above, in a system supporting MIMO transmission, a UE may report a CQI to a base station using one of the methods of FIGS. 23a to 23d based on the number of bits to be transmitted in one sTTI and/or a specific periodicity (e.g., a periodicity in which a CQI for a specific codeword is fed back as a reference value).

### Method of Configuring sTTI to be Used for Transmission Based on CSI Size (Third Embodiment)

Furthermore, CSI (e.g., CQI) values having different sizes may be configured to be transmitted in sTTIs of different lengths. That is, a CQI value having a different size may be fed back using an sTTI of a different length. For example, if a CQI value is configured as an absolute value (or reference value) and transmitted (e.g., a CQI configured as 4 bits in FIGS. 23a to 23d) and if a CQI value is configured as a differential value and transmitted (e.g., a CQI configured as 3 bits in FIGS. 23a to 23d), sTTIs of different lengths may be configured.

More specifically, if a UE divides and transmits each codeword in two STTIs with respect to MIMO transmission, the UE may feed a CQI for a first codeword back as an absolute value or reference value and may feed a CQI for a second codeword as a differential value (i.e., in the case of FIG. 23b). In this case, an sTTI in which an absolute value is transmitted may be differently configured depending on the position of an sTTI in which a CQI is transmitted.

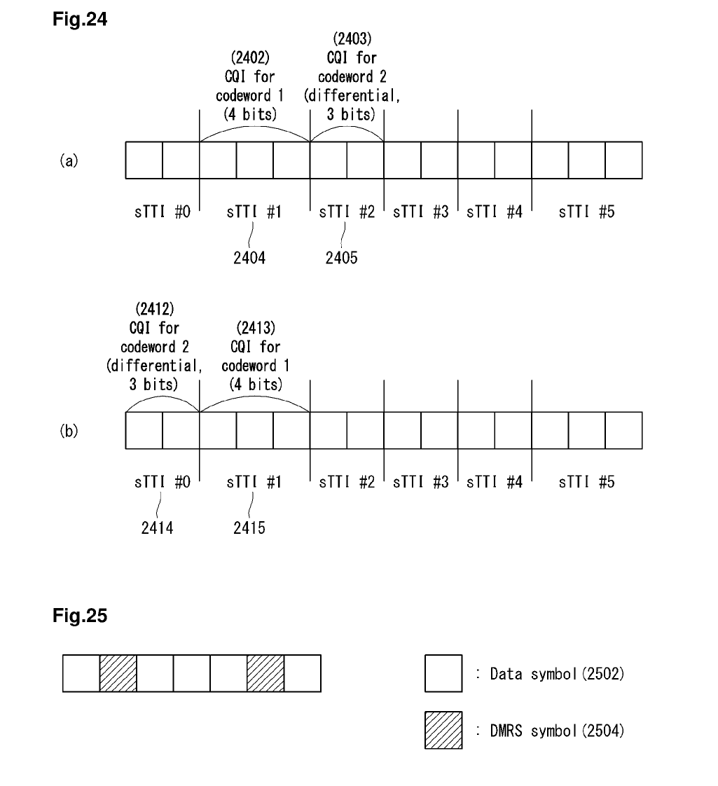

FIG. 24 illustrates an example of a method for a user equipment to transmit a CQI for two codewords to which the present invention may be applied. FIG. 24 is only for convenience of description and does not limit the scope of the present invention.

Referring to FIG. 24, a case where a UE feeds (or reports) a CQI for two codewords back, and feeds a CQI for one codeword (e.g., a first codeword) as an absolute value and a CQI for the other codeword (e.g., a second codeword) as a differential value through the sTTI structure corresponding to FIG. 20(b) (structure in which the number of symbols configuring an sTTI for each sTTI is differently 2 or 3) is assumed.

In this case, a reference value may be configured to be transmitted in a 3-symbol sTTI and the differential value may be configured to be transmitted in a 2-symbol sTTI. That is, as in FIG. 24(a), after a UE transmits a CQI (4 bits, an absolute value) 2402 for a first codeword in a 3-symbol sTTI 2404, the UE may transmit a CQI (3 bits, a differential value) 2403 for a second codeword in a 2-symbol sTTI 2405 consecutive to the 3-symbol sTTI. Alternatively, as in FIG. 24(b), after a UE transmits a CQI (3 bits a differential value) 2412 for a second codeword in a 2-symbol sTTI 2414, the UE may transmit a CQI (4 bits, an absolute value) 2413 for a first codeword in a 3-symbol sTTI 2415 consecutive to the 2-symbol sTTI.

The configuration may be implicitly determined depending on the length of an sTTI to which CQI feedback (or CQI transmission) has been allocated. Alternatively, a base station may transmit information about the configuration to the UE through higher layer signaling and/or physical layer signaling.

Furthermore, if CQI values (i.e., CQI indices) defined in a system are grouped and information about group indices and information about a CQI index indicating a specific CQI within a group are divided and transmitted in two STTIs (i.e., the first embodiment of the present invention), the method used in FIG. 24 may be applied. In other words, when the number of bits for a group index or a CQI index indicating a specific CQI within a group is differently configured, the UE may be configured to transmit information corresponding to a greater number of bits (e.g., 3 bits) among the two in an sTTI having a long length (e.g., 3-symbol sTTI) and to transmit information corresponding to a smaller number of bits (e.g., 2 bits) among the two in a short sTTI (e.g., 2-symbol sTTI).

There is an advantage in that a code rate for an sTTI can be maintained or reduced because a UE feeds a value having a greater number of bits (e.g., an absolute value) back to a base station through an sTTI of a longer length according to the aforementioned method.

The aforementioned method may be applied to different types of CSI and/or uplink control information (UCI). For example, the length of an sTTI may be differently configured based on a value fed back among a CQI, a PMI, and/or an RI. More specifically, the CQI may be configured to be fed back through a 3-symbol sTTI, and the RI may be configured to be fed back through a 2-symbol sTTI.

Furthermore, in relation to transmit power of a UE, the transmit power of the UE may be configured to increase as the number of transmitted CSI bits increases, that is, as a CSI size increases. In this case, when the transmit power of the UE reaches a maximum limit value, the UE may report the state in which the transmit power of the UE has reached the maximum limit value (i.e., the state in which CSI can be no longer transmitted by increasing the transmit power) to a base station using a power headroom report (PHR). When the base station receives reporting on the PHR from the UE, the base station may allocate the sTTI of a proper length (or including a proper number of symbols) based on the PHR value or may control the number of bits of CSI to be transmitted in one sTTI. To this end, the base station may configure one or more operating modes which may change based on a PHR value. In this case, a criterion for changing the one or more operating mode may include a signal to interference plus noise ratio (SINR) range and/or coverage of a UE in addition to an PHR value. In this case, the base station may notify the UE of such a configuration through higher layer signaling and/or physical layer signaling.

Furthermore, as described above, a method of variably configuring the number of bits of supportable (or transmittable) CSI depending on the length of an sTTI may be taken into consideration.

FIG. 25 illustrates an example of a 7-symbol sTTI structure for transmitting CSI to which the present invention may be applied. FIG. 25 is only for convenience of description and does not limit the scope of the present invention.

Referring to FIG. 25, a case where an sTTI includes 7 OFDM symbols corresponding to 1 slot of legacy LTE is assumed. In this case, a 7-symbol sTTI includes two DMRS symbols 2504 and five data symbols 2502.

In this case, the number of transmittable CSI bits may be configured as 5 bits or 6 bits. In this case, after corresponding CSI is converted into 10 bits by applying channel coding, 5 modulation symbols may be generated by applying QPSK modulation to the converted 10 bits. Accordingly, the 5 modulation symbols may be divided into 5 symbols (i.e., 5 data symbols 2502) and transmitted. The aforementioned method may be applied to an sTTI including a different number of symbols in addition to the 7-symbol sTTI of FIG. 25.

Multiplexing Method Between Different UEs for CSI Transmission (Fourth Embodiment)

Furthermore, since multiple UEs may transmit (or feed) CSI back to a base station, a multiplexing method for CSI feedback between different UEs may need to be taken into consideration. For example, in the case of a 2-symbol sTTI, the number of transmittable CSI bits may be configured as 4 bits. The CSI bits of 4 bits may be converted into coded bits of 12 bits by applying channel coding. 6 modulation symbols generated by applying QPSK modulation to the converted coded bits may be mapped to 6 resource elements (REs). Accordingly, the CSI bits of 4 bits are resultantly mapped to the 6 REs. Accordingly, the CSI bits of 4 bits may be repeatedly mapped to one resource block (RB) twice.

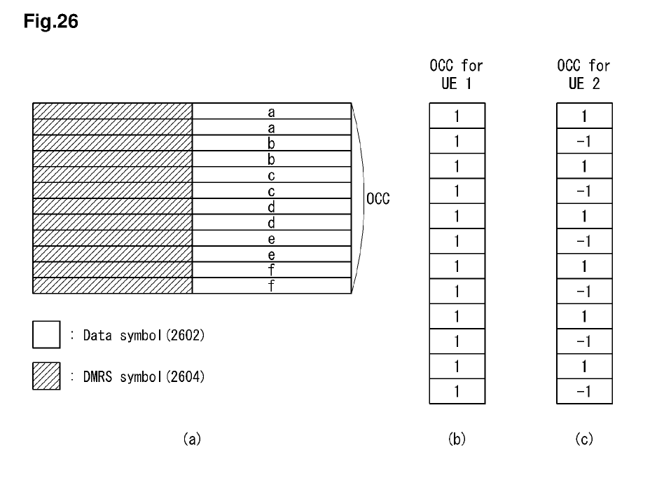

In this case, if the 6 modulation symbols are represented as “a”, “b”, “c”, “d”, “e”, and “f”, as in FIG. 26(a), each of the modulation symbols may be repeated twice and mapped to a total of 12 REs.

FIG. 26 illustrates an example of multiplexing between user equipments for CSI transmission to which the present invention may be applied. FIG. 26 is only for convenience of description and does not limit the scope of the present invention.

Referring to FIG. 26, a case where two UEs feed CSI back to a base station and the CSI is converted into 6 modulation symbols through channel coding and QPSK modulation is assumed.

FIG. 26(a) illustrates an example in which symbols for CSI feedback have been mapped to 12 REs included in a data symbol 2602. In other words, each of the 6 modulation symbols “a”, “b”, “c”, “d”, “e”, and “f” for 4-bit CSI bits is repeated twice and mapped to 12 REs.

Since orthogonal cover code (OCC) is applied to two UEs with respect to the 12 Res, the two UEs may be multiplexed within 1 RB and may transmit CSI. In this case, since the number of repeated REs is 2, multiplexing between UEs may be configured because OCC is applied using an orthogonal sequence of a length 2, such as Table 25.

TABLE 25

| Sequence index | Orthogonal sequences |
|---|---|
| 0 | [1 1] |
| 1 | [1 −1] |

FIG. 26(b) illustrates OCC to which an orthogonal sequence [1 1] corresponding to the sequence index 0 of Table 25 has been applied to the first one of the two UEs. Furthermore, FIG. 26(c) illustrates OCC to which an orthogonal sequence [1-1] corresponding to the sequence index 1 of Table 25 has been applied to the second one of the two UEs.

In this case, the number of CSI bits, applied channel coding, and/or the number of REs repeated according to a modulation method may be configured in various manners. Multiplexing between UEs for CSI feedback may be performed because OCC using a sequence of a length corresponding to the number of repeated REs is applied. For example, for multiplexing between UEs for CSI feedback, when the number of repeated REs is 3, OCC using a discrete Fourier transform (DFT) sequence of length 3 may be applied. When the number of repeated REs is 5, OCC using a DFT sequence of length 5 may be applied. In this case, the aforementioned method (i.e., apply OCC to repeated REs) may be applied when the number of UEs to which multiplexing is applied is different. Furthermore, the aforementioned method may be applied through the repetition of a symbol unit when the size of an sTTI changes.

Furthermore, a reference signal (RS) between UEs may be identified based on a cyclic shift (CS) value of a DMRS, and thus multiplexing between UEs may be performed.

Furthermore, OCC for multiplexing between UEs for CSI feedback may be applied in an RB unit. For example, if CSI includes 2 bits, CSI bits of 2 bits may be converted into coded bits of 6 bits by applying channel coding. 3 modulation symbols generated by applying QPSK modulation on the converted coded bits may be mapped to 3 resource elements (REs).

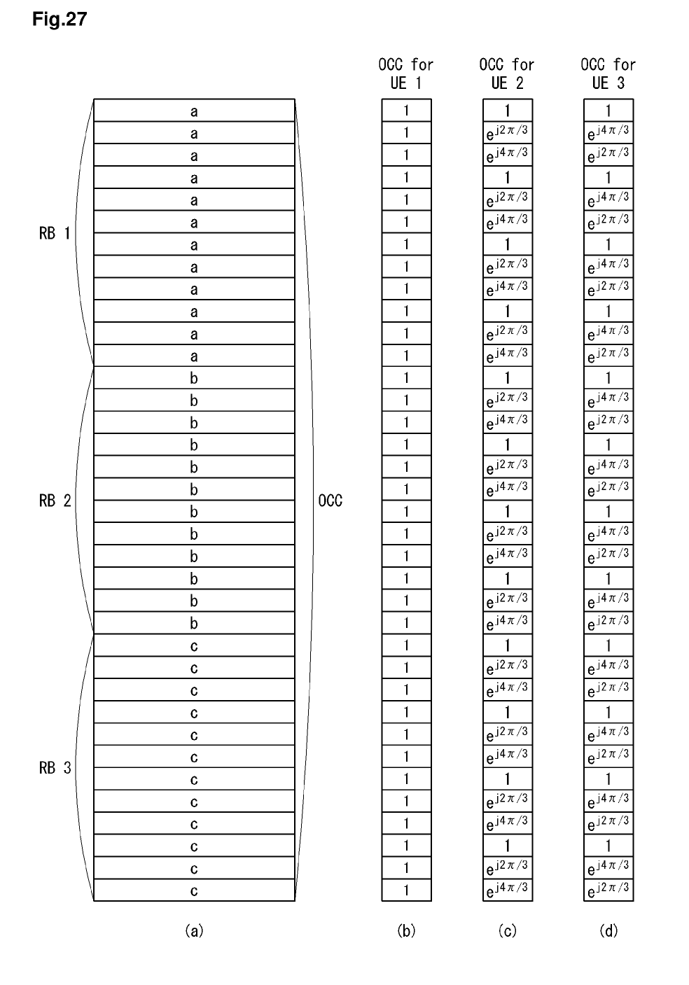

In this case, if the 3 modulation symbols are represented as “a”, “b”, and “c”, as in FIG. 27(a), each of the modulation symbols may be repeated in an RB unit and mapped to the 3 RBs.

FIG. 27 illustrates another example of multiplexing between user equipments for CSI transmission to which the present invention may be applied. FIG. 27 is only for convenience of description and does not limit the scope of the present invention.

Referring to FIG. 27, a case where three UEs transmits (or feeds back) CSI to a base station and the CSI is converted into 3 modulation symbols through channel coding and QPSK modulation is assumed.

FIG. 27(a) illustrates an example in which symbols for CSI feedback have been mapped to 3 RBs. In other words, each of 3 modulation symbols “a”, “b”, and “c” for the aforementioned 2 bits CSI bits is repeated in an RB unit and mapped to 3 RBs.

As orthogonal cover code (OCC) is applied to the three UEs with respect to the 3 RBs, the three UEs may be multiplexed and transmit CSI. In this case, since the number of REs, that is, the number of modulation symbols is 3, multiplexing between UEs can be configured because OCC is applied using a DFT sequence of length 3, such as Table 26.

TABLE 26

| Sequence index | Orthogonal sequences |
|---|---|
| 0 | [1 1 1] |
| 1 | [1 e^{j2π/3} e^{j4π/3}] |
| 2 | [1 e^{j4π/3} e^{j2π/3}] |

FIG. 27(b) illustrates OCC to which an orthogonal sequence [1 1 1] corresponding to the sequence index 0 of Table 26 has been applied to the first UE of the three UEs. Furthermore, FIG. 27(c) illustrates OCC to which an orthogonal sequence [1 e^{j2π/3} e^{j4π/3}] corresponding to the sequence index 1 of Table 26 has been applied to the second UE of the three UEs. Furthermore, FIG. 27(d) illustrates OCC to which an orthogonal sequence [1 e^{j4π/3} e^{j2π/3}] corresponding to the sequence index 2 of Table 26 has been applied to the third UE of the three UEs.

In this case, the number of modulation symbols, that is, the number of REs, may be configured in various manner depending on the number of CSI bits, applied channel coding and/or a modulation method. As OCC using a sequence of a length corresponding to the number of REs is applied, multiplexing between UEs for CSI feedback may be performed.

### Method of Transmitting Different Uplink Control Information Along with CSI Transmission (Fifth Embodiment)

The aforementioned methods may be applied to a case where a UE transmits (or feeds back) CSI to a base station. In this case, as below, a method for a UE to feed CSI back to a base station and also to transmit different uplink control information (e.g., a scheduling request (SR) or ACK/NACK information) may be taken into consideration.

In one embodiment of the present invention, a UE may transmit CSI and a scheduling request (SR) to a base station together. In this case, the UE may implicitly transmit the SR through a cyclic shift (CS) value (i.e., a cyclic shift index (CS index)) of a sequence used for a DMRS.

For example, in an environment (i.e., if CSI is feed back in a 2-symbol sTTI), such as FIG. 26, for multiplexing between UEs, the CS of a DMRS sequence may be differently configured with respect to each UE. Accordingly, the DMRSs of UEs may be distinguished. In this case, an SR may be implicitly transmitted using the remaining CS index(indices) except a CS index(indices) used for multiplexing between UEs among a maximum of 12 CS indices available in 1 RB unit.

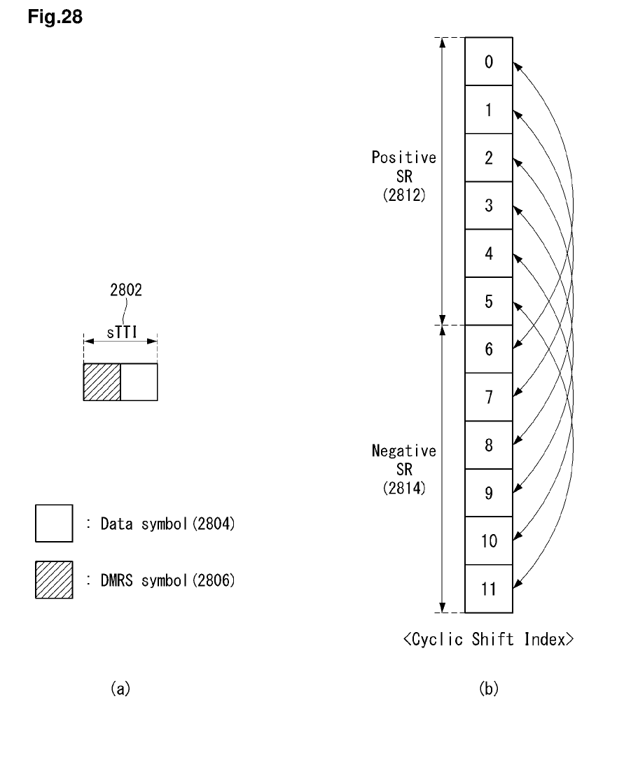

FIG. 28 illustrates an example of a CS index configuration in which a user equipment transmits CSI and an SR to a base station to which the present invention may be applied. FIG. 28 is only for convenience of description and does not limit the scope of the present invention.

Referring to FIG. 28(a), a case where a UE transmits an SR to a base station in a 2-symbol sTTI 2802 along with CSI feedback is assumed. In this case, the CSI feedback is performed through a data symbol 2804, and the transmission of the SR is performed through a DMRS symbol 2806 (i.e., through the CS index of a DMRS). In this case, a reference signal transmitted through the DMRS symbol 2806 may be used for channel estimation for CSI transmitted through the data symbol 2804.

Furthermore, referring to FIG. 28(b), in order to (implicitly) transmit an SR using a DMRS sequence, 12 CS indices may be divided into two regions (or two groups). For example, the 12 CS indices may be divided into a region 2812 (CS index 0 to CS index 5) corresponding to a positive SR and a region 2814 (CS index 6 to CS index 11) corresponding to a negative SR and configured. In this case, for multiplexing between UEs, a CS index pair (e.g., CS index 0-CS index 6, CS index 1-CS index 7 or CS index 3-CS index 9) may be assigned to each UE. That is, a CS index configuration, such as FIG. 28(b), may be used for the multiplexing of a maximum of six UEs.

Specifically, if a first UE and a second UE are multiplexed, the CS index pair (0, 6) may be assigned to the first UE and the CS index pair (3, 9) may be assigned to the second UE. In this case, if each UE attempts to transmit CSI and an SR to a base station at the same time, the UE may transmit a DMRS using the first CS index value (i.e., a CS index corresponding to a positive SR) of the CS indices of a CS index pair. In contrast, if each UE attempts to transmit only CSI to a base station, the UE may transmit a DMRS using the second CS index value (i.e., a CS index corresponding to a negative SR) of the CS indices of a CS index pair.

In this case, the base station may transmit information about a configuration related to the SR to the UE through higher layer signaling and/or physical layer signaling.

Furthermore, a UE may implicitly transmit an SR to a base station through the position of a resource in which CSI is transmitted (i.e., information about an RE to which CSI is mapped) not a CS index for the sequence of a DMRS. In this case, the base station may transmit configuration information related to the position of the resource in which the CSI is transmitted to the UE through higher layer signaling and/or physical layer signaling.

Furthermore, a UE may receive 1 bit allocated for an SR, and may transmit CSI to a base station by performing joint coding on the allocated 1 bit and a CSI value. In this case, a method of joint-coding the SR may be applied to a case where ACK/NACK (i.e., ACK/NACK information) is transmitted in addition to CSI transmission (or feedback).

Furthermore, in another embodiment of the present invention, a UE may transmit CSI and ACK/NACK information to a base station together. In this case, the UE may implicitly transmit the ACK/NACK information using the CS index of a sequence used for a DMRS.

For example, in an environment (i.e., a case where CSI is fed back in a 2-symbol sTTI), such as FIG. 26, for multiplexing between UEs, the CS of a DMRS sequence may be differently configured with respect to each UE. Accordingly, the DMRS of each UE may be identified.

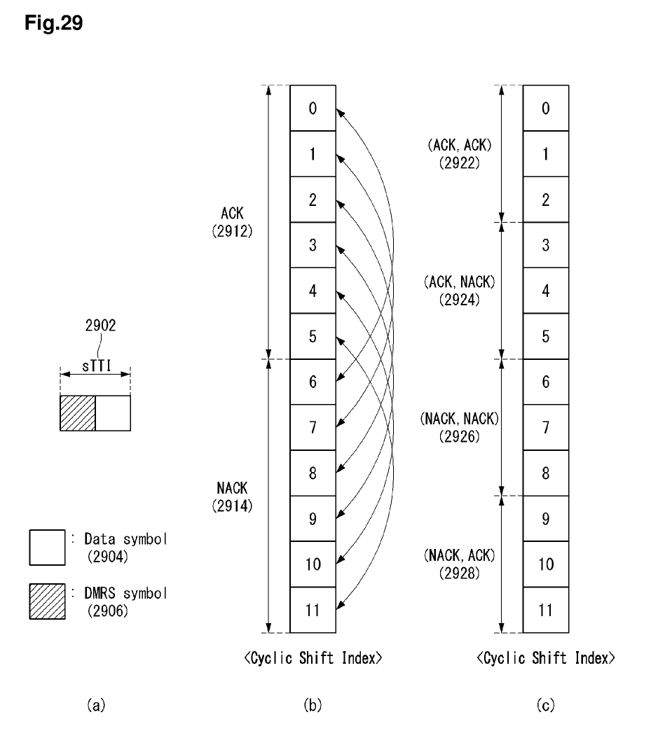

FIG. 29 illustrates an example of a CS index configuration in which a user equipment transmits CSI and ACK/NACK information to a base station to which the present invention may be applied. FIG. 29 is only for convenience of description and does not limit the scope of the present invention.

Referring to FIG. 29(a), a case where a UE transmits ACK/NACK information to a base station in a 2-symbol sTTI 2902 along with CSI feedback is assumed. In this case, the CSI feedback is performed through a data symbol 2904, and the transmission of the ACK/NACK information is performed through a DMRS symbol 2906 (i.e., through the CS index of a DMRS). In this case, a reference signal transmitted through the DMRS symbol 2906 may be used for channel estimation for CSI transmitted through the data symbol 2904.

If the ACK/NACK information is 1-bit ACK/NACK information, in order to (implicitly) transmit the ACK/NACK information using a DMRS sequence, 12 CS indices may be divided into two regions (or two groups) as in FIG. 29(b). For example, the 12 CS indices may include a region (CS index 0 to CS index 5) corresponding to ACK 2912 and a region (CS index 6 to CS index 11) corresponding to NACK 2914 and configured. In this case, for multiplexing between UEs, a CS index pair (e.g., CS index 0-CS index 6, CS index 3-CS index 9 or CS index 5-CS index 11) may be assigned to each UE. Accordingly, a CS index configuration such as FIG. 29(b) may be used for the multiplexing of a maximum of six UEs.

Specifically, if a first UE and a second UE are multiplexed, the CS index pair (0, 6) may be assigned to the first UE and the CS index pair (3, 9) may be assigned to the second UE. In this case, if each UE attempts to transmit CSI and ACK to a base station at the same time, the UE may transmit a DMRS using the first CS index value (i.e., a CS index corresponding to ACK) of the CS indices of a CS index pair. In contrast, if each UE attempts to transmit CSI and NACK to a base station at the same time, the UE may transmit a DMRS using the second CS index value (i.e., a CS index corresponding to NACK) of the CS indices of a CS index pair.

In contrast, if ACK/NACK information is 2-bit ACK/NACK information, a UE may transmit a DMRS using a CS index value corresponding to the region 2912 of FIG. 29(b) if both the 2-bit ACK/NACK information is ACK and using a CS index value corresponding to the region 2914 of FIG. 29(b) if any one of both the 2-bit ACK/NACK information is NACK through bundling.

Alternatively, as in FIG. 29(c), a UE may transmit a DMRS using CS index values in which 12 CS indices are divided into a region 2922 corresponding to (ACK ACK), a region 2924 corresponding to (ACK NACK), and a region 2926 corresponding to (NACK NACK), and a region 2928 corresponding to (NACK ACK) and configured. In this case, the CS index pairs may include a CS index pair (0, 3, 6, 9), a CS index pair (1, 4, 7, 10), and a CS index pair (2, 5, 8, 11). That is, a CS index configuration, such as FIG. 29(c), may be used for the multiplexing of a maximum of three UEs.

Specifically, if a first UE and a second UE are multiplexed, the CS index pair (0, 3, 6, 9) may be assigned to the first UE and the CS index pair (2, 5, 8, 11) may be assigned to the second UE. In this case, if each UE attempts to transmit CSI and ACK/NACK information to a base station at the same time, the UE may select a specific CS index corresponding to specific 2-bit ACK/NACK information among CS indices included in a CS index pair, and may transmit a DMRS.

In this case, the base station may transmit information about a configuration related to the ACK/NACK information to the UE through higher layer signaling and/or physical layer signaling.

Furthermore, the UE may joint-code the ACK/NACK information and a CSI value and transmit it to the base station.

Furthermore, a method of transmitting an SR or ACK/NACK information along with the CSI feedback has been described by taking into consideration multiplexing between UEs, but the method may be applied to a case where multiplexing between UEs is not taken into consideration.

As described above, an RS (RS used for channel estimation) transmitted along with CSI feedback in a specific sTTI may be used to implicitly transmit different uplink control information. Accordingly, there is an advantage in that a UE can transmit various types of information at once in an sTTI configured by taking into consideration short latency.

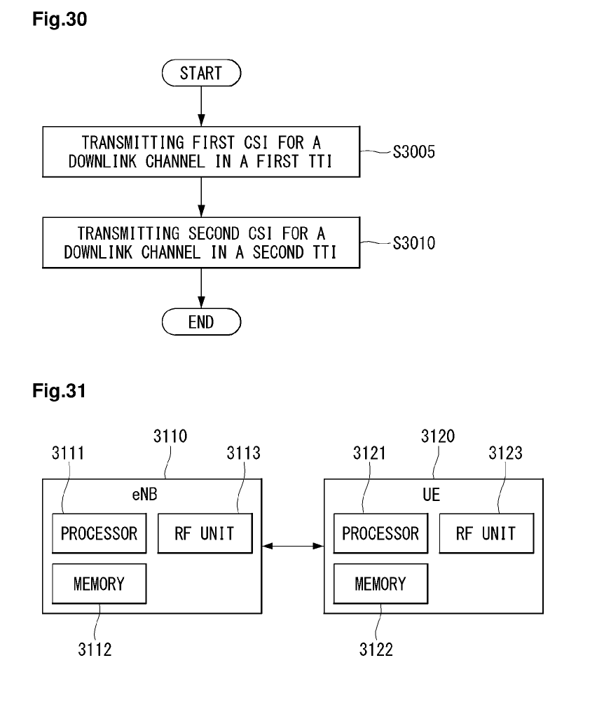

FIG. 30 illustrates an operating flowchart of a user equipment to transmit channel state information (CSI) to a base station to which the present invention may be applied. FIG. 30 is only for convenience of description and does not limit the scope of the present invention.

Referring to FIG. 30, a case where a UE divides (or segments) channel state information (CSI) about a downlink channel received from a base station and transmits two pieces of CSI (i.e., first CSI and second CSI) into two TTIs (or sTTIs) is assumed. Furthermore, in this case, the CSI may include a CQI. That is, indices related to the CSI may mean indices related to the CQI (e.g., CQI indices defined in 4 bits).

Furthermore, the two TTIs (i.e., a first TTI and a second TTI) may include different one or more symbols. That is, a symbol used for first CSI transmission in the first TTI and a symbol used for second CSI transmission in the second TTI may be different.

Furthermore, the UE described in FIG. 30 may perform the method(s) according to the aforementioned embodiments of the present invention.

In step S3005, the UE transmits first CSI about a downlink channel, received from a base station, to the base station. In this case, the first CSI may include information indicating a specific region including one or more indices related to the CSI.

More specifically, if a plurality of indices related to the CSI includes one or more index groups (i.e., in the case of the first embodiment of the present invention), information indicating the specific region may include information indicating a specific index group of the one or more index groups. For example, in the case of FIG. 22, the first CSI may include an index indicating one of the first group 2202, second group 2204, third group 2206 and fourth group 2207 shown in FIG. 22.

In this case, configuration information about the one or more index groups may be received from the base station through higher layer signaling and/or physical layer signaling as described above.

Alternatively, the information indicating the specific region may include information indicating the starting point of the specific region.

After the UE transmits the first CSI to the base station in the first TTI, in step S3010, the UE transmits second CSI about the received downlink channel to the base station. In this case, the second CSI may include information indicating a specific index belonging to one or more indices included in the specific region and corresponding to the channel state of the received downlink channel.

More specifically, if the information indicating the specific region in the first CSI includes information indicating a specific index group, the information indicating the specific index may include information indicating an index belonging to one or more indices included in the specific index group and corresponding to the channel state of the received downlink channel. For example, in the case of FIG. 22, the second CSI may include information indicating the CQI index 13 of CQI indices included in the fourth group.

Alternatively, if the information indicating the specific region in the first CSI includes information indicating the starting point of the specific region, information indicating a specific index in the second CSI may include offset information between the index corresponding to the starting point and the specific index. For example, if a CQI table is given, the offset information may mean information indicating the specific index based on the index corresponding to the starting point.

Furthermore, in various embodiments of the present invention, when the number of bits configuring the first CSI is smaller than the number of bits configuring the second CSI, the number of symbols configuring the first TTI may be configured to be smaller than the number of symbols configuring the second TTI. Alternatively, when the number of bits configuring the first CSI is greater than the number of bits configuring the second CSI, the number of symbols configuring the first TTI may be configured to be greater than the number of symbols configuring the second TTI. Configuration information thereon may be received from the base station through higher layer signaling and/or physical layer signaling.

General Apparatus to which the Present Invention May be Applied

FIG. 31 illustrates a block diagram of a wireless communication apparatus according to an embodiment of the present invention.

Referring to FIG. 31, the wireless communication system includes a network node 3110 and multiple user equipments (UEs) 3120.

The network node 3110 includes a processor 3111, memory 3112 and a communication module 3113. The processor 3111 implements the functions, processes and/or methods proposed in FIGS. 1 to 30. The layers of a wired/wireless interface protocol may be implemented by the processor 3111. The memory 3112 is connected to the processor 3111 and stores stored a variety of types of information for driving the processor 3111. The communication module 3113 is connected to the processor 3111 and transmits and/or receives wired/wireless signals. In particular, if the network node 3110 is a base station, the communication module 3113 may include a radio frequency (RF) unit for transmitting/receiving radio signals.

The UE 3120 includes a processor 3121, memory 3122 and a communication module (or RF unit) 3123. The processor 3121 implements the functions, processes and/or methods proposed in FIGS. 1 to 30. The layers of a wired/wireless interface protocol may be implemented by the processor 3121. The memory 3122 is connected to the processor 3121 and stores a variety of types of information for driving the processor 3121. The communication module 3123 is connected to the processor 3121 and transmits and/or receives radio signals.

The memory 3112, 3122 may be inside or outside the processor 3111, 3121 and may be connected to the processor 3111, 3121 by various well-known means. Furthermore, the network node 3110 (if it is a base station) and/or the UE 3120 may have a single antenna or multiple antennas.

In the aforementioned embodiments, the elements and characteristics of the present invention have been combined in specific forms. Each of the elements or characteristics may be considered to be optional unless otherwise described explicitly. Each of the elements or characteristics may be implemented in a form to be not combined with other elements or characteristics. Furthermore, some of the elements and/or the characteristics may be combined to form an embodiment of the present invention. Order of the operations described in the embodiments of the present invention may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the present invention may be implemented by various means, for example, hardware, firmware, software or a combination of them. In the case of an implementation by hardware, the embodiment of the present invention may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present invention may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present invention may be materialized in other specific forms without departing from the essential characteristics of the present invention. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### INDUSTRIAL APPLICABILITY

A scheme for transmitting channel state information in a wireless communication system supporting a short transmission time interval according to the present invention has been described based on an example in which the scheme has been applied to the 3GPP LTE/LTE-A system, but may be applied to various wireless communication systems in addition to the 3GPP LTE/LTE-A system.

1. A method of transmitting channel state information (CSI) in a wireless communication system supporting a short transmission time interval (short TTI), the method performed by a user equipment comprising:
transmitting, to a base station, first CSI for a downlink channel received from the base station, in a first TTI, and
transmitting, to the base station, second CSI for the received downlink channel, in a second TTI,
wherein the first CSI comprises information for a specific region comprising a plurality of indices related to the CSI, and
wherein the second CSI comprises information for a specific index related to a channel state of the received downlink channel among the plurality of indices.

2. The method of claim 1, wherein, when the plurality of indices related to the CSI is configured as one or more index groups, the information for the specific region comprises information for a specific index group of the one or more index groups, and
wherein the information for the specific index comprises information for an index related to the channel state of the received downlink channel among one or more indices included in the specific index group.

3. The method of claim 2, wherein the plurality of indices related to the CSI comprises at least one of a plurality of indices for a channel quality indicator (CQI) and a plurality of indices for a precoding matrix indicator (PMI).

4. The method of claim 3, wherein the plurality of indices for the CQI is represented as 4-bit information, and
wherein the first CSI and the second CSI are represented as bit information of a number smaller than 4.

5. The method of claim 3, wherein configuration information for the one or more index groups is received from the base station, through at least one of high layer signaling or physical layer signaling.

6. The method of claim 1, wherein the information for the specific region comprises information for a starting point of the specific region, and
wherein the information for the specific index comprises offset information between an index related to the starting point and the specific index.

7. The method of claim 1, wherein the first TTI and the second TTI comprise one or more different symbols.

8. The method of claim 7, wherein, when a number of bits configuring the first CSI is smaller than a number of bits configuring the second CSI, the number of symbols configuring the first TTI is set smaller than a number of symbols configuring the second TTI.

9. The method of claim 8, wherein, when the number of bits configuring the first CSI is greater than the number of bits configuring the second CSI, the number of symbols configuring the first TTI is set greater than the number of symbols configuring the second TTI.

10. A user equipment transmitting channel state information (CSI) in a wireless communication system supporting a short transmission time interval (short TTI), the user equipment comprising:
a transceiver for transmitting and receiving radio signals, and
a processor functionally connected to the transceiver,
wherein the processor controls to:
transmit, to a base station, first CSI for a downlink channel received from the base station, in a first TTI; and
transmit, to the base station, second CSI for the received downlink channel, in a second TTI,
wherein the first CSI comprises information for a specific region comprising a plurality of indices related to the CSI, and
wherein the second CSI comprises information for a specific index related to a channel state of the received downlink channel among the plurality of indices.

11. The user equipment of claim 10, wherein, when the plurality of indices related to the CSI is configured as one or more index groups, the information for the specific region comprises information for a specific index group of the one or more index groups, and
wherein the information for the specific index comprises information for an index related to the channel state of the received downlink channel among one or more indices included in the specific index group.

12. The user equipment of claim 10, wherein the information for the specific region comprises information for a starting point of the specific region, and
wherein the information for the specific index comprises offset information between an index related to the starting point and the specific index.
